(19) United States
(12) Patent Application Publication
(10) Pub. No.: US 2006/0246440 A1
(43) Pub. Date: Nov. 2, 2006

(54) Methods for producing zinc finger proteins that bind to extended dna target sequences

(76) Inventor: J. Keith Joung, Winchester, MA (US)

Correspondence Address: EDWARDS & ANGELL, LLP, P.O. BOX 55874, BOSTON, MA, 02205, US

(21) Appl. No.: 10/532,031

(22) PCT Filed: Oct. 23, 2003
(86) PCT No.: PCT/US03/34028

§ 371 Date: May 1, 2006

Related U.S. Application Data
(60) Provisional application No. 60/477,314, filed on Jun. 9, 2003.
(60) Provisional application No. 60/466,889, filed on Apr. 30, 2003.
(60) Provisional application No. 60/466,712, filed on Apr. 30, 2003.
(60) Provisional application No. 60/420,458, filed on Oct. 23, 2002.

(51) Int. Cl. C40B 30/06; C40B 40/08; C40B 40/10

(52) U.S. Cl. 435/6; 435/226; 435/7.1

(57) ABSTRACT

The present invention relates to non-naturally occurring zinc finger proteins that are selected for binding to a DNA sequence of interest. The non-naturally occurring zinc finger proteins of the present invention are based on the sequence of zinc finger proteins having more than three zinc fingers, such as NRSF, and are capable of binding extended DNA target sequences with high affinity and specificity.

### RELATED APPLICATIONS/PATENTS & INCORPORATION BY REFERENCE

This application claims priority to U.S. application Ser. No. 60/420,458 filed Oct. 23, 2002, U.S. application Ser. No. 60/466,712 filed Apr. 30, 2003, U.S. application Ser. No. 60/466,889 filed Apr. 30, 2003, and U.S. application Ser. No. 60/477,314 filed Jun. 9, 2003, the contents of which are hereby expressly incorporated herein by reference.

### STATEMENT OF RIGHTS TO INVENTION MADE UNDER FEDERALLY SPONSORED RESEARCH

This work was supported, in part, by the government by a grant from the National Institute of Health and the National Institute of Diabetes and Digestive and Kidney Diseases (K08 DK02883). The government may have certain rights to this invention.

Each of the applications and patents cited in this text, as well as each document or reference cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference, and may be employed in the practice of the invention. More generally, documents or references are cited in this text, either in a Reference List before the claims, or in the text itself; and, each of these documents or references (“herein cited references”), as well as each document or reference cited in each of the herein cited references (including any manufacturer's specifications, instructions, etc.), is hereby expressly incorporated herein by reference.

### FIELD OF THE INVENTION

The present invention relates to multi-finger Zinc finger polypeptides that bind to extended DNA target sequences, and methods of selection thereof.

### BACKGROUND

At any given time, only a fraction of the genes in the genome of an organism are expressed and/or producing functional protein products. The profile of proteins expressed in an organism varies greatly between cell types and changes over time, depending on factors such as stage of development, stage of the cell cycle and response to environmental factors. Furthermore, gene expression is often mis-regulated in disease.

Gene expression is controlled, in part, by proteins known as transcription factors. The presence of a particular combination of such transcription factors determines whether a gene is switched on or off at any given time and place. Transcription factors are modular proteins. They contain at least one DNA-binding domain (DBD) and one or more functional or regulatory domains. DBDs act as targeting devices to localize transcription factors to specific sequences or “target sites” on the chromosomal DNA. Functional domains function to direct the localization of specific activities to a gene or locus of interest, ultimately enabling transcription of that gene to be up- or down regulated.

The ability to artificially manipulate gene expression has enormous potential for biological research and for the development of new agents for gene therapy. Realizing this potential requires the ability to engineer DNA binding domains that recognize “target site” sequences with high affinity and specificity. Many DNA-binding proteins contain independently folded domains for the recognition of DNA, and these domains in turn belong to a large number of structural families, such as the leucine zipper, the “helix-turn-helix” and zinc finger (Zf) families. Most sequence-specific DNA-binding proteins bind to the DNA double helix by inserting an α-helix into the major groove (Pabo and Sauer 1992 Annu. Rev. Biochem. 61:1053-1095; Harrison 1991 Nature (London) 353: 715-719; and Klug 1993 Gene 135:83-92). Sequence specificity results from the geometrical and chemical complementarity between the amino acid side chains of the α-helix and the accessible groups exposed on the edges of base-pairs. In addition to this direct reading of the DNA sequence, interactions with the DNA backbone stabilize the complex and are sensitive to the conformation of the nucleic acid, which in turn depends on the base sequence (Dickerson and Drew 1981 J. Mol. Biol. 149:761-786).

Zfs have become the DBD of choice in efforts to engineer custom-made transcription factors. A Zf is an independently folded zinc-containing mini-domain, the structure of which is well known in the art and defined in, for example, Miller et al., (1985) EMBO J. 4:1609; Berg (1988) Proceedings of the National Academy of Sciences (USA) 85:99; Lee et al., (1989) Science 245:635 and Klug, (1993) Gene 135:83. The crystal structures of Zf DNA complexes show a semi-conserved pattern of interactions, in which typically 3 amino acids from the α-helix of the Zf contact 3 adjacent base pairs (bp) or a “subsite” in the DNA (Pavletich et al., (1991) Science 252:809; Fairall et al., (1993) Nature 366:483; and Pavletich et al., (1993) Science 261:1701). Thus, the crystal structure of Zif268 suggested that Zf DBDs might function in a modular manner with a one-to-one interaction between a Zf and a 3 bp “subsite” in the DNA sequence. In naturally occurring transcription factors, multiple Zfs are typically linked together in a tandem array to achieve sequence-specific recognition of a contiguous DNA sequence (Klug, (1993) Gene 135:83).

Multiple studies have shown that it is possible to artificially engineer the DNA binding characteristics of individual Zfs by randomizing the amino acids at the α-helical positions involved in DNA binding and using selection methodologies such as phage display to identify desired variants capable of binding to DNA target sites of interest (Rebar et al., (1994) Science 263:671; Choo et al., (1994) Proceedings of the National Academy of Sciences (USA) 91:11163; Jamieson et al., (1994) Biochemistry 33:5689; Wu et al., (1995) Proceedings of the National Academy of Sciences (USA) 92: 344). Similarly, there are numerous patents and patent applications relating to methods of producing and using artificially engineered zinc finger proteins, see for Example, Published U.S. patent application 2002/0160940 A1 and 2002/0164575 A1, U.S. Pat. Nos. 6,511,808, 6,013,453, 6,007,988, 6,503,717, 6,453,242, 9. U.S. Pat. No. 6,492,117, and International publications WO 02099084A2, WO 02089498, WO 02057308 A2, WO 0153480 A and WO 0027878 A1.

Furthermore, by fusing such recombinant Zf DBDs to regulatory or functional domains, it has been possible to artificially regulate expression of transfected reporter genes in cultured cells. For example, Beerli et al., (Beerli et al., (1998) Proceedings of the National Academy of Sciences (USA) 95:14628) reported construction of a chimeric 6 finger Zf protein fused to either a KRAB, ERD, or SID transcriptional repressor domain, or the VP16 or VP64 transcriptional activation domain. This chimeric Zf protein was designed to recognize an 18 bp target site in the 5′ untranslated region of the human erbB-2 gene. Using this construct, the authors were able to either activate or repress a transiently expressed reporter luciferase construct linked to the erbB-2 promoter. Although these proteins were designed to recognize an 18 bp DNA sequence, recent evidence demonstrates that they specify only some of the 18 bases in their target site (see below and Segal et al. (2003) Biochemistry 42 (7) 2317-2148).

Further studies have demonstrated that such recombinant Zf transcription factors can also be used to regulate expression of endogenous genes in their native chromosomal context (see for Example, Reik et al., (2002) Current Opinions in Genetics & Development 12:233, and published U.S. patent application 2002/0160940 A1). Clinically relevant human genes that have been successfully regulated in this way include MDR1, erythropoietin, erbB-2 and erbB-3, VEGF, and PPARgamma. In the case of VEGF (Liu et al., (2001) Journal of Biological Chemistry 276:11323), proportional up-regulation by the designed transcription factor of all three distinct splice isoforms generated by this locus was observed, illuminating the utility of endogenous gene control in therapeutic settings (proper isoform ratio is essential for the proangiogenic function of VEGF). Furthermore, Rebar et al., (Nature Medicine 8: 1427-1432 (2002) showed that Zf transcription factors designed to bind to the VEGF-A gene induced expression of VEGF-A in vivo leading to a stimulation of angiogenesis and an acceleration of experimental wound healing. In the case of PPARgamma, use of a transcriptional repressor designed to downregulate the expression of two PPARgamma isoforms allowed “mutation-free reverse genetics” analysis that illuminated a unique role for the PPARgamma2 isoform in adipogenesis (Ren et al., (2002) Genes &Development 16:27).

In order to use recombinant Zfs to specifically target a gene of interest within the genome, the target site sequence recognized should be sufficiently long that statistically, it occurs only once in the genome. In the case of the human genome, a multi-finger Zf protein recognizing a stretch of about 16 bp or more should be generated for this to be achieved (Liu et al., (1997) Proceedings of the National Academy of Sciences (USA) 94:5525). Statistically, assuming random base distribution, a unique 16 bp sequence will occur only once in 4.3×10⁹ bp, thus a 16 bp sequence should be sufficient to specify a unique address within the approximately 3.5×10⁹ bp that make up the human genome (Liu et al., (1997) Proceedings of the National Academy of Sciences (USA) 94:5525). Similarly, an 18 bp address specified by a 6 finger protein, would enable sequence specific targeting within 6.8×10¹⁰ bp of DNA. Such a 6-finger protein would thus be able to uniquely specify any locus within all currently known genomes, and thus could be used to artificially regulate the expression of only an intended target gene and not other unintended genes or sequences. However, it should be noted that the “effective” frequency of such unique addresses in the human genome is likely to be significantly lower than the frequencies predicted by these purely statistical calculations, because a certain portion of the DNA in the genome is packaged into regions of densely packed chromatin that is not accessible by transcription factors.

Various strategies have been described for creating multi-finger proteins capable of binding such extend DNA sequences. The majority of such strategies have involved linking together tandem arrays of engineered zinc fingers derived from naturally occurring proteins that contain 3 zinc fingers in their DNA binding domains, such as Zif268 and Sp1, see for example, U.S. patent application 2002/0160940 A1, WO 02099084A2, and WO 0153480 A1. Zinc finger units from these proteins are typically linked together using the canonical 5 amino acid zinc finger linker sequence, TGEKP, to generate proteins composed of 3, 4, 5, 6 and 9 fingers (U.S. Pat. No. 6,140,466). However, biochemical characterization of these synthetic multi-finger proteins has revealed an apparent energetic barrier to the simultaneous binding of more than 3 fingers to a target DNA sequence. For proteins composed of fingers derived from Zif268 or Sp1 connected by standard TGEKP linkers, the binding energy increases dramatically (by approximately 3 orders of magnitude) as one progresses from a 2-finger domain to a 3-finger domain. However, it has been found that adding more fingers to a 3-finger domain does not yield the expected large increase in binding affinity. This result has been observed with 4-, 6-, and 9-finger proteins. The precise reason for this barrier is not well understood although it is known that using longer, non-TGEKP linkers between selected finger units can restore some, but not all, of the expected affinity for a 6 finger protein (see, for example, WO 0153480 A1). These results suggest that some kind of strain is encountered when more than three fingers linked by TGEKP linkers bind to DNA. An important implication of this finding is that synthetic TGEKP-linked proteins with four or more Zfs may not always specify all of the DNA bases in their intended target DNA sequence, and therefore may not be suitable for applications where it is important that only the specific target gene of interest is bound and regulated.

The findings of Segal et al. (Biochemistry 42 (7) 2317-2148 (2003)) provide further evidence that currently available methods for producing multi-finger proteins will not be suitable for the production of artificial transcription factors capable of regulating specific genes in humans. As described above, statistically an 18 bp address specified by a 6 finger protein should be able to uniquely specify any locus within the human genome. However, Segal et al. found that when they linked together two 3-finger Zf proteins, each of which had perfect specificity for its 9 bp target site, the specificity of the 6 finger protein was significantly less than predicted.

Another problem with current methods of producing multi-finger proteins is that of binding affinity. Previous studies have shown that only proteins that bind their target with a dissociation constant in the nanomolar to picomolar range or more tightly are able to effectively regulate gene expression. However, it is also likely to be true that if binding affinity is too great gene expression can not be effectively regulated either. If the dissociation constant of a protein is too low (i.e. affinity is too high), then at physiologic levels of protein expression a zinc finger protein will likely occupy DNA sites other than its intended target sequence. In addition, if affinity is too high (e.g a dissociation constant in the femtomolar range), it is possible that a “kinetic trapping” effect may occur where the zinc finger protein becomes “stuck” to unintended binding sites in the genome (see Kim and Pabo, PNAS (1998) 95(6):2812-7, for example). Thus, in order to be useful in regulating gene expression, ideally an artificial Zf protein should bind to a unique target sequence in the human genome with a dissociation constant in the picomolar to nanomolar range. Predictions based on the chelate effect suggest that if 6 Zfs derived from a 3-finger protein such as zif268 or Sp-1 were strung together in such a way that all fingers simultaneously bound to the DNA, the dissociation constant of the resultant protein would be on the order of 10⁻¹⁸ to 10⁻²¹ molar. Thus another problem with engineering multi-finger proteins using fingers from naturally occurring 3-finger proteins is that even if one could find a means to permit more than three zinc fingers to simultaneously engage their target DNA site, the binding affinity of the resulting protein would likely be too high to be useful. Choo and colleagues (Moore et al., PNAS (2001) February 13; 98(4):1437-41) have described a method for producing six finger proteins in which three two-finger units (derived from two fingers of Zif268) are connected together using a TGGEKP linker. The use of a non-TGEKP linker disrupts the ability of any subset of fingers within one of these proteins from binding to the DNA as a three-finger unit. The overall affinity of the resulting six-finger proteins is in a physiologically useful range. However, it remains unclear whether all six fingers in these proteins are simultaneously engaging the DNA site and also the overall specificity of these proteins remains unclear. Chan et al. produced a six finger protein derived from zif268 fused to a KRAB2 repressor domain, and found that this protein conferred specific repression of the CHK2 gene (Tan et al. (2003) PNAS 1000:11997).

Several naturally occurring zinc fingers having more than three zinc fingers are known in the art. For example, the zinc finger protein CTCF (or CCCTC-binding factor) has 11 zinc fingers and binds to the sequence CCTC in the promoters of chicken, mouse and human c-myc genes (Filippova et al., Molecular & Cellular Biology (16) 2802-2813 (1996)). The Kruppel-associated box protein KS1 is a member of the KRAB family of zinc finger proteins having 10 zinc fingers. KS1 binds to a 27 bp sequence known as the KS1 binding element of KBE (Gebelein et al., Molecular & Cellular Biology (21) 928-939 (2001)). The protein Evi-1 has ten zinc fingers organized in two distinct DNA binding domains, having three and seven zinc fingers. The domain having three zinc fingers binds to the sequence GAAGATGAG, and the domain having seven zinc fingers binds to the sequence GACAAGATAAGATAA (Morishita et al., Oncogene (10) 1961-1917 (1995)). The myeloid zinc finger protein MZF has 13 zinc fingers in wo separate DNA binding domains. Zinc fingers 1-4 of MZF bind to the sequence AGTGGGGA, while zinc fingers 5-13 bind to the sequence CGGGnGAGGGGGAA (Morris et al., Molecular & Cellular Biology (14) 1786-1795 (1994)). The Neuron Restrictive Silencer Factor (hereafter referred to as “NRSF”), which is also known as the RE-1 Silencing Transcription Factor or REST, has eight zinc fingers in its DNA binding domain.

However, to date, no naturally occurring zinc finger protein having more than three zinc fingers has been used as the basis for selecting “designer” zinc finger proteins by engineering its DNA binding affinity.

The NRSF protein, first identified by Chong et al., (Cell 80 (6) 949-957 (1995)) and Schoenherr et al, (Science 267 (5202) 1360-1363 (1995)), is described in U.S. Pat. Nos. 5,935,811 and 6,270,990. The NRSF protein is predominantly expressed in non-neuronal cells. It functions as a master regulator of neuronal gene expression by repressing the expression of its target genes in non-neuronal cells.

NRSF binds to a 21 bp DNA sequence called the Neuron Restrictive Silencer Element (hereafter referred to as “NRSE”). This NRSE sequence is found in many genes that encode proteins required for neuronal function such as the type II sodium channel gene, and the SCG10 gene. A list of many the genes that contain NRSE sequences can be found in Schoenherr et al., 1996 (PNAS 93; p 9881-9886). In addition to its DNA binding domain consisting of 8 tandem Cys₂His₂ zinc fingers, the NRSF protein also comprises two repression domains, one located at each end of the protein. By differential utilization of these repression domains, NRSF mediates both active repression and long-term silencing of its target genes. Thus, NRSF provides a naturally occurring example of a multi-finger protein that can recognize an extended 21 base pair binding site with high specificity.

### OBJECTS AND/OR SUMMARY OF THE INVENTION

Methods for isolating multi-finger Zf proteins that bind to a sequence of interest (e.g., and extended DNA target sequence), would potentially lead to the identification of non-naturally occurring Zf proteins that can perform important biological functions in vivo. The present invention provides methods for selecting multi-finger Zf proteins having more than three zinc fingers. In preferred embodiments, the methods of the present invention are used to select Zf proteins that have 4-8 Zfs that bind selectively to sequences of 12 to 24 bp.

Currently known methods of designing or selecting non-naturally occurring Zf proteins typically start with a natural Zf protein as a source of “scaffold” residues. The process of design or “selection” serves to alter the amino acid composition of the natural Zf proteins so as to confer the desired DNA binding specificity. All currently known methods for designing or selecting Zf proteins utilize 3-finger Zf proteins, such as zif268, as the “scaffold” from which to engineer proteins having altered DNA binding specificities. Such three finger proteins are used to produce proteins having more than 3 fingers by linking the desired number of Zfs together using the well conserved canonical Zf linker sequence, TGEKP, or other synthetic linkers (see above). However, as noted above, biochemical analysis to date suggests that there exists an energetic barrier to engagement of more than 3 fingers in these proteins with DNA. This means that such proteins may not always specifically bind to all of the DNA bases in their intended target DNA sequence, and therefore may not be suitable for applications where it is important that only the specific target gene of interest is bound and regulated. Furthermore, it is likely that the binding affinity of the individual fingers in naturally occurring 3-finger proteins is significantly higher, such that if 6 fingers were joined together and simultaneously bound to their DNA target, the binding affinity of the resultant protein would be too high to allow productive regulation of gene expression.

It is an object of the present invention to create non-naturally occurring proteins that bind to sequences of interest with high affinity and specificity, not by linking together multiple fingers from three-finger proteins (e.g., zif268)—as has been done previously—but by re-engineering the DNA binding specificity of a naturally occurring multi-finger Zf protein.

The methods of the present invention overcome the problems in the art by using as a scaffold a protein that has greater than three Zfs in its DNA binding domain. Thus, the present invention is unique in exploiting the zinc fingers and “linkers” from Zf proteins that have naturally evolved (and are therefore presumably optimized) to bind to sequences of interest with an affinities in the physiological range (e.g. with a dissociation constant (K_{D}) in the nanomolar to picomolar range.

In a preferred embodiment, the methods of the present invention use the naturally occurring Zf protein NRSF as the starting point. To date there have been very few studies on the interaction of the NRSF Zfs with its NRSE target sequence. Very little biochemical or genetic information, and no structural information, exists about the interaction of the 8-finger NRSF DNA binding domain with the NRSE. One study, in which entire fingers were inactivated by substituting an arginine for one of the conserved cysteines, revealed that neutralization of NRSF finger 7, or of a combination of fingers 6 and 8, leads to diminished DNA binding by NRSF. Another study provided evidence suggesting that a splice form of NRSF that contains fingers 3 through 5 can bind near the 3′ end of the NRSE, but no detailed mapping of finger-DNA interactions was performed.

Similarly, there have been no attempts to alter the DNA binding specificity of the NRSF protein. In the present invention, it now has been surprisingly shown that NRSF actually binds simultaneously to a span of at least 20 DNA bases, suggesting that NRSF is uniquely able to bind to extend DNA sequences with high specificity. It has also been surprisingly found that binding requires only zinc fingers 3-8 of the NRSF protein. Furthermore, the specific nucleotide contacts made by each of zinc finger 3-8 in NRSF have now been modeled and specific DNA contacts made by fingers 4, 5, 6 and 8 have been defined. This critical new information on the binding of NRSF to its target sequence has enabled the development of the novel Zf engineering methods of the present invention.

Accordingly, in one aspect, the present invention provides methods of selecting non-naturally occurring zinc-finger polypeptides that bind specifically to DNA target sequences of interest, where a Zf protein having greater than three zinc fingers in its DNA-binding domain is used as the scaffold sequence. Any suitable Zf proteins having more than three zinc fingers can be used as a scaffold.

In another aspect, the scaffold protein is selected from the group of Zf proteins comprising CTCF, Ks1, Evi-1, MZF, and NRSF.

In a preferred aspect, the present invention provides methods of selecting non-naturally occurring zinc-finger polypeptides that bind specifically to sequences of interest, where the NRSF protein is used as the scaffold sequence.

In another aspect, the present invention provides preferred libraries and selection methods to be used in the production of such scaffold-based synthetic Zf proteins.

In another aspect, the invention is directed to methods of selecting appropriate target sequences within a gene of interest. The invention provides criteria and methods for selecting optimum subsequence(s) from a target gene of interest for targeting by a Zf protein.

### BRIEF DESCRIPTION OF THE DRAWINGS

In the following Detailed Description and Examples reference will be made to the accompanying drawings, incorporated herein by reference.

FIG. 1 provides the amino acid sequence of the human NRSF protein (SEQ ID NO.1).

FIG. 2 provides the sequence of the human the NRSF cDNA (SEQ ID NO.2).

FIG. 3 provides the amino acid sequence of the mouse NRSF protein (SEQ ID NO.3)

FIG. 4 provides the sequence of the mouse NRSF cDNA (SEQ ID NO.4)

FIG. 5 provides the amino acid sequence of the rat NRSF protein (SEQ ID NO.5)

FIG. 6 provides the sequence of the rat NRSF cDNA (SEQ ID NO.6)

FIG. 7 provides the amino acid sequence of the Xenopus laevis NRSF protein (SEQ ID NO.7)

FIG. 8 provides the sequence of the Xenopus laevis NRSF cDNA (SEQ ID NO.8)

FIG. 9 shows the amino acid sequences of zinc finger 1 (SEQ ID NO.14), 2 (SEQ ID NO.15), and 3 (SEQ ID NO.16) of Zif268, and also zinc fingers 1 (SEQ ID NO.17), 2 (SEQ ID NO.18), 3 (SEQ ID NO.19), 4 (SEQ ID NO.20), 5 (SEQ ID NO.21), 6 (SEQ ID NO.22), 7 (SEQ ID NO.23), and 8 (SEQ ID NO.24) of human NRSF. The arrows and barrel above the sequences indicate positions of β-sheet and α-helix respectively. Conserved cysteines (C) and histidines (H) are shown in bold type. Recognition helix sequences (including the −1 residue preceding the helix start) are underlined. Linker sequences following the second conserved histidine (H) are also shown. The unusual tyrosine (Y) in the NRSF fingers is shown.

FIG. 10 provides a schematic representation of the bacterial two-hybrid method. In an appropriately engineered E. coli strain, binding of a Zf protein (2) to a target DNA sequence of interest (1) can trigger transcriptional activation of a reporter gene(s) (7). The target DNA sequence (1) is positioned upstream of a weak promoter (6) that directs low-level expression of a reporter gene (7). Transcription of the reporter gene(s) (7) can be activated (as indicated by the arrows) by expressing 2 hybrid proteins, one a fusion of the Zf protein (2) with a fragment of the yeast Gal11P protein (3) (to form GP-Zf) and the other a fusion between a fragment of the yeast Gal4 protein (4) and the E. coli RNA polymerase alpha subunit (5) (to form α-Gal4 protein). Since the yeast Gal11P (3) and Gal4 (4) protein fragments can interact with each other, GP-Zf bound to the target DNA sequence (1) can mediate recruitment of RNA polymerase complexes that have incorporated the α-Gal4 protein thereby stimulating transcription of the reporter gene (7) from the weak promoter (6).

FIG. 11 illustrates binding of NRSF1-8 and NRSF3-8 domains to various NRSE sites in the bacterial two-hybrid system. As described in the Examples, GP-NRSF1-8 and GP-NRSF3-8 proteins were tested in “B2 reporter strains” harboring the depicted NRSE sequence. Mutated bases in the NRSE sites are shown in bold. Fold-activation indicates the extent of transcriptional activation of the lacZ reporter gene in the strains.

FIG. 12 shows the predicted model for the interaction of NRSF fingers 3-8 with the consensus NRSE. Recognition helix residues −1, 2, 3, and 6 from fingers 3-8 are shown with postulated contacts (arrows) to the consensus NRSE sequence. Strongly conserved positions in the NRSE are shown in uppercase whereas less well conserved positions are in lowercase.

FIG. 13 shows electrophoretic mobility shift assay (EMSA) data showing binding of NRSF3-8 and NRSF 1-8 to the NRSE.

FIG. 14 shows sequences of re-engineered NRSF-based variants. Sequences of residues selected in recognition helices of re-engineered fingers are shown. Finger 4 variants are shown in FIG. 14A and Finger 5 variants are shown in FIG. 14B. The double mutant NRSE targeted is shown above the finger sequences. Mutated positions are indicated in bold and are underlined.

FIG. 15 provides data showing that re-engineered NRSF-based variants bind specifically to their target mutant NRSE sequence. Finger 4 (FIG. 15A) and Finger 5 (FIG. 15B) NRSF-based variants were introduced into B2H reporter strains harboring the consensus NRSE, the appropriate double mutant target NRSE, or a point mutant NRSE. The ability of each NRSF variant to activate transcription in the indicated reporter strain is expressed as fold-activation of the promoter.

FIG. 16 depicts an overview of a Context Sensitive Parallel Optimization Strategy for selection of a three-finger protein. Step 1 is the primary selection stage, in which “primary CSPO libraries” (B) are selected for binding to “target site constructs” (C). The zinc fingers in each of the three primary libraries (B) are represented as numbered circles. Each of the primary libraries has one zinc finger randomized (as represented by a black circle), and two zinc fingers with a constant “anchor” sequence (as represented by the gray circles). Each of the three primary libraries is selected for binding to a different “target site construct” (C). Each target site construct (C) comprises 3 subsites, one of which has the exact sequence of the corresponding subsite in the sequence of interest (as represented by the black box), while the remaining two subsites have a defined “anchor” sequence (as represented by the gray boxes). In step 2, pools of Zf proteins fingers (D) that bind to their corresponding target site with a range of affinities, are identified and selected. In step 3, the nucleic acids encoding these pools of Zf proteins are isolated and recombined randomly to produce a secondary CSPO library (E). In step 4, a secondary selection is performed in which the secondary CSPO library (E) is selected for binding to the exact sequence of interest (A) at high stringency, to identify Zf proteins (F) that bind with high affinity and specificity to the sequence of interest (A).

FIG. 17 depicts a schematic representation of experiments to assess the activity of selected NRSF-based variants (described in Example 9) in mammalian cells. As described in the text, for each of the target DNA sequences used, several selected NRSF-based variants can be used to construct stable cell lines that express these proteins. For each selected NRSF-based variant, multiple stable cell lines will be identified. RNA extracted from each of these cell lines is hybridized to an Affymetrix U133A GeneChip.

FIG. 18 depicts data from microarray experiments used to provide insight into the functional specificity of a three-finger protein in a mammalian cell, as in Example 9. The data shown comes from a single microarray experiment using Affymetrix U 133A chips which was performed to assess the global effects of a three-finger protein (VZ-573) fused to a transcriptional activator domain. Three sets of 30 genes each were selected: the 30 unique genes with the greatest fold activation (“activated genes”), the 30 genes whose expression levels were apparently unaffected (“unaffected genes”), and the 30 genes with the greatest fold-repression (“repressed genes”). Genomic sequences flanking the likely transcriptional start sites for each gene were obtained and searched on both strands for matches or near-matches (off by one base, at either of two positions judged most likely to be degenerate for this protein). The average number of matches per gene within 2500 bases of the transcriptional start site (shown in spans of 500 base pairs) is shown for the three different set of genes.

FIG. 19 shows the amino acid sequence of selected NRSF-based protein F4v 1 (SEQ ID NO.25).

FIG. 20 shows the amino acid sequence of selected NRSF-based protein F4v4 (SEQ ID NO.26).

FIG. 21 shows the amino acid sequence of selected NRSF-based protein F4v5 (SEQ ID NO.27).

FIG. 22 shows the amino acid sequence of selected NRSF-based protein F4v6 (SEQ ID NO.28).

FIG. 23 shows the amino acid sequence of selected NRSF-based protein F4v7 (SEQ ID NO.29).

FIG. 24 shows the amino acid sequence of selected NRSF-based protein F4v8 (SEQ ID NO.30).

FIG. 25 shows the amino acid sequence of selected NRSF-based protein F5v1 (SEQ ID NO.31).

FIG. 26 shows the amino acid sequence of selected NRSF-based protein F5v2 (SEQ ID NO.32).

FIG. 27 shows the amino acid sequence of selected NRSF-based protein F5v3 (SEQ ID NO.33).

FIG. 28 shows the amino acid sequence of selected NRSF-based protein F5v4 (SEQ ID NO.34).

FIG. 29 shows the amino acid sequence of selected NRSF-based protein F5v5 (SEQ ID NO.35).

FIG. 30 shows the amino acid sequence of selected NRSF-based protein F5v6 (SEQ ID NO.36).

FIG. 31 shows the amino acid sequence of selected NRSF-based protein F5v7 (SEQ ID NO.37).

FIG. 32 shows the amino acid sequence of selected NRSF-based protein F5v8 (SEQ ID NO.38).

FIG. 33 shows sequences of a) wild-type and b) re-engineered variants of NRSF finger 6 with the relevant portions of their associated consensus or mutant NRSE sequences, as described in Example 7. Arrows indicate contacts consistent with interactions observed in previously described zinc finger-DNA interfaces.

FIG. 34 shows sequences of a) wild-type and b) re-engineered variants of NRSF finger 8 with the relevant portions of their associated consensus or mutant NRSE sequences, as described in Example 7. Arrows indicate contacts consistent with interactions observed in previously described zinc finger-DNA interfaces.

FIG. 35 b) summarizes NSRF—NRSE interactions as determined from the NRSF finger re-engineering data presented herein, in comparison with predicted interactions (part a).

### DETAILED DESCRIPTION

I. Introduction

The present invention provides engineered multi-finger Zf polypeptides that bind with great specificity to a sequence of interest, and methods of selection thereof. The scaffold Zf protein that is used as the starting point from which to engineer and select these Zf polypeptides can be any Zf protein that comprises more than three zinc fingers.

In one embodiment, the Zf protein used as the scaffold is selected from the group consisting of CCCTC-binding factor (CTCF), the Kruppel-associated box protein KS1, Evi-1, myeloid zinc finger protein (MZF), and neuron restrictive silencing factor (NRSF). In a preferred embodiment, the scaffold protein used is the naturally occurring transcription factor NRSF, which has a DNA binding domain comprising 8 Zfs.

Using the methods of the present invention, all Zfs can be engineered and selected for binding to a sequence of interest, enabling the construction of an engineered Zf protein, for example, that binds to a sequence of interest spanning up to 21 bp. The present invention also provides methods for selection of suitable target sequences within genes of interest. Further details of the methods of the present invention are provided below.

II. Definitions

As used herein, the following terms have the meanings ascribed to them unless specified otherwise.

In this disclosure, “comprises,” “comprising,”¹ “containing” and “having” and the like can have the meaning ascribed to them in U.S. Patent law and can mean “includes,” “including,” and the like; “consisting essentially of” or “consists essentially” likewise has the meaning ascribed in U.S. Patent law and the term is open-ended, allowing for the presence of more than that which is recited so long as basic or novel characteristics of that which is recited is not changed by the presence of more than that which is recited, but excludes prior art embodiments.

Methods of the present invention can be used to select a non-naturally occurring scaffold-based zinc-finger polypeptide comprising more than three zinc fingers, wherein the selected polypeptide has at least one amino acid residue in at least one zinc finger that differs in sequence from a scaffold polypeptide, and wherein the polypeptide binds to a DNA sequence of interest but does not bind to a naturally occurring DNA binding site of the scaffold polypeptide. Using methods of the present invention, a scaffold polypeptide is re-engineered into a new scaffold-based zinc-finger polypeptide which has novel structural and functional features, such that the new polypeptide binds to a sequence of interest but does not bind to a naturally occurring DNA binding site of the scaffold protein.

The term “zinc finger” or “Zf” refers to a polypeptide having DNA binding domains that are stabilized by zinc. The individual DNA binding domains are typically referred to as “fingers.” A Zf protein has at least one finger, preferably 2 fingers, 3 fingers, or 6 fingers. A Zf protein having two or more Zfs is referred to as a “multi-finger” or “multi-Zf” protein. Each finger typically comprises an approximately 30 amino acid, zinc-chelating, DNA-binding domain. An exemplary motif characterizing one class of these proteins is -Cys-(X) (2-4)-Cys-(X) (12)-His-(X) (3-5)-His (SEQ ID NO:9), where X is any amino acid, which is known as the “C(2)H(2)class.” A single Zf of this class typically consists of an alpha helix containing the two invariant histidine residues co-ordinated with zinc along with the two cysteine residues

Each finger within a Zf protein binds to from about two to about five base pairs within a DNA sequence. Typically a single Zf within a Zf protein binds to a three or four base pair “subsite” within a DNA sequence. Accordingly, a “subsite” is a DNA sequence that is bound by a single zinc finger. A “multi-subsite” is a DNA sequence that is bound by more than one zinc finger, and comprises at least 4 bp, preferably 6 bp or more. A multi-Zf protein binds at least two, and typically three, four, five, six or more subsites i.e., one for each finger of the protein.

The term “scaffold” as used herein refers to a Zf protein having more than three zinc fingers, or a portion thereof (such as the DNA binding domain) that is used as the starting point from which to engineer a new Zf protein by altering its amino acid sequence. The term scaffold specifically excludes naturally occurring proteins having three or fewer zinc fingers, such as zif268, and Sp I. Any Zf protein having more than three zinc fingers, can be used as a scaffold protein in the methods of the present invention. “Scaffold” zinc finger proteins, as used herein, includes naturally occurring zinc finger proteins, and artificially created or selected derivatives of naturally occurring zinc finger proteins.

In one embodiment, the scaffold protein is selected from the group comprising CTCF, NRSF, KS1, Evi-1 and MZF. In a preferred embodiment, scaffold protein is the naturally occurring transcription factor NRSF, or a Zf-containing portion thereof.

The non-naturally occurring proteins or polypeptides that are generated by alteration of the amino acid sequence of the scaffold protein are referred to as “scaffold-based” or “scaffold-derived.” In embodiments where the scaffold protein is NRSF, the proteins or polypeptides that are generated by alteration of the amino acid sequence of the NRSF protein are referred to as “NRSF-based”or “NRSF-derived.”

The methods of the present invention involve engineering scaffold proteins to generate new non-naturally occurring scaffold-based Zf proteins that bind to a chosen target site or “sequence of interest” but do not bind to the natural DNA binding site of the scaffold protein (such as the NRSE in the case of NRSF). The terms “designed” “engineered” “synthetic” “artificial” and “non-naturally occurring” as used herein refer to Zf proteins that have been generated or selected to bind to a sequence of interest that is not a “naturally occurring DNA binding site” of the scaffold protein, and which differ in amino acid sequence from a scaffold protein. As used herein, the term “naturally occurring DNA binding site” refers to one or more native genomic DNA sequences for which there is specific binding at the points of contact between the amino acids of the regulatory factor (e.g., transcription factor) and the nucleotides of the DNA sequence, in vivo.

The present invention provides methods for the selection of zinc finger proteins that bind to a desired nucleotide sequence comprising several subsites, which is referred to herein as a “sequence of interest”. A “sequence of interest” is typically located within a “gene of interest.” A sequence of interest can comprise any desired number of base pairs. Advantageously, a sequence of interest comprises from between 2 and 24 base pairs. Zf proteins that bind to sequences of interest comprising from 6 For example, in one embodiment a “sequence of interest” is a string of consecutive subsites located in the vicinity of the promoter of a gene of interest. In another embodiment, a sequence of interest may be located within the coding region of a gene of interest. However, the “sequence of interest” need not be located in a natural gene, but can be any sequence chosen as the binding site of an engineered zinc finger protein, using the methods of the present invention. For example, in one embodiment, the methods of the present invention can be used to select a Zf protein that binds to a specific sequence in a piece of DNA that has been artificially altered, such as a recombinant DNA molecule in a vector, or a manipulated nucleotide sequence in a transgenic animal.

As used herein the term “target site” refers to any nucleic acid sequence bound by a Zf protein, and encompasses “sequences of interest”. For example, target sites may be artificially created nucleotide sequences that are used solely at certain stages in the selection procedure, and are not the actual “sequence of interest” to which the final selected Zf protein will bind. For example, in the methods of the present invention, artificial DNA constructs known as “target site constructs” can be used in primary selection steps. These “target site constructs” have one target subsite whose sequence is identical to a portion of the sequence of the “sequence of interest” and have one or more other subsites having sequences that are not present in the “sequence of interest” but which are chosen because they bind to the “anchor” fingers in the primary Zf library.

Naturally occurring transcription factors typically bind to one or more “naturally occurring DNA binding sites”. The DNA sequence that is bound by the naturally occurring transcription factor NRSF is known as a Neuron Restrictive Silencer Element or “NRSE”. The exact nucleotide sequence of the NRSE sequence that NRSF binds varies between the group of 50 or so genes that are regulated by NRSF. However, a consensus NRSE sequence has been derived from nineteen different experimentally conserved NRSF binding sites: ^{3′}CcgcGAcAGGcaCCACGACtt^{5′} (SEQ ID NO.10). Thirteen positions in this consensus NRSE are strongly conserved (uppercase letters) and 8 are more weakly conserved (lowercase letters). None of the nineteen sequences used to derive the consensus differ by more than 6 bases from the consensus. Examination of experimentally confirmed NRSE sequences reveals that very few differ from the consensus by more than 3 bases (and these differences typically occur in the more weakly conserved positions). As used herein the term “NRSE” refers to any sequence fitting (or partially matching) this consensus sequence (SEQ ID NO.10).

The term “linker” or “inter-finger linker” as used herein refers to a stretch of amino acids located between two Zfs in a given protein or polypeptide. In certain embodiments of the present invention, selected zinc finger proteins are covalently linked together using such amino acid linkers. In other embodiments, selected zinc finger proteins are non-covalently linked by the process of “multimerization” or “dimerization”. As used herein “multimerization” refers to the non-covalent linkage of more than two individual proteins or polypeptides, while “dimerization” refers the non-covalent linkage of only two individual proteins or polypeptides. The individual proteins that are linked together may be identical to each other, in which case the proteins are said to “homo-multimerize” or homo-dimerize”, or they may be different, in which case the proteins are said to “hetero-multimerize” or hetero-dimerize”. The protein complexes produced by such non-covalent linkages are referred to as “multimers” or “dimers,” respectively. The production of such a zinc finger multimer or dimer may be performed by fusion of a “multimerization domain” or “dimerization domain” to a selected zinc finger protein. Such domains are amino acid sequences that when present in a polypeptide cause that polypeptide to multimerize or dimerize.

The term “library” as used herein refers to a population of nucleic acid sequences that encode Zf polypeptides. Such “libraries” are used in the present invention to select for and identify Zf polypeptides having desired characteristics from a large and complex pool of Zf polypeptides. Such libraries can be created in cell free systems or within eukaryotic cells, prokaryotic cells or viral particles. The term “primary library” refers to a library that has not been “enriched” for nucleic acids encoding Zf polypeptides with particular characteristics. The term “secondary library” refers to a library that is enriched for nucleic acids encoding Zf polypeptides with particular characteristics, such as binding to a given target site construct.

The term “randomized” or “randomize” refers to a pool of Zf molecules, or the generation of a pool of Zf molecules, in which one of a multitude of possible amino acids is represented at one or more given “variable” amino acid positions.

In one embodiment, the methods of the present invention can utilize any Zf protein that has more than three zinc fingers, such as for example, the naturally occurring Zf proteins CTCF, KS1, Evi-1 and MZF. Unless otherwise specified, all Zf proteins referred to herein include, not just the full-length polypeptides, but also variants, homologues, species homologues (for example the corresponding human, rat and mouse proteins), and fragments of these polypeptides, and additionally the nucleic acid sequences encoding any of these polypeptides.

In preferred embodiments, methods of the present invention utilize the “Neuron Restrictive Silencer Factor” or “NRSF” protein, which is also known as the “RE-1 silencing transcription factor” or “REST”, or variants, fragments or homologues thereof, as the scaffold polypeptide. Unless otherwise specified, the name “NRSF” as used herein refers to NRSF proteins, or nucleic acids encoding NRSF proteins, from any animal species. Thus the name “NRSF” encompasses, for example, human, rat and mouse NRSF proteins. Furthermore, the name “NRSF” encompasses all splice variants of the NRSF protein, several of which are known (see for example, Palm et al., J. Neurosci 15: 1280-96 (1998) and Palm et al., Brain Res 8: 72 (1999)). As used herein, the name “NRSF” includes variants, homologues and fragments of the NRSF protein.

As used herein the term “selection” has its normal meaning in the art, i.e. selection is the process of detecting or identifying a protein, nucleic acid molecule, cell, or virus having desired properties. Typically the selection methods of the present invention utilize selective media such that only proteins, nucleic acid molecules, cells, or viruses having the desired properties are able to survive, while all other r viruses are killed or inactivated. However, the selection methods of the present invention can also utilize “screening” methods whereby those proteins, nucleic acid molecules, cells, or viruses having the desired properties are detected and picked out from a mixed population without the need for killing or inactivating those proteins nucleic acid molecules, cells, or viruses that do not have the desired properties. For example, when “screening” methods are used, the desired proteins, nucleic acid molecules, cells, or viruses may be identified visually, such as by the detecting the expression of a fluorescent marker, or by any other suitable means.

The term “homologue”, as used herein, refers to a protein or nucleic acid sharing a certain degree of sequence “identity” or sequence “similarity” with a given protein, or the nucleic acid encoding the given protein. The term “percent identity” refers to the percentage of residues in two sequences that are the same when aligned for maximum correspondence. Sequence “similarity” is related to sequence “identity”, but differs in that residues that are not exactly the same as each other, but that are functionally “similar” are taken into consideration.

For example, by way of illustration only, a protein A may be considered to be 100% similar, or share 100% homology with a protein B, even though not all of the amino acids in the two proteins are identical, if the amino acids that differ between the two proteins are “conservative substitutions”.

Those of skill in the art will understand what is meant by “conservative substitutions.” For example, a 3-methyl-histidine residue may be substituted for a histidine residue, a 4-hydroxy-proline residue may be substituted for a proline residue, a 5-hydroxylysine residue may be substituted for a lysine residue, and the like. Furthermore, “conservative substitutions” include substitutions of amino acids with chemically similar amino acids. Conservative substitution tables providing functionally similar amino acids are well known in the art. The following six groups each contain amino acids that are conservative substitutions for one another:

1) Alanine (A), Serine (S), Threonine (T);

2) Aspartic acid (D), Glutamic acid (E);

3) Asparagine (N), Glutamine (Q);

4) Arginine (R), Lysine (K);

5) Isoleucine (1), Leucine (L), Methionine (M), Valine (V); and

6) Phenylalanine (F), Tyrosine (Y), Tryptophan (W).

See also, Creighton (1984) Proteins W.H. Freeman and Co.

Conservative substitutions typically include the substitution of one amino acid for another with similar characteristics such as substitutions within the following groups: valine, glycine; glycine, alanine; valine, isoleucine; aspartic acid, glutamic acid; asparagine, glutamine; serine, threonine; lysine, arginine; and phenylalanine, tyrosine. The non-polar (hydrophobic) amino acids include alanine, leucine, isoleucine, valine, proline, phenylalanine, tryptophan and methionine. The polar neutral amino acids include glycine, serine, threonine, cysteine, tyrosine, asparagine and glutamine. The positively charged (basic) amino acids include arginine, lysine and histidine. The negatively charged (acidic) amino acids include aspartic acid and glutamic acid.

Other conservative substitutions are described by Dayhoff in the Atlas of Protein Sequence and Structure (1988).

There are a number of different algorithms known in the art which can be used to quantify sequence similarity or identity. For instance, polypeptide sequences can be compared using NCBI BLASTp. Alternatively, FASTA, a program in GCG version 6.1. FASTA provides alignments and percent sequence identity of the regions of the best overlap between the query and search sequences (Peterson, 1990). Alternatively, nucleotide sequence similarity or homology or identity can be determined using the “Align” program of Myers and Miller, (“Optimal Alignments in Linear Space”, CABIOS 4, 11-17, 1988) and available at NCBI.

The term “homology” as used herein with respect to a nucleotide or amino acid sequence, is intended to indicate a quantitative measure of the “identity” or “similarity” between two sequences. The percent sequence identity can be calculated as (N_{ref}−N_{dif})*100/N_{ref}, wherein N_{dif} is the total number of non-identical residues in the two sequences when aligned and wherein N_{ref} is the number of residues in one of the sequences. Hence, the DNA sequence AGTCAGTC will have a sequence identity of 75% with the sequence AATCAATC (N_{ref}=8; N_{dif}=2).

Alternatively or additionally, “identity” with respect to sequences refers to the number of positions with identical nucleotides divided by the number of nucleotides in the shorter of the two sequences wherein alignment of the two sequences can be determined in accordance with the Wilbur and Lipman algorithm (Wilbur and Lipman, 1983 PNAS USA 80:726), for instance, using a window size of 20 nucleotides, a word length of 4 nucleotides, and a gap penalty of 4, and computer-assisted analysis and interpretation of the sequence data including alignment can be conveniently performed using commercially available programs (e.g., Intelligenetics™ Suite, Intelligenetics Inc. CA).

When RNA sequences are said to be similar, or have a degree of sequence identity with DNA sequences, thymidine (T) in the DNA sequence is considered equal to uracil (U) in the RNA sequence.

Thus, the term “homolgue” as used herein refers to protein or nucleic sequences sharing either a certain degree of “indentity” or “similarity” with another sequence.

In one embodiment, the homologues of the present invention share at least 70%,75%,80%,85%, 90%,95%,96%,97%,98%, or 99% sequence similarity with scaffold proteins within their DNA binding domains. Preferably the homologues share at least 80%, 85%, 90%, 95%, 96%, 97%, 98%, or 99% sequence similarity. More preferably the homologues share at least 90%, 95%, 96%, 97%, 98%, or 99% sequence similarity with that of the scaffold proteins within their DNA binding domains. More preferably still, the homologue's share 95%, 96%, 97%, 98%, or 99% sequence similarity with the scaffold proteins in their DNA binding domains.

In another embodiment, the homologues of the present invention share at least 70%, 75%, 80%, 85%, 90%, 95%, 96%, 97%, 98%, or 99% sequence identity with scaffold proteins within their DNA binding domains. Preferably the homologues share at least 80%, 85%, 90%, 95%, 96%, 97%, 98%, or 99% sequence identity. More preferably the homologues share at least 90%, 95%, 96%, 97%, 98%, or 99% sequence identity with that of the scaffold proteins within their DNA binding domains. More preferably still, the homologues share 95%, 96%, 97%, 98%, or 99% sequence identity with the scaffold proteins in their DNA binding domains.

The homology to the scaffold protein need not span the entire length of the scaffold protein. Only the zinc finger DNA binding domain of the scaffold protein need be used in the methods of the present invention. Therefore, the above degrees of homology relate to the amino acid sequence of the zinc finger DNA binding domain of the scaffold protein.

A “functional” homologue or fragment of the scaffold protein, polypeptide or nucleic acid is a protein, polypeptide or nucleic acid whose sequence is not identical to the full-length the scaffold protein, polypeptide or nucleic acid, but yet retains some of the same functions as the full-length the scaffold protein, polypeptide or nucleic acid. In particular, in the methods of the present invention, a “functional homologue” is one that encodes a protein that conforms to a zinc finger consensus sequence, and is capable of binding to DNA. A functional fragment can possess more, fewer, or the same number of residues as the corresponding native molecule, and/or can contain one or more amino acid or nucleotide substitutions. Methods for determining the function of a nucleic acid (e.g., coding function, ability to hybridize to another nucleic acid) are well-in the art. Similarly, methods for determining protein function are well known. For example, the DNA-binding function of a polypeptide can be determined, for example, by filter-binding, electrophoretic mobility-shift, or immunoprecipitation assays. See Ausubel et al., supra. The ability of a protein to interact with another protein can be determined, for example, by co-immunoprecipitation, two-hybrid assays or complementation, both genetic and biochemical. See, for example, Fields et al. (1989) Nature 340:245-246; U.S. Pat. No. 5,585,245 and PCT WO 98/44350.

“K_{D}” refers to the dissociation constant for binding of one molecule to another molecule, i.e., the concentration of a molecule (such as a Zf protein), that gives half maximal binding to its binding partner (such as a DNA target sequence) under a given set of conditions. The K_{D} provides a measure of the strength of the interaction between two molecules, or the “affinity” of the interaction between two molecules. Two molecules that bind strongly and specifically to each other have a “high affinity” and an “high specificity” for each other. “High affinity”, as used herein typically refers to interactions having a K_{D} in the range of 5-100 pM. “High specificity” as used herein, typically refers to interaction having a specificity ratio of 15,000 or higher. Molecules that bind significantly more weakly, and/or with a significantly lower specificity, to each to each other are said to have a “low affinity” and/or a “low specificity” for each other.

The term “recombinant” when used herein with reference to portions of a nucleic acid or protein, indicates that the nucleic acid comprises two or more sub-sequences that are not found in the same relationship to each other in nature. For instance, a nucleic acid that is recombinantly produced typically has two or more sequences from distinct genes or non-adjacent regions of the same gene, synthetically arranged to make a new nucleic acid sequence encoding a new protein, for example, a DBD from one source and a “functional” or “regulatory” region from another source, or a Zf from the native Zif268 protein and a Zf selected from a library. The term “recombination” as used herein, refers to the process of producing a recombinant protein or nucleic acid by standard techniques known to those skilled in the art, and described in, for example, Sambrook et al., Molecular Cloning; A Laboratory Manual 2d ed. (1989).

“Nucleotide” refers to a base-sugarphosphate compound. Nucleotides are the monomeric subunits of both types of nucleic acid molecules, RNA and DNA. Nucleotide refers to ribonucleoside triphophates, rATP, rGTP, rUTP and rCTP, and deoxyribonucleoside triphosphates, such as dATP, dGTP, dTTP, and dCTP.

“Base” refers to the nitrogen-containing base of a nucleotide, for example ade9 (A), cytidine (C), guanine (G), thymine (T), and uracil (U). “Base pair” or “bp” refers to the partnership of bases within the DNA double helix, whereby typically an A on one strand of the double helix is paired with a T on the other strand and a C on one strand of the double helix is paired with a G on the other strand.

“Nucleic acid” refers to deoxyribonucleotides or ribonucleotides and polymers thereof in either single- or double-stranded form. The term encompasses nucleic acids containing known nucleotide analogs or modified backbone residues or linkages, which are synthetic, naturally occurring, and non-naturally occurring, which have similar binding properties as the reference nucleic acid, and which are metabolized in a manner similar to the reference nucleotides. Examples of such analogs include, without limitation, phosphorothioates, phosphoramidates, methyl phosphonates, chiral-methyl phosphonates, 2-O-methyl ribonucleotides, peptide-nucleic acids (PNAs). Unless otherwise indicated, a particular nucleic acid sequence also implicitly encompasses conservatively modified variants thereof (e.g., degenerate codon substitutions) and complementary sequences, as well as the sequence explicitly indicated. The term nucleic acid is used interchangeably with gene, cDNA and nucleotide. The nucleotide sequences are displayed herein in the conventional 5′ to 3′ orientation.

The terms “polypeptide,” “peptide” and “protein” are used interchangeably herein to refer to a polymer of amino acid residues. The terms apply to amino acid polymers in which one or more amino acid residue is an analog or mimetic of a corresponding naturally occurring amino acid, as well as to naturally occurring amino acid polymers. Polypeptides can be modified, e.g., by the addition of carbohydrate residues to form glycoproteins. The terms “polypeptide,” “peptide” and “protein” include glycoproteins, as well as non-glycoproteins. The polypeptide sequences are displayed herein in the conventional N-terminal to C-terminal orientation.

The term “amino acid” refers to naturally occurring and synthetic amino acids, as well as amino acid analogs and amino acid mimetics that function in a manner similar to the naturally occurring amino acids. Naturally occurring amino acids are those encoded by the genetic code, as well as those amino acids that are later modified, e.g., hydroxyproline, carboxyglutamate, and O-phosphoserine. Amino acid analogs refers to compounds that have the same basic chemical structure as a naturally occurring amino acid, i.e., a carbon that is bound to a hydrogen, a carboxyl group, an amino group, and an R group, e.g., homoserine, norleucine, methionine sulfoxide, methionine, and methyl sulfonium. Such analogs have modified R groups (e.g., norleucine) or modified peptide backbones, but retain the same basic chemical structure as a naturally occurring amino acid. Amino acid mimetics refers to chemical compounds that have a structure that is different from the general chemical structure of an amino acid, but that functions in a manner similar to a naturally occurring amino acid. The terms “amino acid residue” or “residue” refer to a specific amino acid position within a polypeptide or protein.

Degenerate codon substitutions or “doping strategies” may be achieved by generating sequences in which any position of one or more selected (or all) codons is substituted with mixed-base and/or deoxyinosine residues (Batzer et al., Nucleic Acid Res. 19:5081 (1991); Ohtsuka et al., J. Biol. Chem. 260:2605-2608 (1985); Rossolini et al., Mol. Cell. Probes 8:91-98 (1994)). Because of the degeneracy of the genetic code, a large number of functionally identical nucleic acids encode any given protein. For instance, the codons GCA, GCC, GCG and GCU all encode the amino acid alanine. Thus, at every position where an alanine is specified by a codon in an amino acid herein, the codon can be altered to any of the corresponding codons described without altering the encoded polypeptide. Such nucleic acid variations are “silent variations,” which are one species of conservatively modified variations. Every nucleic acid sequence herein which encodes a polypeptide also describes every possible silent variation of the nucleic acid. One of skill will recognize that each codon in a nucleic acid (except AUG, which is ordinarily the only codon for methionine, and TGG, which is ordinarily the only codon for tryptophan) can be modified to yield a functionally identical molecule. Accordingly, each silent variation of a nucleic acid which encodes a polypeptide is implicit in each described sequence.

“Specific” or “specific-binding” as used herein, refers to the interaction between a protein and a nucleic acid wherein the protein recognizes and interacts with a defined nucleotide sequence or sequences, as opposed to a “non-specific” interaction wherein the protein does not require a defined nucleotide sequence to associate with the nucleic acid molecule (for example, a protein that interacts with the phosphate-sugar backbone of the DNA but not the bases of the nucleotides). The strength of the association between the protein and the nucleic acid molecule can vary significantly between different “binding complexes.” A “binding complex,” as used herein, comprises an association between a sequence of interest, target site or subsite and a Zf binding domain. “Binding complexes” can comprise both weakly-bound Zf proteins and nucleic acids and strongly-bound Zf proteins and nucleic acids. The strength or “affinity”of the association of a Zf with an intended or specified sequence of interest, target site or subsite is expressed in terms of the K_{D}, as defined above.

“Conditions sufficient to form binding complexes” refers to the physical parameters selected for a binding reaction or “incubation” between a nucleic acid and a protein sample that potentially contains an unknown nucleic acid-binding protein, such as, buffer ionic strength, buffer pH, temperature, incubation time, and the concentrations of nucleic acid and protein, where such physical parameters allow nucleic acids to bind to proteins. Such conditions can be “low-stringency conditions”, which are conducive to the formation of “binding complexes” comprising both weakly- and strongly-bound proteins and nucleic acids or “high-stringency conditions”, which are conducive to the formation of “high affinity binding complexes” comprising only strongly-bound proteins and nucleic acids. Low-stringency conditions typically comprise high salt concentration and a temperature ranging between 37° C. and 47° C. When DNA-protein “binding reactions” or “incubations” are performed in vitro, high-stringency conditions typically comprise lower salt concentrations, a temperature of 65° C. or greater, and a detergent, such as sodium dodecylsulfate (SDS) at a concentration ranging from about 0.1% to about 2%. When DNA-protein “binding reactions” or “incubations” are performed within living cells, the stringency of the binding reaction is controlled, for example, as described by Joung et al. (Joung et al., 2000, Proceedings of the National Academy of Sciences (USA) 97:7382 and US Patent Application No. 20020119498).

Further definitions are provided in context below.

III. “Scaffolds” from which Non-Naturally Occurring Multi-Finger Zinc Finger Proteins can be Engineered.

The methods of the present invention involve altering or “engineering” the DNA binding specificity of Zf proteins to produce non-naturally occurring Zf proteins or polypetides capable of binding to sequences of interest. These zinc finger polypeptides are referred to as “scaffolds,” and can be any zinc finger protein that has more than three zinc fingers. For example, scaffold proteins comprise naturally occurring zinc finger proteins that have more than three zinc fingers, and artificially generated derivatives of such naturally occurring zinc finger proteins. Thus, the scaffold protein itself may comprise a zinc finger protein that has already been engineered in some way.

In one embodiment the scaffold polypeptide is selected from the group comprising CTCF, NRSF, KS1, Evi-1 and MZF.

In a preferred embodiment, the scaffold polypeptide is NRSF. Thus, the present invention comprises, a non-naturally occurring NRSF-based zinc-finger polypeptide that differs from a naturally occurring NRSF zinc-finger polypeptide by comprising at least one amino acid residue in at least one zinc finger that differs in amino acid sequence from the naturally occurring NRSF zinc-finger polypeptide, wherein the naturally occurring NRSF zinc finger polypeptide binds to a NRSE consensus sequence, and the non-naturally occurring NRSF-based zinc finger polypeptide binds to a sequence of interest but does not bind to the NRSE consensus sequence.

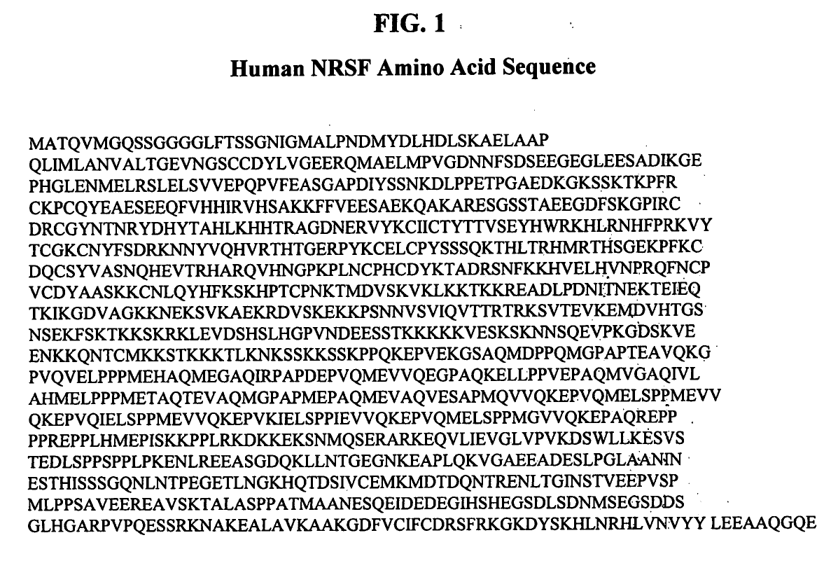

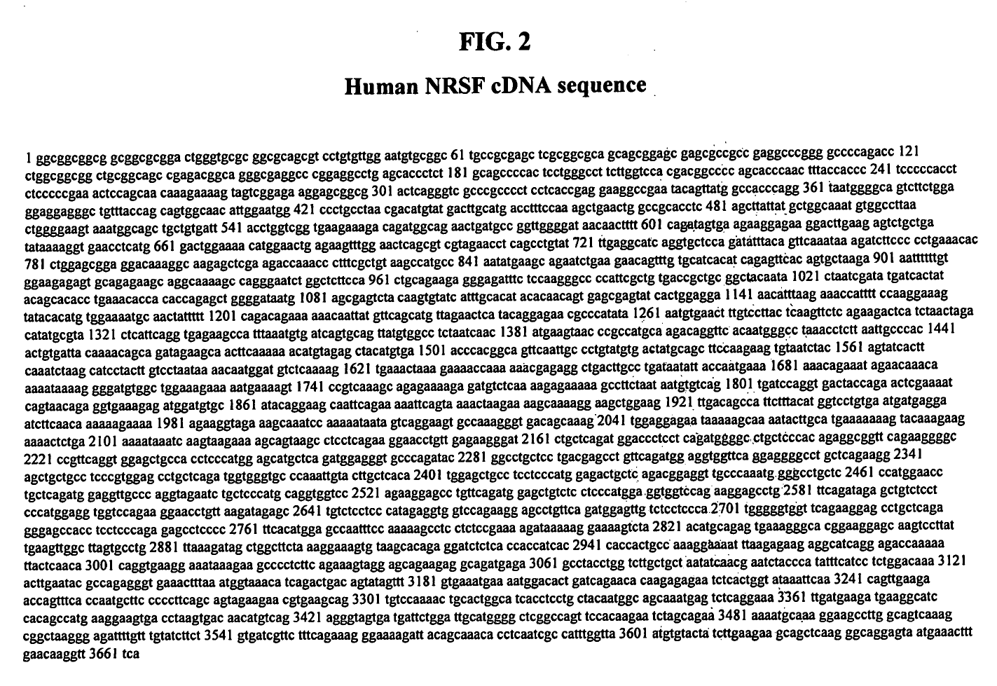

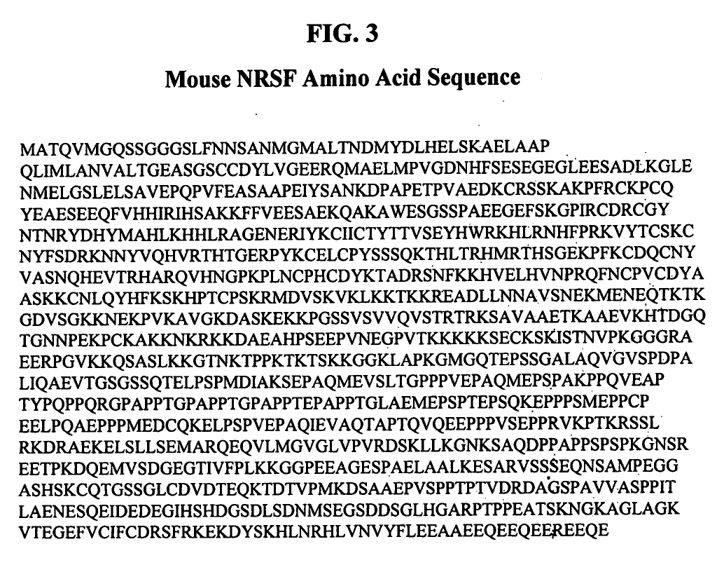

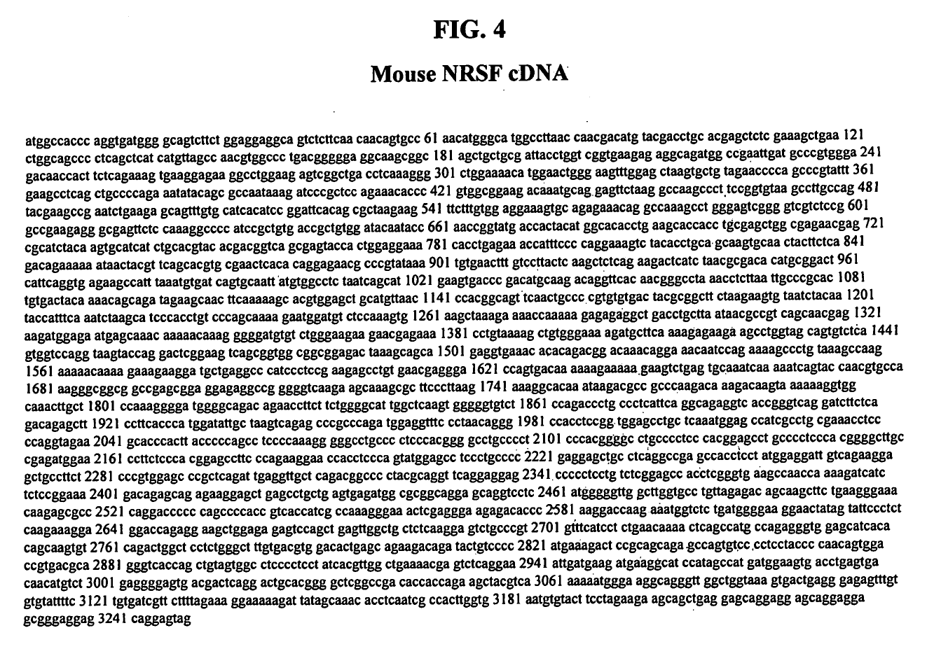

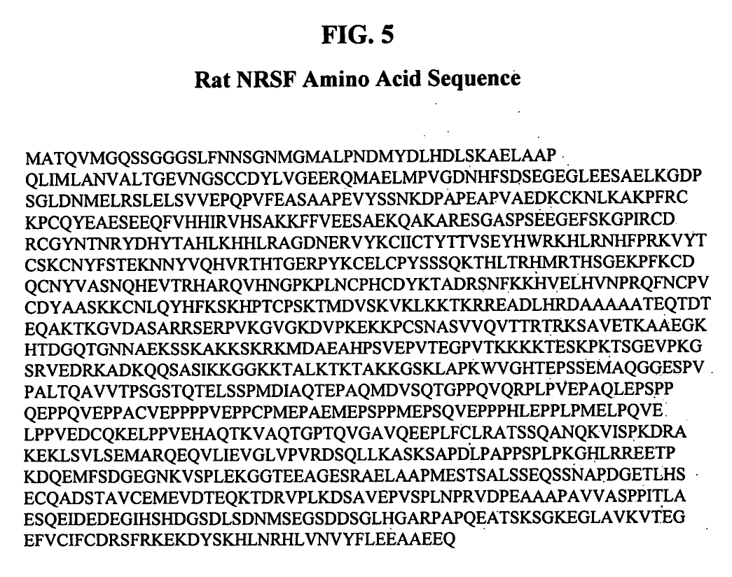

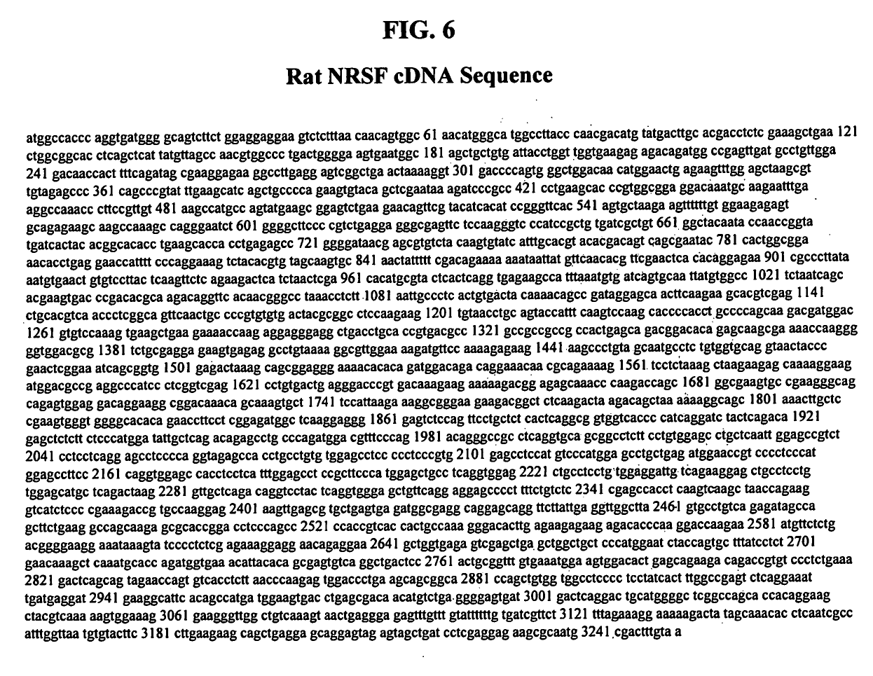

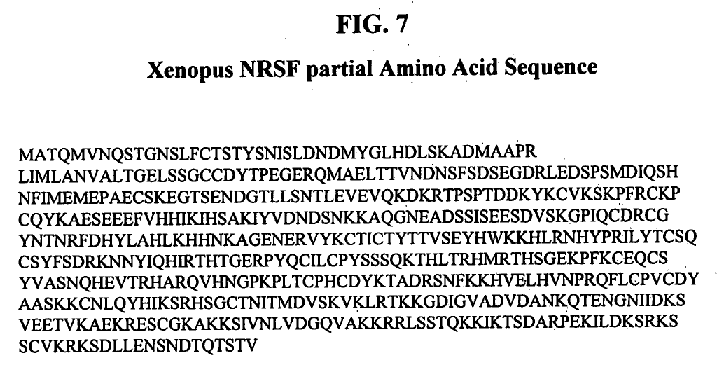

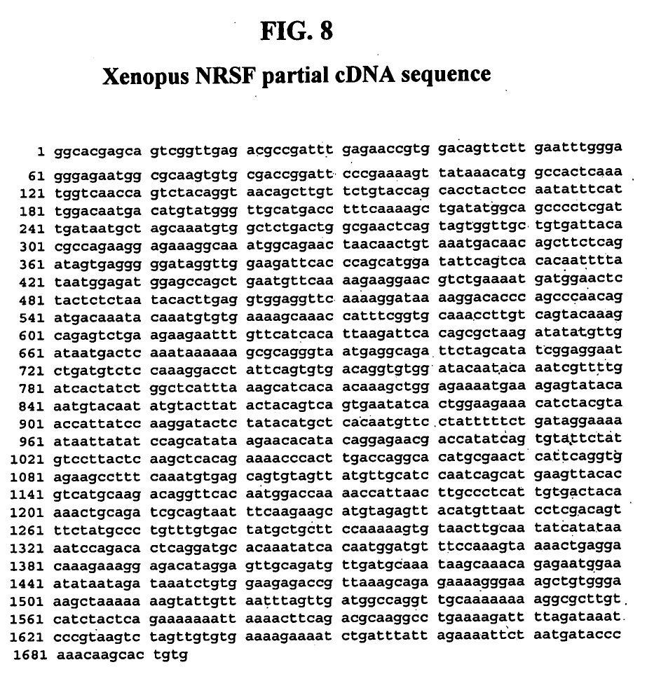

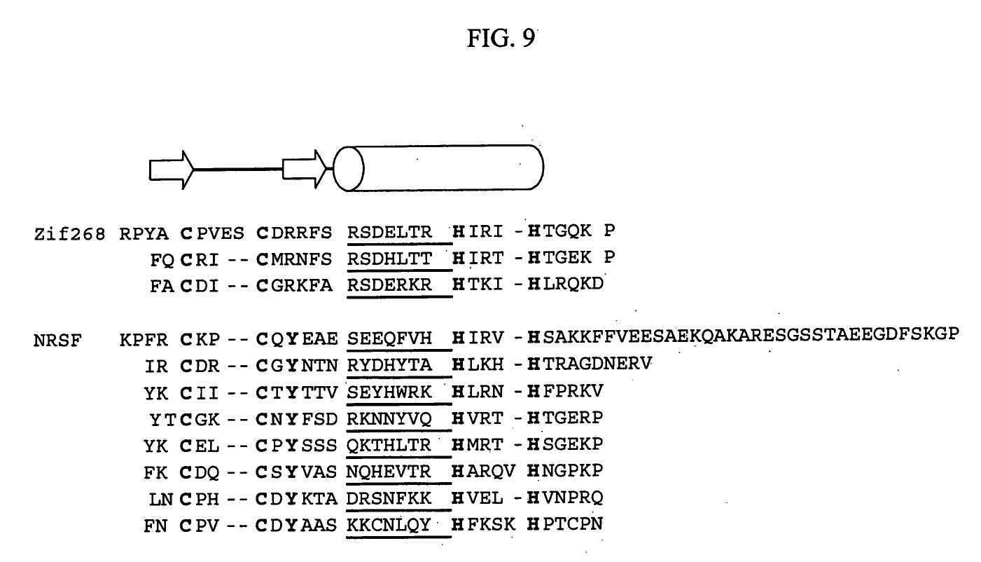

The full-length human NRSF protein consists of 1097 amino acid residues. The amino acid sequence of this protein, which was first reported by Chong et al. (Cell 80 (6) 949-957 (1995)) and Schoenherr et al. (Science 267 (5202) 1360-1363 (1995)), is provided in FIG. 1 (SEQ ID NO.1) and has Gene Bank accession no. NP_{—}005603. The cDNA encoding the human NRSF protein consists of 3294 bases. The nucleotide sequence of this cDNA is provided in FIG. 2 (SEQ ID NO. 2) and has Gene Bank accession no. NM_{—}005612. The amino acid sequence (SEQ ID NO. 3), and nucleotide sequence (SEQ ID NO.4) of mouse NRSF are shown in FIGS. 3 and 4, respectively. The amino acid sequence (SEQ ID NO.5), and nucleotide sequence (SEQ ID NO.6) of rat NRSF are shown in FIGS. 5 and 6, respectively. The amino acid sequence (SEQ ID NO.7), and nucleotide sequence (SEQ ID NO.8) of Xenopus NRSF are shown in FIGS. 7 and 8, respectively. FIG. 9 illustrates the amino acid sequences of each of the 8 zinc fingers and the inter-finger linkers of human NRSF (taken from SEQ ID NO.1). U.S. Pat. Nos. 5,935,811 and 6,270,990 describe the nucleotide and amino acid sequence of the wild-type human NRSF protein.

As with all “C₂H₂-type” Zf proteins, the Zfs in the NRSF DNA binding domain contain 2 conserved cysteine residues and 2 conserved histidine residues. However, in several respects, the DNA binding domain of NRSF differs from those found in most other Zf transcription factors. For example, the Zfs in NRSF most closely match the less common zinc finger consensus sequence Y—X—C—X₂—C—X—F—X₇-L-X₂—H—X₄—H (SEQ ID NO.11), as opposed to the more common motif (F/Y)—X—C—X₂₋₅—C—X₃-(F/Y)—X₅-Φ—X₂—H—X₃₋₅—H (SEQ ID NO.12) (where X is any amino acid and Φ is a hydrophobic amino acid) found in proteins such as Zif268. All 8 Zfs of NRSF harbor a tyrosine residue at the position that is two amino acids carboxy-terminal to the second conserved cysteine (see FIG. 2) as opposed to the more commonly found phenylalanine. In addition, several of the inter-finger linkers in NRSF differ in length and/or composition from the consensus TGEKP-type linkers found in many other Zf proteins including zif268. For example, the linkers between Zf1 and Zf2 and between Zf2 and Zf3 comprise 34 and 9 amino acids, respectively. Also, although Zfs 3 to 8 are all connected by 5 amino acid inter-finger linkers, only 2 of these (the Zf4-ZfF5 and Zf5-Zf6 linkers) are of the common TGEKP type.

Without being bound by theory, it is believed that some or all of these unusual characteristics of the NRSF DNA binding domain may provide NRSF with its unique capability to bind simultaneously to each of 20 base pairs within the NRSE target sequence. Similarly, without being bound by theory, it is believed that some or all of the characteristics of other scaffold proteins having four or more zinc fingers, may confer upon these proteins the capability to bind to extended DNA target sequences.

To alter the DNA binding specificity of a scaffold protein according to the methods of the present invention, the amino acid sequence of the zinc fingers in the DNA binding domain are altered. Any suitable method known in the art can be used to alter the amino acid sequence of the scaffold protein, such as random mutagenesis, PCR, synthetic construction and the like. (see, e.g., U.S. Pat. No. 5,786,538; Wu et al., PNAS 92:344-348 (1995); Jamieson et al., Biochemistry 33:5689-5695 (1994); Rebar & Pabo, Science 263:67′-673 (1994); Choo &. Klug, PNAS 91:11163-11167 (1994); Choo & Klug, PNAS 91: 11168-11172 (1994); Desjarlais & Berg, PNAS 90:2256-2260 (1993); Desjarlais & Berg, PNAS 89:7345-7349 (1992); Pomerantz et al., Science 267:93-96 (1995); Pomerantz et al., PNAS 92:9752-9756 (1995); and Liu et al., PNAS 94:5525-5530 (1997); Griesman & Pabo, Science 275:657-661 (1997); Desjarlais & Berg, PNAS 91:11-99-11103 (1994), Joung et al., PNAS (2000)).

In one preferred aspect, the amino acid sequences of the zinc fingers are altered randomly to generate combinatorial libraries of sequences derived from the scaffold protein. Methods for randomization of amino acid sequences and for production of libraries encoding such randomized peptides are routine practice to those skilled in the art, and any such method can be used to produce randomized scaffold-based libraries. Preferred libraries and selection strategies are described below.

The amino acid sequence of the DNA binding domain of the scaffold protein can be altered in any way desired, such that the new scaffold-derived protein binds to the target sequence of interest but does not bind to the normal or natural binding site of the scaffold protein. This may be achieved by altering anywhere from one amino acid in one zinc finger to all of the amino acids within each of the zinc fingers of the scaffold protein. Also, this might be achieved by altering the amino acid sequence of the linkers that connect each of the zinc fingers in the DNA binding domain of the scaffold polypeptide.

In a preferred embodiment, the scaffold protein is NRSF. Thus, in this preferred embodiment, the amino acid sequence of the NRSF protein is altered to produce an NRSF-derived protein that binds to a sequence of interest, but does not bind to the natural DNA binding site of NRSF, i.e. the NRSE DNA sequence.

It is preferred that the amino acid alterations that are made to the scaffold protein are controlled such that certain of the unique features of the scaffold protein, such as the spacers sequences between zinc fingers, are retained.

In a preferred embodiment, the amino acid alterations that are made to the NRSF DNA binding domain are controlled such that certain of the unique features of the NRSF DNA binding domain described above are retained. In particular, it is preferred that the engineered protein has a tyrosine residue at the position that is two amino acids carboxy-terminal to the second conserved cysteine in each zinc finger. It is also preferred that the NRSF-derived-protein retains approximately the same number of amino acid residues in the inter-finger linkers as occur in naturally occurring NRSF proteins (see FIG. 9). Thus, in a preferred embodiment the inter-finger linker between Zf 1 and Zf 2 of an NRSF-based zinc finger protein comprise about 34 amino acid residues, the linker between Zf 2 and Zf3 comprises about 9 amino acid residues, and the remaining inter-finger linkers (i.e. those between Zf3 and Zf4, Zf4 and Zf5, Zf5 and Zf6, Zf6 and Zf7, Zf7 and Zf8) are approximately 5 amino acids in length.

In an even more preferable embodiment, the linkers between each Zf in an engineered NRSF-derived protein have the same or similar amino acid sequence as the inter-finger linkers in naturally occurring NRSF proteins.

IV. Libraries and Strategies for Selection of Scaffold-Based Zf Proteins

Any strategy suitable for selection of multi-finger proteins can be used for the selection of scaffold-based Zf proteins, such as NRSF-based Zf proteins. For a review of some of such methods see Beerli and Barbas, (2002) Nature Biotechnology 20:135. For example, suitable selection strategies include Greisman and Pabo's “sequential selection” method (Greisman and Pabo (1997) Science 275:657 and U.S. Pat. No. 6,410,248), the “bipartite selection” method developed by Isalan et al. (Isalan et al., (2001) Nature Biotechnology 19: 656), and the “parallel selection” methods described by Desjarlais et al., (Proceedings of the National Academy of Sciences (USA) 90:2256, (1993)) and Choo et al., (Nature 372:642, (1994)).

However, in a preferred embodiment the “Context Sensitive Parallel Optimization” or “CSPO” strategy developed by Joung at al. is used to select the scaffold-based Zf proteins of the present invention. The general principles and detailed methods of the CSPO strategy are described in U.S. Provisional Patent Application Ser. No. 60/420,458, U.S. Provisional Patent Application Ser. No. 60/466,889, and an International PCT Application (Application Number not yet assigned), the contents of which are hereby incorporated by reference. The specific application of CSPO to the selection of the scaffold-based Zf proteins of the present invention, is described below.

Any suitable expression system can be used for expression of scaffold-based libraries for example, phage display (see U.S. Pat. No. 6,013,453 and U.S. Pat. No. 6,007,988), polysome display (WO 0027878 A1), in vitro transcription/translation, or expression in eukaryotic or prokaryotic cells, methods for which are well known in the art. Likewise, any suitable selection methods can be used to select those expressed scaffold-based Zf proteins in the library that have the desired DNA binding characteristics. In a preferred embodiment, a eukaryotic or prokaryotic cell-based system is used for both expression of the scaffold-based libraries and the selection of the scaffold-based proteins that bind to the target sequence of interest. The use of such a cell-based system advantageously provides for the selection Zf proteins that are likely to function well in a cellular context. In the most preferred embodiment, a bacterial “2-hybrid” system is used to express and select the Zfs of the present invention. The bacterial 2-hybrid selection method has an additional advantage, in that the library protein expression and the DNA binding “assay” occur within the same cells. The use of bacterial 2-hybrid systems to express and select Zf proteins is described in Joung et al., 2000, Proceedings of the National Academy of Sciences (USA) 97:7382 and US Patent Application No. 20020119498, the contents of which are incorporated herein by reference.

V. Selection of the Sequence of Interest

As described herein, using the methods of the present invention, Zfs can be designed to recognize any sequence of interest. Thus, any sequence of interest, for example in a gene of interest, can be chosen, and used as the “template” against which to select a Zf protein.

For embodiments where the selected Zf protein is to be used to regulate the expression of a gene of interest, it is desirable, although not required, that the sequence of interest be located in the general vicinity of the promoter of that gene. A general theme in transcription factor function is that simple binding and sufficient proximity to the promoter are all that is generally needed. Therefore, the exact positioning of the sequence of interest relative to the promoter (both in terms of orientation and distance) can be readily varied by one of skill in the art. This allows considerable flexibility in choosing a sequence of interest. The sequence of interest bound by the scaffold-based Zf polypeptide can be any suitable sequence in the gene of interest that will allow regulation of gene expression by a scaffold-based Zf, optionally linked to a functional domain. Preferred sequences of interest include regions adjacent to, downstream, or upstream of the transcription start site. In addition, sequences of interest that are located in enhancer regions, repressor sites, RNA polymerase pause sites, and specific regulatory sites (e.g., SP-1 sites, hypoxia response elements, nuclear receptor recognition elements, p53 binding sites), sites in the cDNA encoding region or in an expressed sequence tag (EST) coding region, can be used.

In embodiments where the selected Zf protein is to be used for applications other than regulating gene expression, different factors may be taken into consideration when selecting the “sequence of interest”. For example, in one embodiment a synthetic restriction enzyme can be created by fusing an scaffold-based Zf DNA-binding domain to an endonuclease domain. In this case the the sequence of interest is chosen so that it directs the endonuclease activity to the specific DNA sequence to be cleaved by the synthetic restriction enzyme.

In a preferred embodiment, the sequence of interest occurs only once in the genome or other desired substrate (such as a nucleic acid vector, for example). The ability to specify a unique sequence is a function of the length of the sequence of interest and the size of the genome or other substrate. For example, assuming random base distribution, a unique 16 bp sequence will occur only once in 4.3×10⁹ bp, thus a 16 bp sequence should be sufficient to specify a unique address within 4.3×10⁹ bp of sequence. Similarly, an 18 bp address would enable sequence specific targeting within 6.8×10¹⁰ bp of DNA. However, it should be noted that the “effective” frequency of such unique addresses in the human genome is likely to be significantly lower than the frequencies predicted by these purely statistical calculations, because a certain portion of the DNA in the genome is packaged into regions of densely packed chromatin that is not accessible by transcription factors. The unique target site selected can be located anywhere within or proximal to the gene of interest. Wherein the ultimate aim is to generate a synthetic transcription factor to regulate expression of the gene of interest, it is preferable that the chosen target site is within the general vicinity of the promoter and in a region where chromatin architecture will not impede binding of the Zf protein to the target site (see for example, Liu et al., (2001) Journal of Biological Chemistry 276:11323).

In one preferred embodiment any desired sequence of interest can be used to select an NRSF-based Zf protein. However, the present invention provides methods for predicting and selecting target sequences that are most likely to provide good substrates against which to select an NRSF-based Zf protein.

In a preferred embodiment, methods provided by the present invention for selection of optimum target sites make use of knowledge gained about the details of the NRSF-NRSE interaction. Modeling of the specific base contacts made by each of the Zfs within NRSF (e.g. Example 3) has enabled the development of a “framework” sequence, a partially degenerate version of the 21 base pair consensus NRSE (e.g. ^{5′}NNNNN(C/G)NNCNNGNNCNNCNNN^{3′}SEQ ID NO.13) that governs the possible sequences chosen as a target site. For NRSF-based Zf proteins, it is preferred that target sequences are selected according to this framework sequence. The fixed, non-degenerate bases in any framework sequence will be those that are contacted by recognition helix residues from more than one finger at the Zf/target site interface. Alteration of one of these “finger overlap” bases might require randomization of more than one finger to recognize a new base at that position.

“Sequences of interest” can be chosen in any gene or other nucleotide sequence (such as vectors, plasmids etc.) desired. For example, a sequence of interest may be in a “therapeutic gene” or “therapeutically useful gene.” “Therapeutic genes” are genes where there could be some therapeutic benefit obtained from up- or down-regulating expression, or otherwise altering the structure or function, of that gene. Examples of suitable genes include VEGF, erbB2, CCR5, ER.alpha., Her2/Neu, Tat, Rev, HBV C, S, X, and P, LDL-R, PEPCK, CYP7, Fibrinogen, ApoB, Apo E, Apo(a), renin, NF-.kappa.B, I-.kappa.B, TNF-.alpha., FAS ligand, amyloid precursor protein, atrial naturetic factor, ob-leptin, ucp-1, IL-1, IL-2, IL-3, IL4, IL-5, IL-6, IL-12, G-CSF, GM-CSF, Epo, PDGF, PAF, p53, Rb, fetal hemoglobin, dystrophin, eutrophin, GDNF, NGF, IGF-1, VEGF receptors fit and flk, topoisomerase, telomerase, bcl-2, cyclins, angiostatin, IGF, ICAM-1, STATS, c-myc, c-myb, TH, PTI-1, polygalacturonase, EPSP synthase, FAD2-1, delta-12 desaturase, delta-9 desaturase, delta-15 desaturase, acetyl-CoA carboxylase, acyl-ACP-thioesterase, ADP-glucose pyrophosphorylase, starch synthase, cellulose synthase, sucrose synthase, senescence-associated genes, heavy metal chelators, fatty acid hydroperoxide lyase, viral genes, protozoal genes, fungal genes, and bacterial genes. In general, suitable genes to be regulated include cytokines, lymphokines, growth factors, mitogenic factors, chemotactic factors, onco-active factors, receptors, potassium channels, G-proteins, signal transduction molecules, and other disease-related genes.

VI. CSPO Method for Selection of Scaffold-Based ZF Proteins

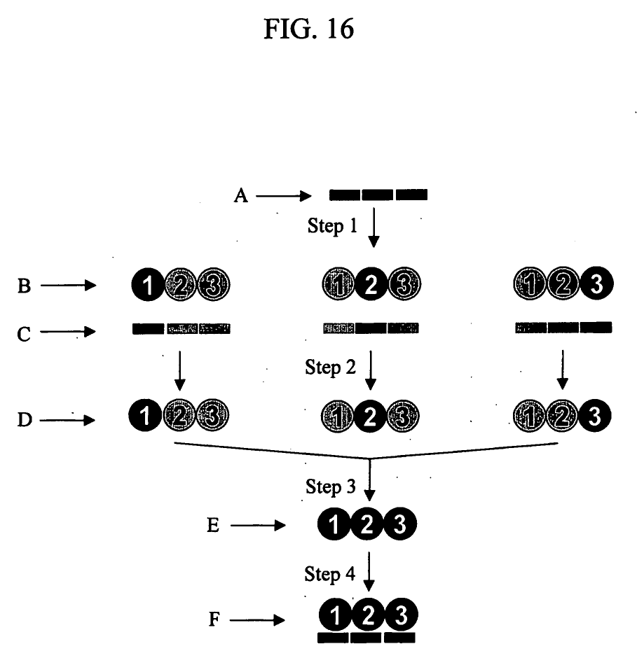

A schematic overview of the selection of Zf proteins using the CSPO method is provided in FIG. 16. Step 1 of FIG. 16 is the primary selection stage, in which “primary CSPO libraries” (B) are select for binding to “target site constructs” (C). It can be seen that three different primary libraries are required when selecting a three-finger Zf protein. The zinc fingers in each of the three primary libraries (B) are represented as numbered circles. Each of the primary libraries has one zinc finger randomized (as represented by a black circle), and two zinc fingers with a constant “anchor” sequence (as represented by the gray circles). It can be seen that each of the three primary libraries is randomized at a different zinc finger position. Zinc finger position 1 (1) is randomized in the first primary library, zinc finger position 2) is randomized in the second primary library, (2), and zinc finger position 3 (3) is randomized in the third primary library. For the selection of a three finger protein by CSPO, three different primary selections are performed in parallel. Each of the three primary libraries is selected for binding to a different “target site construct” (C). Each target site construct (C) comprises 3 subsites, one of which has the exact sequence of the corresponding subsite in the sequence of interest (as represented by the black box), while the remaining two subsites have a defined “anchor” sequence (as represented by the gray boxes). The sequences of the “anchor fingers” (represented by the gray circles) and the “anchor subsites” (represented by the gray boxes) are chosen specifically so that the anchor fingers bind to the anchor sequences, as is described further below. In primary selection 1, the primary library having zinc finger 1 randomized is selected for binding to the target site contruct in which the corresponding subsite has the exact sequence of the sequence of interest. Likewise, with other primary selections, primary libraries are selected against target sites in which the subsite having the exact sequence of the sequence of interest is that which corresponds to the position of the variable finger in the primary library.

FIG. 16 also shows that in step 2, pools of Zf proteins fingers (D) that bind to their corresponding target site with a range of affinities, are identified and selected. In step 3, the nucleic acids encoding these pools of Zf proteins are isolated and recombined randomly to produce a secondary CSPO library (E). In step 4, a secondary selection is performed in which the secondary CSPO library (E) is selected for binding to the exact sequence of interest (A) at high stringency. Thus, final selected Zf proteins (F) are identified which bind with high affinity and specificity to the sequence of interest.

i. Scaffold-Based Primary Libraries

CSPO is an efficient Zf selection strategy that allows assembled multi-finger polypeptides to be selected for binding to a desired sequence of interest while also retaining maximal combinatorial diversity in the Zf libraries used. Zf polypeptides identified using CSPO typically have an affinity and specificity for their target site that is superior to that produced by alternative methods. The CSPO method involves the two sequentially performed selection steps using two sets of libraries, as described in U.S. application Ser. No. 60/420,458, and U.S. application Ser. No. 60/466,889, the contents of which are hereby expressly incorporated herein by reference.

In CSPO methods, a separate primary library must be used for each Zf position within the multi-finger protein to be generated. For example, to select an 8 finger NRSF-based Zf protein, 8 different primary libraries are produced. The first primary library has Zf position 1 (the N-terminal Zf) randomized and Zf positions 2-8 held constant as “anchor” fingers. The second primary library has Zf position 2 (the finger C-terminal to Zf position 1 randomized and Zf positions 1 and 3-8 held constant as “anchor” fingers. The third primary library has Zf position 3 (the finger C-terminal to Zf position 2) randomized and Zf positions 1,2 and 4-8 held constant as “anchor” fingers, and so on.

Similarly, the same general method can be used to select any scaffold-based Zf protein having any number of zinc fingers. For example, a 4 Zf protein can be derived from a scaffold protein by using 4 primary libraries, each having one different finger randomized and having 3 constant anchor fingers. Similarly, a 6 Zf protein can be derived from a scaffold protein by using 6 primary libraries, each having one different finger randomized and having 5 constant anchor fingers.

Importantly, it has been surprisingly shown that Zfs 3-8 of NRSF alone are sufficient to bind to a 20 bp NRSE target sequence, and that Zfs 1 and 2 of NRSF are not required for this binding. Therefore, in a preferred embodiment, generation of a NRSF-based Zf protein for binding to a desired target sequence of 20 bp or less is performed using a maximum of 6 primary libraries, each having one of Zfs 3-8 varied. Although fingers 1 and 2 of NRSF are not required for binding to the consensus NRSE, they may make indirect contributions to DNA binding affinity and specificity (see Example 4). Therefore, it is preferred that Zfs 1 and 2 are retained in these NRSF-based libraries but are simply not varied. This will result in the selection of eight-finger proteins, but only 6 of the Zfs within the eight-finger protein will have been “engineered”. However, if desired either or both of Zf 1 and Zf 2 can be deleted from the NRSF-based libraries.

The constant “anchor” fingers in the primary libraries can be any zinc fingers chosen from any zinc finger protein. In one embodiment the “anchor” fingers are those of the scaffold protein protein. In a preferred embodiment the “anchor” fingers are those of the scaffold protein NRSF.

In one embodiment 6 amino acids residues within a single zinc finger are randomized. In a still more preferred embodiment the 6 amino acids residues randomized within a given zinc finger are the amino acid residues at positions −1, 1, 2, 3, 5, and 6, where position 1 is the first residue of the α-helical section of each zinc finger (see FIG. 9).

The number of randomized amino acids at a single variable residue position can be varied up to the maximum limits of the library expression and selection system used. Preferably, all 20 naturally occurring amino acids are represented at all randomized residue positions. However, more frequently, it will be desirable to limit the number of amino acids represented at any given residue position to 19. If cysteine is excluded, the remaining 19 naturally occurring amino acids can be encoded by 24 codons as a result of codon doping schemes (Wolfe et al., (2001) Structure 9:717). Libraries with 24 codon variations at 6 variable positions of an α-helix have a diversity of 24⁶. A library of such a size is within the limits of known expression and selection systems, such as the bacterial 2-hybrid system and phage display. Thus, in one embodiment, methods of the present invention comprise the use of libraries in which 19 different naturally occurring amino acids are represented at one or more variable residue positions of the α-helix. In this instance, the naturally occurring amino acid cysteine is excluded because cysteine cannot readily be incorporated into a 24-codon doping strategy.

In yet another embodiment, 16 naturally occurring amino acids are represented in any given randomized residue position within the α-helix. 16 amino acids can also be encoded by 24 codons using codon-doping strategies (see Joung et al., (2000) Proceedings of the National Academy of Sciences (USA) 97:7382). Thus, as for the 19 amino acid library described above, such a 16 amino acid Zf library also has a diversity of 24⁶. In the embodiment where a 16 amino acid/24 codon library is used, the excluded amino acids are preferably phenylalanine, tryptophan, tyrosine, and cysteine.

The primary libraries described herein can be synthesized using any known randomization strategy (see for example Joung et al., (2000) Proceedings of the National Academy of Sciences (USA) 97:7382), U.S. Pat. No. 6,013,453 and U.S. Pat. No. 6,007,988). Such strategies are well known to those skilled in the art and include, for example, the use of degenerate oligonucleotides, use of mutagenic cassettes and techniques based on error prone PCR. Methods of cassette mutagenesis are taught by Wolfe et al. (2000) Structure, Volume 7, p739-750 and Reidhaar-Olson et al. (1988) Science, Volume 241, p 53 to 57. Error-prone PCR uses low-fidelity polymerization conditions to introduce a low level of point mutations randomly over a long sequence. Error prone PCR can be used to mutagenize a mixture of fragments of unknown sequence. Library production and randomization strategies are described in U.S. Pat. No. 6,489,145 (“Method of DNA shuffling”) and U.S. Pat. No. 6,395,547 (“Methods of generating polynucleotides having desired characteristics by iterative selection and recombination”).

Standard recombinant DNA and cloning techniques can also be used for library construction and for incorporation of such libraries into appropriate expression and selection systems. Standard recombinant DNA and cloning techniques are well known to those of skill in the art and are described in laboratory text such as, for example, Sambrook et al., Molecular Cloning; A Laboratory Manual 2d ed. (1989), the contents of which are incorporated herein by reference.

ii. Target Site Constructs for Use in Primary Selection

Once the desired “sequence of interest” has been chosen, “target site constructs” for use in selection assays can be produced. The CSPO strategy employs construction and/or use of a separate “target site construct” for each subsite within the entire sequence of interest. For example, if an 18 bp sequence of interest (composed of six 3 bp subsites) is chosen, 6 “target site constructs” are produced. In the first “target site construct” subsite 1 (the 5′ subsite) would have the sequence of the corresponding subsite of the sequence of interest, and subsites 2-6 would have defined “anchor” sequences. These anchor sequences are the sequence bound by the “anchor fingers” described above. In the second target site construct subsite 2 would have the sequence of the gene of interest, and subsites 1 and 3-6 would have the defined “anchor” sequences. In summary only one subsite within a given “target site construct” should have the sequence of the gene of interest and the remaining subsites should have the defined “anchor” sequences. These target sites are referred to as “position sensitive” because the subsites having the sequence of the gene of interest are located at the same position relative to the other subsites, as occurs in the true target site within the gene of interest.

In a preferred embodiment, these “target site constructs” are cloned upstream of a test promoter in a vector for use in the bacterial 2-hybrid system (Joung et al., 2000, Proceedings of the National Academy of Sciences (USA) 97:7382 and US Patent Application No. 2002011949. Such target site constructs can be synthesized readily using standard molecular biology techniques (for example using restriction digestion of vector DNA, PCR, or automated nucleic acid synthesis). Such techniques are well known to those skilled in the art and are described in many laboratory texts such as, for example Sambrook et al., Molecular Cloning, A Laboratory Manual 2d ed. (1989).

iii. Primary Selection

A key feature of the CSPO Zf selection strategy is that a separate primary selection is performed for each “Zf/subsite pair” i.e. if the aim is to select a 6 finger scaffold-based protein that binds to an 18 bp target sequence, 6 parallel primary selections are performed, one for each randomized finger. For example, in the scheme described above, in primary selection 1, primary library 1 is expressed and candidates are selected for binding to DNA target site 1, i.e. primary library 1 and DNA target site 1 comprise a Zf/subsite pair. Similarly, in primary selection 2, primary library 2 is expressed and candidates are selected for binding to DNA target site 2.

In a preferred embodiment, the stringency of each of the primary selections should be low, such that each selection yields a pool of selected Zf proteins with target binding affinities that range from low to high. The rationale for this low stringency selection is that there should be no bias towards Zfs that bind tightly to their target subsite at the primary selection stage, because Zfs so identified may not bind tightly to their target subsite in the context of the Zfs selected against the other subsites that make up the full target sequence. Zfs that bind tightly in the context of the “anchor” fingers may not bind tightly in the context of the full target specific Zf protein. Mechanisms for controlling the stringency of DNA binding reactions are known to those of skill in the art and any such mechanism can be used.

iv. Construction of Secondary Partially Optimized Library

The primary selection methods described above will yield a separate “pool” of candidate scaffold-based Zf proteins for each “Zf/subsite” pair. A key aspect of the CSPO strategy is that these “pools” can be recombined to produce a secondary library comprising variants that harbor fingers which have been partially optimized for binding to a desired subsite. For example, such a secondary library can comprise a range of multi-finger proteins composed of random combinations of the pools of fingers selected from the randomized fingers of the primary library. Thus, the secondary library can comprise multi-finger proteins that, unlike the primary library, can potentially vary at all finger positions of the multi-finger proteins. Furthermore, the secondary library can comprise fingers with a range of binding affinities and specificities for their target subsite(s). The secondary library can then be used in a secondary selection, which is preferably conducted under conditions of high-stringency, to produce a multi-Zf polypeptide that binds with high affinity to the sequence of interest. Preferably, a new secondary library is synthesized for each new multi-finger protein to be produced.

The individual “pools” derived from the individual primary selections can be recombined using any one of a number of recombination techniques known in the art, such as described in, for example, Sambrook et al., Molecular Cloning; A Laboratory Manual 2d ed. (1989). Preferably, the individual “pools” derived from the individual primary selections are recombined using a PCR-mediated recombination method. More preferably still, the individual “pools” derived from the individual primary selections are recombined using a PCR-mediated recombination method, as described in U.S. application Ser. No. 60/420,458, and U.S. application Ser. No. 60/466,889, the contents of which are hereby expressly incorporated herein by reference.

v. Secondary Selection

For each new sequence specific scaffold-based Zf protein to be produced, one high-stringency secondary selection is performed. In this selection, a partially optimized secondary library (such as described above) is selected against the exact target sequence of interest, wherein the sequence of interest excludes “anchor” subsites. Thus, in the secondary selection, full-length assembled scaffold-based Zfs that bind to the sequence of interest can be identified. This is a key feature of the CSPO strategy, and means that there is no need to perform any post-selection assembly of individual Zfs or groups of Zfs to generate the final multi-finger product. Such post-selection assembly is a common feature of other Zf selection methods. Post-selection assembly often introduces an uncontrollable element into the production of multi-finger proteins, as there is a possibility that the individually selected fingers will not function as predicted when assembled into the final multi-finger protein. CSPO advantageously allows for secondary selection of fully assembled scaffold-based Zfs and thus results in the generation of a final product where each scaffold-based finger and the linkers between them are known to work together to bind to the target sequence of interest. In a preferred embodiment, the secondary selection is performed at high-stringency in order to isolate proteins that bind to their sequence of interest with high affinity and specificity. Mechanisms for controlling the stringency of selection reactions are known to those of skill in the art and any such mechanism can be used.

VII. Characterization of Selected Scaffold-Based Proteins.

The Zf proteins identified using methods of the present invention can be further characterized after selection to ensure that they bind to the target site of interest with the desired characteristics, and to confirm that the selected proteins do not bind non-specifically to other sequences. It is preferred that any selected scaffold-based proteins that do not bind to the target sequence with high specificity should be eliminated from susbsequent development. It is preferred that the selected proteins be tested for target site binding using a different strategy than that used in the original selection, thereby controlling for the possibility of spurious or artifactual interactions specific to the selection system. For example, Zfs selected using a bacterial 2-hybrid or phage-display system can be assayed for binding to their target sequence using an electrophoretic mobility shift assay or “EMSA” (Buratowski & Chodosh, in Current Protocols in Molecular Biology pp. 12.2.1-12.2.7). Equally, any other DNA binding assay known in the art could be used to verify the DNA binding properties of the selected proteins.

Preferably, calculations of binding affinity and specificity are also made. This can be done by a variety of methods. The affinity with which the selected Zf protein binds to the sequence of interest can be measured and quantified in terms of its K_{D}. Any assay system can be used, as long is it gives an accurate measurement of the actual K_{D} of the Zf protein. In one embodiment, the K_{D} for the binding of a Zf protein to its target is measured using an EMSA

In a preferred embodiment, EMSA is used to determine the K_{D} for binding of the selected Zf protein both to the sequence of interest (i.e., the specific K_{D}) and to non-specific DNA (i.e., the non-specific K_{D}). Any suitable non-specific or “competitor” double stranded DNA known in the art can be used. Preferably, calf thymus DNA or human placental is used. The ratio of the specific K_{D} to the non-specific K_{D} can be calculated to give the specificity ratio. Zfs that bind with high specificity have a high specificity ratio. This measurement is very useful in deciding which of a group of selected Zfs should be used for a given purpose. For example, use of Zfs in vivo requires not only high affinity binding but also highly-specificity binding. In a preferred embodiment, Zfs isolated using methods of the present invention have binding specificities higher than Zfs selected using other selection strategies (such a parallel selection, sequential selection and bipartite selection), and even more preferably, comparable or superior to those of naturally occurring multi-finger proteins, such as Zif268. It is preferred that the scaffold-based proteins of the present invention bind to their target sequences with affinities in the picomolar to nanomolar range. Furthermore, it is preferred that the scaffold-based proteins of the present invention bind to their target with a specificity ratio of >250,000 (i.e. the ratio one would expect for a perfectly specific three-finger protein that specifies 9 base pairs of DNA. Further methods useful for the characterization of selected scaffold-based Zf proteins in vitro and in living cells are provided in Examples 8 and 9, respectively.

VIII. Construction of Scaffold-Based Chimeric Proteins Such as Transcription Factors.

The ultimate aim of producing a custom-designed scaffold-based Zf protein, is to use that Zf protein to perform a function. The scaffold-based DNA binding domain can be used alone, for example to bind to a specific site on a gene and thus block binding of other DNA-binding domains. However, in a preferred embodiment, the scaffold based Zf protein will be used in the construction of a “chimeric Zf protein” containing a Zf DNA binding domain and an additional functional domain having some desired function (e.g. gene activation) or enzymatic activity i.e., a “functional domain”.

Chimeric scaffold-based proteins (i.e. recombinant proteins having a scaffold-based Zf DNA binding domain and an additional functional domain) can be used to perform any function where it is desired to target, for example, some specific enzymatic activity to a specific DNA sequence, as well as any of the functions already described for other types of synthetic or engineered zinc finger molecules. Scafold-based Zf DNA binding domains can be used in the construction of chimeric proteins useful for the treatment of disease (see, for example, U.S. patent application 2002/0160940 A1, and U.S. Pat. Nos. 6,511,808, 6,013,453 and 6,007,988, and International patent application WO 02057308 A2), or for otherwise altering the structure or function of a given gene in vivo. The chimeric Zf proteins of the present invention are also useful as research tools, for example, in performing either in vivo or in vitro functional genomics studies (see, for example, U.S. Pat. No. 6,503,717 and U.S. patent application 2002/0164575 A1).

To generate a functional recombinant protein, the Zf DNA binding domain will typically be fused to at least one “functional” domain. Fusing functional domains to synthetic Zf proteins to form functional transcription factors involves only routine molecular biology techniques which are commonly practiced by those of skill in the art, see for example, U.S. Pat. Nos. 6,511,808, 6,013,453, 6,007,988, 6,503,717 and U.S. patent application 2002/0160940 A1).

Functional domains can be associated with the Scaffold-based Zf DNA binding domain at any suitable position, including the C- or N-terminus of the Zf protein. Suitable “functional” domains for addition to the selected Zf domains are described in U.S. Pat. Nos. 6,511,808, 6,013,453, 6,007,988, U.S. and U.S. Pat. No. 6,503,717 and U.S. patent application 2002/0160940 A1.

In one embodiment, the functional domain is a nuclear localization domain which provides for the protein to be translocated to the nucleus. Several nuclear localization sequences (NLS) are known, and any suitable NLS can be used. For example, many NLSs have a plurality of basic amino acids, referred to as a bipartite basic repeats (reviewed in Garcia-Bustos et al, Biochimica et Biophysica Acta (1991) 1071, 83-101). An NLS containing bipartite basic repeats can be placed in any portion of chimeric protein and results in the chimeric protein being localized inside the nucleus. It is preferred that a nuclear localization domain is routinely incorporated into the final chimeric protein, as the ultimate functions of the chimeric proteins of the present invention will generally require the proteins to be localized in the nucleus. However, it may not be necessary to add a separate nuclear localization domain in cases where the selected Zf domain itself, or another functional domain within the final chimeric protein, has intrinsic nuclear translocation function.

In another embodiment, the functional domain is a transcriptional activation domain such that the chimeric protein can be used to activate transcription of the gene of interest. Any transcriptional activation domain known in the art can be used, such as for example, the VP16 domain form herpes simplex virus (Sadowski et al. (1988) Nature, Volume 335, p563-564) or the p65 domain from the cellular transcription factor NF-κB (Ruben et al. (1991) Science, Volume 251, p 1490-1493).

In yet another embodiment, the functional domain is a transcriptional repression domain such that the chimeric protein can be used to repress transcription of the gene of interest. Any transcriptional repression domain known in the art can be used, such as for example, the KRAB domain found in many naturally occurring KRAB proteins (Thiesen et al. (1991) Nucleic Acids Research, Volume 19 p 3996).

In a further embodiment, the functional domain is a DNA modification domain such as a methyltransferase (or methylase) domain, a de-methylation domain, an acteylation domain, or a deacteylation domain. Many such domains are known in the art and any such domain can be used, depending on the desired function of the resultant chimeric protein. For example, it has been shown that a DNA methylation domain can be fused to a Zf protein and used for targeted methylation of a specific DNA sequence (Xu et al., (1997) Nature Genetics, Volume 17, p 376-378). The state of methylation of a gene affects its expression and regulation, and furthermore, there are several diseases associated with defects in DNA methylation.

In a still further embodiment the functional domain is a chromatin modification domain. Chromatin is the material of eukaryotic chromosomes, and may comprise DNA, RNA, histone proteins, and non-histone proteins. Suitable chromatin modification domains of the present invention include histone acteylase or histone acteyltransferase domains (HATs), and histone de-acetylase domains (HDACs). Many such domains are known in the art and any such domain can be used, depending on the desired function of the resultant chimeric protein. Histone deacetylases (such as HDAC1 and HDAC2) are involved in gene repression. Therefore, by targeting HDAC activity to a specific gene of interest using a selected Zf protein, the expression of the gene of interest can be repressed.

In an alternative embodiment, the functional domain is a nuclease domain, such as a restriction endonuclease (or restriction enzyme) domain. The DNA cleavage activity of a nuclease enzyme can be targeted to a specific target sequence by fusing it to an appropriate selected Zf DNA binding domain. In this way, sequence specific chimeric restriction enzyme can be produced. Several nuclease domains are known in the art and any suitable nuclease domain can be used. For example, the endonuclease domain of the type II restriction endonuclease FokI can be used, as taught by Kim et al. ((1996) Proceedings of the National Academy of Sciences, Volume 6, p1156-60). Such chimeric endonucleases can be used in any situation where cleavage of a specific DNA sequence is desired, such as in laboratory procedures for the construction of recombinant DNA molecules, or in producing double-stranded DNA breaks in genomic DNA in order to promote homologous recombination (Kim et al. (1996) Proceedings of the National Academy of Sciences, Volume 6, p1156-60; and Bibikova et al. (2001) Molecular & Cellular Biology, Volume 21, p 289-297).

In a further alternative embodiment, the functional domain is an integrase domain, such that the chimeric protein can be used to insert exogenous DNA at a specific location in, for example, the human genome.

Other suitable functional domains include silencer domains (which mediate long-term and long-distance repression of DNA expression), nuclear hormone receptors, resolvase domains, oncogene transcription factors (e.g., myc, jun, fos, myb, max, mad, rel, ets, bcl, myb, mos family members etc.), kinases, phosphatases, and any other proteins that modify the structure of DNA and/or the expression of genes. Suitable kinase domains, from kinases involved in transcription regulation are reviewed in Davis, Mol. Reprod. Dev. 42:459-67 (1995). Suitable phosphatase domains are reviewed in, for example, Schonthal & Semin, Cancer Biol. 6:239-48 (1995).

In a preferred embodiment the functional domains found in the native NRSF protein are used to generate a final scaffold-based chimeric protein, such as an NRSF-based scaffold protein. The native NRSF protein comprises an N-terminal repressor domain and a C-terminal repressor domain (Tapia Ramirez et al., 1997 PNAS 94; p1172-1182; Andres et al., 1999 PNAS 96; p9873-9878; Grimes et al., 2000 Journal of Biological Chemistry 275: p9461-9467). Either or both of these repressor domains may be used. It has recently been shown that the C-terminal repressor domain of NRSF can mediate long term silencing through alteration of chromatin structure (Lunyak et al., 2002 Science 2989; p1747-1751) i.e., the C-terminal repressor domain of NRSF can also function as a silencer domain. Thus, it may be particularly desirable to use NRSF-based Zf proteins comprising the C-terminal repressor domain of NRSF in circumstances where long-term or permanent “switching-off” of the target gene is desired. Another advantage of using the C-terminal repressor domain of NRSF is that target cells may only need to be exposed to the chimeric protein briefly to result in long term silencing of gene expression. This will be particularly useful in human patients, as it means a single short term “treatment” with such a chimeric protein may be all that is required to induce long term effects on gene expression.

Fusions of selected Zfs to functional domains can be performed by standard recombinant DNA techniques well known to those skilled in the art, and as are described in, for example, basic laboratory texts such as Sambrook et al., Molecular Cloning; A Laboratory Manual 2d ed. (1989), and in U.S. Pat. Nos. 6,511,808, 6,013,453, 6,007,988, U.S. and U.S. Pat. No. 6,503,717 and U.S. patent application 2002/0160940 A1.

In one embodiment, the DNA binding domain used to form the synthetic transcription factor of the present invention is the exact scaffold-based protein that has been selected.

In other embodiments, two or more selected Zf proteins are linked together to produce the final DNA binding domain. The linkage of two or more selected scaffold-based proteins may be performed by covalent or non-covalent means.

In the case of covalent linkage, scaffold-based proteins may be covalently linked together using an amino acid linker (see, for example, U.S. patent application 2002/0160940 A1, and International applications WO 02099084A2 and WO 0153480 A1). This linker may be any string of amino acids desired. In one embodiment the linker is a canonical TGEKP linker. In a preferred embodiment, the linker has the same sequence as one of the linkers in the scaffold protein. In a further preferred embodiment the linker has the same sequence as one of the linkers in the NRSF scaffold protein Whatever linkers are used standard recombinant DNA techniques (such as described in, for example, Sambrook et al., Molecular Cloning; A Laboratory Manual 2d ed. (1989)) are used to produce such linked proteins.

In the case of non-covalent linkage, two or more CSPO-selected proteins may multimerized i.e, two or more folded CSPO-selected protein “subunits” may associate with each other by non-covalent interactions to form a “multi-subunit protein assembly” or “multimeric complex”. Where only two CSPO-selected proteins are non-covalently linked, the proteins are said to be dimerized. In one embodiment two identical CSPO-selected proteins may be linked to form a homo-dimer. In an alternative embodiment two different CSPO-selected proteins may be linked to form a hetero-dimer. For example, a six-finger protein may be produced by dimerization of two three-finger proteins, or an eight-finger protein may be produced by dimerization of two four-finger proteins. The production of multimers or dimers can be performed by fusing “multimerization” or “dimerization domains” to the zinc finger proteins to be joined. Any suitable method for fusing protein domains or producing chimeric proteins can be used. For example, in one embodiment, the DNA encoding the zinc finger protein is fused to the DNA encoding the multimerization domain using standard recombinant DNA technqiues (as described in, for Example, Sambrook et al., Molecular Cloning; A Laboratory Manual 2d ed. (1989).

Suitable multimerization or dimerization domains can be selected from any protein that is known to exists as a multimer or dimer, or any protein known to possess such multimerization or dimerization activity. Examples, of suitable domains include the dimerization element of Gal4, leucine zipper domains, STAT protein N-terminal domains, and FK506 binding proteins (see, e.g., Pomerantz et al., Biochemistry 37: 965-970 (1998), Wolfe et al., Structure 8: 739-750 (2000), O'Shea, Science 254: 539 (1991), Barahmand-Pour et al., Curr. Top. Microbiol. Immunol. 211:121-128 (1996); Klemm et al., Annu. Rev. Immunol. 16:569-592 (1998); Ho et al., Nature 382:822-826 (1996)). Furthermore, some zinc finger proteins themselves have dimerization activity. For example, the zinc fingers from the transcription factor Ikaros have dimerization activity (McCarty et al., Molecular Cell 11: 459-470 (2003), and there is evidence that even the zinc finger proteins of NRSF (and/or NRSF splice variants) may have some dimerization activity (Shimojo et al., Mol Cell Biol. 19: 6788-95 (1999)). In the event that the selected Zf proteins themselves have dimerization function there will be no need to fuse an additional dimerization domain to these proteins.

In certain embodiments, “conditional” multimerization of dimerization” technology can be used. For example, this can be accomplished using FK506 and FKBP interactions. FK506 binding domains are attached to the proteins to be dimerized. These proteins will remain apart in the absence of a dimerizer. Upon addition of a dimerizer, such as the synthetic ligand FK1012, the two proteins will fuse.

In embodiments where the CSPO-selected proteins are used in the generation of chimeric endonuclease it is preferred that the chimeric protein possesses a dimerization domain as endonucleases are believed to function as dimers. Any suitable dimerization domain may be used. In one embodiment the endonuclease domain itself possesses dimerization activity. For example, the nuclease domain of Fok I which has intrinsic dimerization activity can be used (Kim et al. (1996, PNAS Vol 93, p 1156-1160).

A particular advantage of NRSF-based Zf proteins of the present invention is that, because of the relatively low DNA-binding affinity of the NRSF zinc fingers (e.g. three fingers of NRSF bind with an affinity in the micromolar range whereas three fingers of Zif268 bind with an affinity in the picomolar to nanomolar range) the number of zinc fingers that can be linked together is not limited. For example, using the methods of the present invention two three-finger NRSF-based proteins may be dimerized to produce a six-finger protein, two four-finger proteins may be dimerized to produce an eight finger protein, or two five-finger proteins may be linked together to produce a ten finger protein. In the case of zif268 dimerization of zinc finger domains with more than two fingers each will likely result in the production of a protein whose DNA-binding affinity is likely to be too high for the protein to be physiologically useful (Wolfe et al., Structure 8: 739-750 (2000)). Thus, the NRSF-based proteins of the present invention are particularly well suited to applications requiring the use of dimerized or multimerized proteins.

IX. Use of Selected Scaffold-Based Proteins

The ultimate aim of producing scaffold-based transcription factors is to express and produce the scaffold-based proteins, or chimeric proteins possessing the scaffold-based Zf domain, and use them to regulate gene expression, or otherwise alter the structure or function of DNA either in vitro or in vivo. A further description of how this is achieved is provided below.

i. Expression Vectors

The nucleic acid encoding the scaffold-based Zf protein is typically cloned into intermediate vectors for transformation into prokaryotic or eukaryotic cells for replication and/or expression. Intermediate vectors are typically prokaryote vectors, e.g., plasmids, or shuttle vectors, or insect vectors, for storage or manipulation of the nucleic acid encoding the scaffold-based Zf protein or production of protein. The nucleic acid encoding the scaffold-based Zf protein is also typically cloned into an expression vector, for administration to a plant cell, animal cell, preferably a mammalian cell or a human cell, fungal cell, bacterial cell, or protozoal cell.

To obtain expression of a cloned gene or nucleic acid, the scaffold-based Zf protein is typically subcloned into an expression vector that contains a promoter to direct transcription. Suitable bacterial and eukaryotic promoters are well known in the art and described, e.g., in Sambrook et al., Molecular Cloning, A Laboratory Manual (2nd ed. 1989); Kriegler, Gene Transfer and Expression: A Laboratory Manual (1990); and Current Protocols in Molecular Biology (Ausubel et al., eds., 1994). Bacterial expression systems for expressing the scaffold-based Zf protein are available in, e.g., Eschericia coli, Bacillus species, and Salmonella species (Palva et al., Gene 22:229-235 (1983)). Kits for such expression systems are commercially available. Eukaryotic expression systems for mammalian cells, yeast, and insect cells are well known in the art and are also commercially available.

The promoter used to direct expression of the selected scaffold-based Zf protein nucleic acid depends on the particular application. For example, a strong constitutive promoter is typically used for expression and purification of the selected Zf protein. In contrast, when the selected Zf protein is to be administered in vivo for gene regulation, either a constitutive or an inducible promoter is used, depending on the particular use of the selected Zf protein. In addition, a preferred promoter for administration of the selected Zf protein can be a weak promoter, such as HSV TK or a promoter having similar activity. The promoter typically can also include elements that are responsive to transactivation, e.g., hypoxia response elements, Gal4 response elements, lac repressor response element, and small molecule control systems such as tet-regulated systems and the RU-486 system (see, e.g., Gossen & Bujard, PNAS 89:5547 (1992); Oligino et al., Gene Ther. 5:491-496 (1998); Wang et al., Gene Ther. 4:432-441 (1997); Neering et al., Blood 88:1147-1155 (1996); and Rendahl et al., Nat. Biotechnol. 16:757-761 (1998)).

In addition to the promoter, the expression vector typically contains a transcription unit or expression cassette that contains all the additional elements required for the expression of the nucleic acid in host cells, either prokaryotic or eukaryotic. A typical expression cassette thus contains a promoter operably linked, e.g., to the nucleic acid sequence encoding the selected Zf protein, and signals required, e.g., for efficient polyadenylation of the transcript, transcriptional termination, ribosome binding sites, or translation termination. Additional elements of the cassette may include, e.g., enhancers, and heterologous spliced intronic signals.

The particular expression vector used to transport the genetic information into the cell is selected with regard to the intended use of the selected Zf protein, e.g., expression in plants, animals, bacteria, fungus, protozoa etc. (see expression vectors described below and in the Example section). Standard bacterial expression vectors include plasmids such as pBR322 based plasmids, pSKF, pET23D, and commercially available fusion expression systems such as GST and LacZ. A preferred fusion protein is the maltose binding protein, “MBP.” Such fusion proteins are used for purification of the selected Zf proteins. Epitope tags can also be added to the selected Zf proteins to provide convenient methods of isolation, for monitoring expression, and for monitoring cellular and subcellular localization, e.g., c-myc or FLAG.

Expression vectors containing regulatory elements from eukaryotic viruses are often used in eukaryotic expression vectors, e.g., SV40 vectors, papilloma virus vectors, and vectors derived from Epstein-Barr virus. Other exemplary eukaryotic vectors include pMSG, pAV009/A+, pMTO10/A+, pMAMneo-5, baculovirus pDSVE, and any other vector allowing expression of proteins under the direction of the SV40 early promoter, SV40 late promoter, metallothionein promoter, murine mammary tumor virus promoter, Rous sarcoma virus promoter, polyhedrin promoter, or other promoters shown effective for expression in eukaryotic cells.

Some expression systems have markers for selection of stably transfected cell lines such as thymidine kinase, hygromycin B phosphotransferase, and dihydrofolate reductase. High yield expression systems are also suitable, such as using a baculovirus vector in insect cells, with the selected Zf protein encoding sequence under the direction of the polyhedrin promoter or other strong baculovirus promoters.

The elements that are typically included in expression vectors also include a replicon that functions in E. coli, a gene encoding antibiotic resistance to permit selection of bacteria that harbor recombinant plasmids, and unique restriction sites in nonessential regions of the plasmid to allow insertion of recombinant sequences.

Standard transfection methods are used to produce bacterial, mammalian, yeast or insect cell lines that express large quantities of protein, which are then purified using standard techniques (see, e.g., Colley et al., J. Biol. Chem. 264:17619-17622 (1989); Guide to Protein Purification, in Methods in Enzymology, vol. 182 (Deutscher, ed., 1990)). Transformation of eukaryotic and prokaryotic cells are performed according to standard techniques (see, e.g., Morrison, J. Bact. 132:349-351 (1977); Clark-Curtiss & Curtiss, Methods in Enzymology 101:347-362 (Wu et al., eds, 1983).

Any of the well known procedures for introducing foreign nucleotide sequences into host cells may be used in conjunction with the selected scaffold-based Zf proteins of the present invention. These include the use of calcium phosphate transfection, polybrene, protoplast fusion, electroporation, liposomes, microinjection, naked DNA, plasmid vectors, viral vectors, both episomal and integrative, and any of the other well known methods for introducing cloned genomic DNA, cDNA, synthetic DNA or other foreign genetic material into a host cell (see, e.g., Sambrook et al., supra). Additionally, any of the well known procedures for expressing and purifying proteins, can be used to obtain purified scaffold-based Zf proteins, for subsequent uses such as administration to cells or to animals. For example, purified scaffold-based Zf proteins' can be administered to animals by intravenous, subcutaneous or intramuscular delivery.

ii. Assays For Determining Regulation of Gene Expression

A variety of assays can be used to determine the level of gene expression regulation by the scaffold-based Zf proteins, see for example U.S. Pat. No. 6,453,242. The activity of a particular selected Zf protein can be assessed using a variety of in vitro and in vivo assays, by measuring, e.g., protein or mRNA levels, product levels, enzyme activity, tumor growth; transcriptional activation or repression of a reporter gene; second messenger levels (e.g., cGMP, cAMP, IP3, DAG, Ca.sup.2+); cytokine and hormone production levels; and neovascularization, using, e.g., immunoassays (e.g., ELISA and immunohistochemical assays with antibodies), hybridization assays (e.g., RNase protection, northerns, in situ hybridization, oligonucleotide array studies), colorimetric assays, amplification assays, enzyme activity assays, tumor growth assays, phenotypic assays, and the like.

Scaffold-based Zf proteins are typically first tested for activity in vitro using cultured cells, e.g., 293 cells, CHO cells, VERO cells, BHK cells, HeLa cells, COS cells, and the like. Preferably, human cells are used. The NRSF-based Zf protein is often first tested using a transient expression system with a reporter gene, and then regulation of the target endogenous gene is tested in cells and in animals, both in vivo and ex vivo. The selected Zf proteins can be recombinantly expressed in cells, transplanted into an animal, or recombinantly expressed in a transgenic animal, as well as administered as a protein to an animal or cell using delivery vehicles described below. The cells can be immobilized, be in solution, be injected into an animal, or be naturally occurring in a transgenic or non-transgenic animal.

Modulation of gene expression is tested using one of the in vitro or in vivo assays described herein. Samples or assays are treated with the scaffold-based Zf protein and compared to un-treated control samples, to examine the extent of modulation. For regulation of endogenous gene expression, the selected Zf protein ideally has a K_{D} of 200 nM or less, more preferably 100 nM or less, more preferably 50 nM, most preferably 25′ nM or less. The effects of the NRSF-based Zf protein can be measured by examining any of the parameters described above. Any suitable gene expression, phenotypic, or physiological change can be used to assess the influence of the selected scaffold-based Zf protein. When the functional consequences are determined using intact cells or animals, one can also measure a variety of effects such as tumor growth, neovascularization, hormone release, transcriptional changes to both known and uncharacterized genetic markers (e.g., northern blots or oligonucleotide array studies), changes in cell metabolism such as cell growth or pH changes, and changes in intracellular second messengers such as cGMP.

Preferred assays for regulation of endogenous gene expression can be performed in vitro. In one in vitro assay format, the scaffold-based Zf protein regulation of endogenous gene expression in cultured cells is measured by examining protein production using an ELISA assay The test sample is compared to control cells treated with an empty vector or an unrelated Zf protein that is targeted to another gene.

In another embodiment, regulation of endogenous gene expression is determined in vitro by measuring the level of target gene mRNA expression. The level of gene expression is measured using amplification, e.g., using RT-PCR, LCR, or hybridization assays, e.g., northern hybridization, RNase protection, dot blotting. RNase protection is used in one embodiment. The level of protein or mRNA is detected using directly or indirectly labeled detection agents, e.g., fluorescently or radioactively labeled nucleic acids, radioactively or enzymatically labeled antibodies, and the like, as described herein.

Alternatively, a reporter gene system can be devised using the target gene promoter operably linked to a reporter gene such as luciferase, green fluorescent protein, CAT, or .beta.-gal. The reporter construct is typically co-transfected into a cultured cell. After treatment with the selected scaffold-based Zf protein, the amount of reporter gene transcription, translation, or activity is measured according to standard techniques known to those of skill in the art.

Another example of an assay format useful for monitoring regulation of endogenous gene expression is performed in vivo. This assay is particularly useful for examining Zf proteins that inhibit expression of tumor promoting genes, genes involved in tumor support, such as neovascularization (e.g., VEGF), or that activate tumor suppressor genes such as p53. In this assay, cultured tumor cells expressing the selected scaffold-based Zf protein are injected subcutaneously into an immune compromised mouse such as an athymic mouse, an irradiated mouse, or a SCID mouse. After a suitable length of time, preferably 4-8 weeks, tumor growth is measured, e.g., by volume or by its two largest dimensions, and compared to the control. Tumors that have statistically significant reduction (using, e.g., Student's T test) are said to have inhibited growth. Alternatively, the extent of tumor neovascularization can also be measured. Immunoassays using endothelial cell specific antibodies are used to stain for vascularization of the tumor and the number of vessels in the tumor. Tumors that have a statistically significant reduction in the number of vessels (using, e.g., Student's T test) are said to have inhibited neovascularization.

Transgenic and non-transgenic animals can also be used for examining regulation of endogenous gene expression in vivo. Transgenic animals typically express the scaffolf-based Zf protein. Alternatively, animals that transiently express the scaffold-based Zf protein, or to which the scaffold-based Zf protein has been administered in a delivery vehicle, can be used. Regulation of endogenous gene expression is tested using any one of the assays described herein.

iii. Nucleic Acids Encoding Fusion Proteins and Gene Therapy

The selected scaffold-based proteins of the present invention can be used to regulate gene expression in gene therapy applications in the same way as has already been described for other types of synthetic zinc finger proteins, see for example U.S. Pat. No. 6,511,808, U.S. Pat. No. 6,013,453, U.S. Pat. No. 6,007,988, U.S. Pat. No. 6,503,717, U.S. patent application 2002/0164575 A1, and U.S. patent application 2002/0160940 A1.

Conventional viral and non-viral based gene transfer methods can be used to introduce nucleic acids encoding the selected scaffold-based Zf protein into mammalian cells or target tissues. Such methods can be used to administer nucleic acids encoding the selected scaffold-based Zf proteins to cells in vitro. Preferably, the nucleic acids encoding the selected scaffold-based Zf protein s are administered for in vivo or ex vivo gene therapy uses. Non-viral vector delivery systems include DNA plasmids, naked nucleic acid, and nucleic acid complexed with a delivery vehicle such as a liposome. Viral vector delivery systems include DNA and RNA viruses, which have either episomal or integrated genomes after delivery to the cell. For a review of gene therapy procedures, see Anderson, Science 256:808-813 (1992); Nabel & Felgner, TIBTECH 11:211-217 (1993); Mitani & Caskey, TIBTECH 11:162-166 (1993); Dillon, TIBTECH 11: 167-175 (1993); Miller, Nature 357:455-460 (1992); Van Brunt, Biotechnology 6(10):1149-1154 (1988); Vigne, Restorative Neurology and Neuroscience 8:35-36 (1995); Kremer & Perricaudet, British Medical Bulletin 51 (1):31-44 (1995); Haddada et al., in Current Topics in Microbiology and Immunology Doerfler and Bohm (eds) (1995); and Yu et al., Gene Therapy 1: 13-26 (1994).

Methods of non-viral delivery of nucleic acids encoding the selected Zf proteins include lipofection, microinjection, biolistics, virosomes, liposomes, immunoliposomes, polycation or lipid:nucleic acid conjugates, naked DNA, artificial virions, and agent-enhanced uptake of DNA. Lipofection is described in e.g., U.S. Pat. No. 5,049,386, No. 4,946,787; and No. 4,897,355) and lipofection reagents are sold commercially (e.g., Transfectam.™and Lipofectin.™.). Cationic and neutral lipids that are suitable for efficient receptor-recognition lipofection of polynucleotides include those of Felgner, WO 91/17424, WO 91/16024. Delivery can be to cells (ex vivo administration) or target tissues (in vivo administration).

The preparation of lipid:nucleic acid complexes, including targeted liposomes such as immunolipid complexes, is well known to one of skill in the art (see, e.g., Crystal, Science 270:404-410 (1995); Blaese et al., Cancer Gene Ther. 2:291-297 (1995); Behr et al., Bioconjugate Chem. 5:382-389 (1994); Remy et al., Bioconjugate Chem. 5:647-654 (1994); Gao et al., Gene Therapy 2:710-722 (1995); Ahmad et al., Cancer Res. 52:4817-4820 (1992); U.S. Pat. Nos. 4,186,183, 4,217,344, 4,235,871, 4,261,975, 4,485,054, 4,501,728, 4,774,085, 4,837,028, and 4,946,787).

The use of RNA or DNA viral based systems for the delivery of nucleic acids encoding the selected-based Zf proteins takes advantage of highly evolved processes for targeting a virus to specific cells in the body and trafficking the viral payload to the nucleus. Viral vectors can be administered directly to patients (in vivo) or they can be used to treat cells in vitro and the modified cells are administered to patients (ex vivo). Conventional viral based systems for the delivery of Zf proteins could include retroviral, lentivirus, adenoviral, adeno-associated and herpes simplex virus vectors for gene transfer. Viral vectors are currently the most efficient and versatile method of gene transfer in target cells and tissues. Integration in the host genome is possible with the retrovirus, lentivirus, and adeno-associated virus gene transfer methods, often resulting in long term expression of the inserted transgene. Additionally, high transduction efficiencies have been observed in many different cell types and target tissues.

The tropism of a retrovirus can be altered by incorporating foreign envelope proteins, expanding the potential target population of target cells. Lentiviral vectors are retroviral vectors that are able to transduce or infect non-dividing cells and typically produce high viral titers. Selection of a retroviral gene transfer system would therefore depend on the target tissue. Retroviral vectors are comprised of cis-acting long terminal repeats with packaging capacity for up to 6-10 kb of foreign sequence. The minimum cis-acting LTRs are sufficient for replication and packaging of the vectors, which are then used to integrate the therapeutic gene into the target cell to provide permanent transgene expression. Widely used retroviral vectors include those based upon murine leukemia virus (MuLV), gibbon ape leukemia virus (GaLV), Simian Immuno deficiency virus (SIV), human immuno deficiency virus (HIV), and combinations thereof (see, e.g., Buchscher et al., J. Virol. 66:2731-2739 (1992); Johann et al., J. Virol. 66:1635-1640 (1992); Sommerfelt et al., Virol. 176:58-59 (1990); Wilson et al., J. Virol. 63:2374-2378 (1989); Miller et al., J. Virol. 65:2220-2224 (1991); PCT/US94/05700).

In applications where transient expression of the selected scaffold-based Zf protein is preferred, adenoviral based systems are typically used. Adenoviral based vectors are capable of very high transduction efficiency in many cell types and do not require cell division. With such vectors, high titer and levels of expression have been obtained. This vector can be produced in large quantities in a relatively simple system. Adeno-associated virus (“AAV”) vectors are also used to transduce cells with target nucleic acids, e.g., in the in vitro production of nucleic acids and peptides, and for in vivo and ex vivo gene therapy procedures (see, e.g., West et al., Virology 160:3847 (1987); U.S. Pat. No. 4,797,368; WO 93/24641; Kotin, Human Gene Therapy 5:793-801 (1994); Muzyczka, J. Clin. Invest. 94:1351 (1994). Construction of recombinant AAV vectors are described in a number of publications, including U.S. Pat. No. 5,173,414; Tratschin et al., Mol. Cell. Biol. 5:3251-3260 (1985); Tratschin, et al., Mol. Cell. Biol. 4:2072-2081 (1984); Hermonat & Muzyczka, PNAS 81:6466-6470 (1984); and Samulski et al., J. Virol. 63:03822-3828 (1989).

In particular, at least six viral vector approaches are currently available for gene transfer in clinical trials, with retroviral vectors by far the most frequently used system. All of these viral vectors utilize approaches that involve complementation of defective vectors by genes inserted into helper cell lines to generate the transducing agent.

pLASN and MFG-S are examples are retroviral vectors that have been used in clinical trials (Dunbar et al., Blood 85:3048-305 (1995); Kohn et al., Nat. Med. 1:1017-102 (1995); Malech et al., PNAS 94:22 12133-12138 (1997)). PA317/pLASN was the first therapeutic vector used in a gene therapy trial. (Blaese et al., Science 270:475-480 (1995)). Transduction efficiencies of 50% or greater have been observed for MFG-S packaged vectors. (Ellem et al., Immunol Immunother. 44(1): 10-20 (1997); Dranoffetal., Hum. Gene Ther. 1:111-2 (1997).

Recombinant adeno-associated virus vectors (rAAV) are a promising alternative gene delivery systems based on the defective and nonpathogenic parvovirus adeno-associated type 2 virus. All vectors are derived from a plasmid that retains only the AAV 145 bp inverted terminal repeats flanking the transgene expression cassette. Efficient gene transfer and stable transgene delivery due to integration into the genomes of the transduced cell are key features for this vector system. (Wagner et al., Lancet 351:9117 1702-3 (1998), Kearns et al., Gene Ther. 9:748-55 (1996)).

Replication-deficient recombinant adenoviral vectors (Ad) are predominantly used for colon cancer gene therapy, because they can be produced at high titer and they readily infect a number of different cell types. Most adenovirus vectors are engineered such that a transgene replaces the Ad E1a, E1b, and E3 genes; subsequently the replication defector vector is propagated in human 293 cells that supply deleted gene function in trans. Ad vectors can transduce multiply types of tissues in vivo, including nondividing, differentiated cells such as those found in the liver, kidney and muscle system tissues. Conventional Ad vectors have a large carrying capacity. An example of the use of an Ad vector in a clinical trial involved polynucleotide therapy for antitumor immunization with intramuscular injection (Sterman et al., Hum. Gene Ther. 7:1083-9 (1998)). Additional examples of the use of adenovirus vectors for gene transfer in clinical trials include Rosenecker et al., Infection 24:15-10 (1996); Sterman et al., Hum. Gene Ther. 9:7 1083-1089 (1998); Welsh et al., Hum. Gene Ther. 2:205-18 (1995); Alvarez et al., Hum. Gene Ther. 5:597-613 (1997); Topf et al., Gene Ther. 5:507-513 (1998); Sterman et al., Hum. Gene Ther. 7:1083-1089 (1998).

Packaging cells are used to form virus particles that are capable of infecting a host cell. Such cells include 293 cells, which package adenovirus, and Ψ2 cells or PA317 cells, which package retrovirus. Viral vectors used in gene therapy are usually generated by producer cell line that packages a nucleic acid vector into a viral particle. The vectors typically contain the minimal viral sequences required for packaging and subsequent integration into a host, other viral sequences being replaced by an expression cassette for the protein to be expressed. The missing viral functions are supplied in trans by the packaging cell line. For example, AAV vectors used in gene therapy typically only possess ITR sequences from the AAV genome which are required for packaging and integration into the host genome. Viral DNA is packaged in a cell line, which contains a helper plasmid encoding the other AAV genes, namely rep and cap, but lacking ITR sequences. The cell line is also infected with adenovirus as a helper. The helper virus promotes replication of the AAV vector and expression of AAV genes from the helper plasmid. The helper plasmid is not packaged in significant amounts due to a lack of ITR sequences. Contamination with adenovirus can be reduced by, e.g., heat treatment to which adenovirus is more sensitive than AAV.

In many gene therapy applications, it is desirable that the gene therapy vector be delivered with a high degree of specificity to a particular tissue type. A viral vector is typically modified to have specificity for a given cell type by expressing a ligand as a fusion protein with a viral coat protein on the viruses outer surface. The ligand is chosen to have affinity for a receptor known to be present on the cell type of interest. For example, Han et al., PNAS 92:9747-9751 (1995), reported that Moloney murine leukemia virus can be modified to express human heregulin fused to gp70, and the recombinant virus infects certain human breast cancer cells expressing human epidermal growth factor receptor. This principle can be extended to other pairs of virus expressing a ligand fusion protein and target cell expressing a receptor. For example, filamentous phage can be engineered to display antibody fragments (e.g., FAB or Fv) having specific binding affinity for virtually any chosen cellular receptor. Although the above description applies primarily to viral vectors, the same principles can be applied to nonviral vectors. Such vectors can be engineered to contain specific uptake sequences thought to favor uptake by specific target cells.

Gene therapy vectors can be delivered in vivo by administration to an individual patient, typically by systemic administration (e.g., intravenous, intraperitoneal, intramuscular, subdermal, or intracranial infusion) or topical application, as described below. Alternatively, vectors can be delivered to cells ex vivo, such as cells explanted from an individual patient (e.g., lymphocytes, bone marrow aspirates, tissue biopsy) or universal donor hematopoietic stem cells, followed by reimplantation of the cells into a patient, usually after selection for cells which have incorporated the vector.

Ex vivo cell transfection for diagnostics, research, or for gene therapy (e.g., via re-infusion of the transfected cells into the host organism) is well known to those of skill in the art. In a preferred embodiment, cells are isolated from the subject organism, transfected with nucleic acid (gene or cDNA), encoding the selected scaffold-based-based Zf protein, and re-infused back into the subject organism (e.g., patient). Various cell types suitable for ex vivo transfection are well known to those of skill in the art (see, e.g., Freshney et al., Culture of Animal Cells, A Manual of Basic Technique (3rd ed. 1994)) and the references cited therein for a discussion of how to isolate and culture cells from patients).

In one embodiment, stem cells are used in ex vivo procedures for cell transfection and gene therapy. The advantage to using stem cells is that they can be differentiated into other cell types in vitro, or can be introduced into a mammal (such as the donor of the cells) where they will engraft in the bone marrow. Methods for differentiating CD34+cells in vitro into clinically important immune cell types using cytokines such a GM-CSF, IFN-gamma. and TNF-alpha. are known (see Inaba et al., J. Exp. Med. 176:1693-1702 (1992)).

Stem cells are isolated for transduction and differentiation using known methods. For example, stem cells are isolated from bone marrow cells by panning the bone marrow cells with antibodies which bind unwanted cells, such as CD4+ and CD8+ (T cells), CD45+ (panB cells), GR-1 (granulocytes), and lad (differentiated antigen presenting cells) (see Inaba et al., J. Exp. Med. 176:1693-1702 (1992)).

Vectors (e.g., retroviruses, adenoviruses, liposomes, etc.) containing therapeutic the selected scaffold-based Zf protein nucleic acids can be also administered directly to the organism for transduction of cells in vivo. Alternatively, naked DNA can be administered. Administration is by any of the routes normally used for introducing a molecule into ultimate contact with blood or tissue cells. Suitable methods of administering such nucleic acids are available and well known to those of skill in the art, and, although more than one route can be used to administer a particular composition, a particular route can often provide a more immediate and more effective reaction than another route. Alternatively, stable formulations of the selected proteins can also be administered.

Pharmaceutically acceptable carriers are determined in part by the particular composition being administered, as well as by the particular method used to administer the composition. Accordingly, there is a wide variety of suitable formulations of pharmaceutical compositions available, as described below (see, e.g., Remington's Pharmaceutical Sciences, 17th ed., 1989).

iv. Delivery Vehicles

An important factor in the administration of polypeptide compounds, such as the selected scaffold-based Zf proteins of the present invention, is ensuring that the polypeptide has the ability to traverse the plasma membrane of a cell, or the membrane of an intra-cellular compartment such as the nucleus. Cellular membranes are composed of lipid-protein bilayers that are freely permeable to small, nonionic lipophilic compounds and are inherently impermeable to polar compounds, macromolecules, and therapeutic or diagnostic agents. However, proteins and other compounds such as liposomes have been described, which have the ability to translocate polypeptides such as scaffold-based Zf protein across a cell membrane.

For example, “membrane translocation polypeptides” have amphiphilic or hydrophobic amino acid subsequences that have the ability to act as membrane-translocating carriers. In one embodiment, homeodomain proteins have the ability to translocate across cell membranes. The shortest internalizable peptide of a homeodomain protein, Antennapedia, was found to be the third helix of the protein, from amino acid position 43 to 58 (see, e.g., Prochiantz, Current Opinion in Neurobiology 6:629-634 (1996)). Another subsequence, the h (hydrophobic) domain of signal peptides, was found to have similar cell membrane translocation characteristics (see, e.g., Lin et al., J. Biol. Chem. 270:1 4255-14258 (1995)).

Examples of peptide sequences which can be linked to a protein, for facilitating uptake of the protein into cells, include, but are not limited to: an 11 amino acid peptide of the tat protein of HIV; a 20 residue peptide sequence which corresponds to amino acids 84-103 of the p16 protein (see Fahraeus et al., Current Biology 6:84 (1996)); the third helix of the 60-amino acid long homeodomain of Antennapedia (Derossi et al., J. Biol. Chem. 269:10444 (1994)); the h region of a signal peptide, such as the Kaposi fibroblast growth factor (K-FGF) h region (Lin et al., supra); or the VP22 translocation domain from HSV (Elliot & O'Hare, Cell 88:223-233 (1997)). Other suitable chemical moieties that provide enhanced cellular uptake may also be chemically linked to the selected scaffold-based Zf proteins of the present invention.

Toxin molecules also have the ability to transport polypeptides across cell membranes. Often, such molecules are composed of at least two parts (called “binary toxins”): a translocation or binding domain or polypeptide and a separate toxin domain or polypeptide. Typically, the translocation domain or polypeptide binds to a cellular receptor, and then the toxin is transported into the cell. Several bacterial toxins, including Clostridium perfringens iota toxin, diphtheria toxin (DT), Pseudomonas exotoxin A (PE), pertussis toxin (PT), Bacillus anthracis toxin, and pertussis adenylate cyclase (CYA), have been used in attempts to deliver peptides to the cell cytosol as internal or amino-terminal fusions (Arora et al., J. Biol. Chem., 268:3334-3341 (1993); Perelle et al., Infect. Immun., 61:5147-5156 (1993); Stenmark et al., J. Cell Biol. 113:1025-1032 (1991); Donnelly et al., PNAS 90:3530-3534 (1993); Carbonetti et al., Abstr. Annu. Meet. Am. Soc. Microbiol. 95:295 (1995); Sebo et al., Infect. Immun. 63:3851-3857 (1995); Klimpel et al., PNAS U.S.A. 89:10277-10281 (1992); and Novak et al., J. Biol. Chem. 267:17186-17193 1992)).

Such subsequences can be used to translocate selected scaffold-based Zf proteins across a cell membrane. The selected scaffold-based Zf proteins can be conveniently fused to or derivatized with such sequences. Typically; the translocation sequence is provided as part of a fusion protein. Optionally, a linker can be used to link the selected scaffold-based Zf protein and the translocation sequence. Any suitable linker can be used, e.g., a peptide linker.

The selected scaffold-based Zf protein can also be introduced into an animal cell, preferably a mammalian cell, via a liposomes and liposome derivatives such as immunoliposomes. The term “liposome” refers to vesicles comprised of one or more concentrically ordered lipid bilayers, which encapsulate an aqueous phase. The aqueous phase typically contains the compound to be delivered to the cell, i.e., the selected scaffold-based Zf protein.

The liposome fuses with the plasma membrane, thereby releasing the compound into the cytosol. Alternatively, the liposome is phagocytosed or taken up by the cell in a transport vesicle. Once in the endosome or phagosome, the liposome either degrades or fuses with the membrane of the transport vesicle and releases its contents.

In current methods of compound delivery via liposomes, the liposome ultimately becomes permeable and releases the encapsulated compound (in this case, the selected scaffold-based Zf protein) at the target tissue or cell. For systemic or tissue specific delivery, this can be accomplished, for example, in a passive manner wherein the liposome bilayer degrades over time through the action of various agents in the body. Alternatively, active compcompound release involves using an agent to induce a permeability change in the liposome vesicle. Liposome membranes can be constructed so that they become destabilized when the environment becomes acidic near the liposome membrane (see, e.g., PNAS 84:7851 (1987); Biochemistry 28:908 (1989)). When liposomes are endocytosed by a target cell, for example, they become destabilized and release their contents. This destabilization is termed fusogenesis. Dioleoylphosphatidylethanolamine (DOPE) is the basis of many “fusogenic” systems.

Such liposomes typically comprise the selected scaffold-based Zf protein and a lipid component, e.g., a neutral and/or cationic lipid, optionally including a receptor-recognition molecule such as an antibody that binds to a predetermined cell surface receptor or ligand (e.g., an antigen). A variety of methods are available for preparing liposomes as described in, e.g., Szoka et al., Ann. Rev. Biophys. Bioeng. 9:467 (1980), U.S. Pat. Nos. 4,186,183, 4,217,344, 4,235,871, 4,261,975, 4,485,054, 4,501,728, 4,774,085, 4,837,028, 4,235,871, 4,261,975, 4,485,054, 4,501,728, 4,774,085, 4,837,028, 4,946,787, PCT Publication No. WO 91.backslash. 17424, Deamer & Bangham, Biochim. Biophys. Acta 443:629-634 (1976); Fraley, et al., PNAS 76:3348-3352 (1979); Hope et al., Biochim. Biophys. Acta 812:55-65 (1985); Mayer et al., Biochim. Biophys. Acta 858:161-168 (1986); Williams et al., PNAS 85:242-246 (1988); Liposomes (Ostro (ed.), 1983, Chapter 1); Hope et al., Chem. Phys. Lip. 40:89 (1986); Gregoriadis, Liposome Technology (1984) and Lasic, Liposomes: from Physics to Applications (1993)). Suitable methods include, for example, sonication, extrusion, high pressure/homogenization, microfluidization, detergent dialysis, calcium-induced fusion of small liposome vesicles and ether-fusion methods, all of which are well known in the art.

In certain embodiments, it is desirable to target liposomes using targeting moieties that are specific to a particular cell type, tissue, and the like. Targeting of liposomes using a variety of targeting moieties (e.g., ligands, receptors, and monoclonal antibodies) has been previously described (see, e.g., U.S. Pat. Nos. 4,957,773 and 4,603,044).

Examples of targeting moieties include monoclonal antibodies specific to antigens associated with neoplasms, such as prostate cancer specific antigen and MAGE. Tumors can also be diagnosed by detecting gene products resulting from the activation or over-expression of oncogenes, such as ras or c-erbB2. In addition, many tumors express antigens normally expressed by fetal tissue, such as the alphafetoprotein (AFP) and carcinoembryonic antigen (CEA). Sites of viral infection can be diagnosed using various viral antigens such as hepatitis B core and surface antigens (HBVc, HBVs) hepatitis C antigens, Epstein-Barr virus antigens, human immunodeficiency type-1 virus (HIV1) and papilloma virus antigens. Inflammation can be detected using molecules specifically recognized by surface molecules which are expressed at sites of inflammation such as integrins (e.g., VCAM-1), selectin receptors (e.g., ELAM-1) and the like.

Standard methods for coupling targeting agents to liposomes can be used. These methods generally involve incorporation into liposomes lipid components, e.g., phosphatidylethanolamine, which can be activated for attachment of targeting agents, or derivatized lipophilic compounds, such as lipid derivatized bleomycin. Antibody targeted liposomes can be constructed using, for instance, liposomes which incorporate protein A (see Renneisen et al., J. Biol. Chem., 265:16337-16342 (1990) and Leonetti et al., PNAS 87:2448-2451 (1990).

v. Dosages

For therapeutic applications, the dose of the selected scaffold-based transcription factor to be administered to a patient is calculated in the same was as has already been described for other types of synthetic zinc finger proteins, see for example U.S. Pat. No. 6,511,808, U.S. U.S. Pat. No. 6,492,117, U.S. Pat. No. 6,453,242, U.S. patent application 2002/0164575 A1, and U.S. patent application 2002/0160940 A1. In the context of the present disclosure, should be sufficient to effect a beneficial therapeutic response in the patient over time. In addition, particular dosage regimens can be useful for determining phenotypic changes in an experimental setting, e.g., in functional genomics studies, and in cell or animal models. The dose will be determined by the efficacy, specificity, and K_{D} of the particular selected scaffold-based Zf protein employed, the nuclear volume of the target cell, and the condition of the patient, as well as the body weight or surface area of the patient to be treated. The size of the dose also will be determined by the existence, nature, and extent of any adverse side-effects that accompany the administration of a particular compound or vector in a particular patient.

vi. Pharmaceutical Compositions and Administration

Appropriate pharmaceutical compositions for administration of the scaffold-based transcription factors of the present invention are determined as already described for other types of synthetic zinc finger proteins, see for example U.S. Pat. No. 6,511,808, U.S. U.S. Pat. No. 6,492,117, U.S. Pat. No. 6,453,242, U.S. patent application 2002/0164575 A1, and U.S. patent application 2002/0160940 A1. Scaffold-based-based Zf proteins, and expression vectors encoding scaffold-based Zf proteins, can be administered directly to the patient for modulation of gene expression and for therapeutic or prophylactic applications, for example, cancer, ischemia, diabetic retinopathy, macular degeneration, rheumatoid arthritis, psoriasis, HIV infection, sickle cell anemia, Alzheimer's disease, muscular dystrophy, neurodegenerative diseases, vascular disease, cystic fibrosis, stroke, and the like. Examples of microorganisms that can be inhibited by Zf gene therapy include pathogenic bacteria, e.g., chlamydia, rickettsial bacteria, mycobacteria, staphylococci, streptococci, pneumococci, meningococci and conococci, klebsiella, proteus, serratia, pseudomonas, legionella, diphtheria, salmonella, bacilli, cholera, tetanus, botulism, anthrax, plague, leptospirosis, and Lyme disease bacteria; infectious fungus, e.g., Aspergillus, Candida species; protozoa such as sporozoa (e.g., Plasmodia), rhizopods (e.g., Entamoeba) and flagellates (Trypanosoma, Leishmania, Trichomonas, Giardia, etc.);viral diseases, e.g., hepatitis (A, B, or C), herpes virus (e.g., VZV, HSV-1, HSV-6, HSV-II, CMV, and EBV), HIV, Ebola, adenovirus, influenza virus, flaviviruses, echovirus, rhinovirus, coxsackie virus, comovirus, respiratory syncytial virus, mumps virus, rotavirus, measles virus, rubella virus, parvovirus, vaccinia virus, HTLV virus, dengue virus, papillomavirus, poliovirus, rabies virus, and arboviral encephalitis virus, etc.

Administration of therapeutically effective amounts is by any of the routes normally used for introducing Zf proteins into ultimate contact with the tissue to be treated. The Zf proteins are administered in any suitable manner, preferably with pharmaceutically acceptable carriers. Suitable methods of administering such modulators are available and well known to those of skill in the art, and, although more than one route can be used to administer a particular composition, a particular route can often provide a more immediate and more effective reaction than another route.

Pharmaceutically acceptable carriers are determined in part by the particular composition being administered, as well as by the particular method used to administer the composition. Accordingly, there is a wide variety of suitable formulations of pharmaceutical compositions that are available (see, e.g., Remington's Pharmaceutical Sciences, 17.sup.th ed. 1985)).

The ZFPs, alone or in combination with other suitable components, can be made into aerosol formulations (i.e., they can be “nebulized”) to be administered via inhalation. Aerosol formulations can be placed into pressurized acceptable propellants, such as dichlorodifluoromethane, propane, nitrogen, and the like.

Formulations suitable for parenteral administration, such as, for example, by intravenous, intramuscular, intradermal, and subcutaneous routes, include aqueous and non-aqueous, isotonic sterile injection solutions, which can contain antioxidants, buffers, bacteriostats, and solutes that render the formulation isotonic with the blood of the intended recipient, and aqueous and non-aqueous sterile suspensions that can include suspending agents, solubilizers, thickening agents, stabilizers, and preservatives. The disclosed compositions can be administered, for example, by intravenous infusion, orally, topically, intraperitoneally, intravesically or intrathecally. The formulations of compounds can be presented in unit-dose or multi-dose sealed containers, such as ampules and vials. Injection solutions and suspensions can be prepared from sterile powders, granules, and tablets of the kind previously described.

vii. Regulation of Gene Expression in Plants

Scaffold-based Zf proteins can be used to engineer plants for traits such as increased disease resistance, modification of structural and storage polysaccharides, flavors, proteins, and fatty acids, fruit ripening, yield, color, nutritional characteristics, improved storage capability, and the like. In particular, the engineering of crop species for enhanced oil production, e.g., the modification of the fatty acids produced in oilseeds, is of interest.

Seed oils are composed primarily of triacylglycerols (TAGs), which are glycerol esters of fatty acids. Commercial production of these vegetable oils is accounted for primarily by six major oil crops (soybean, oil palm, rapeseed, sunflower, cotton seed, and peanut.) Vegetable oils are used predominantly (90%) for human consumption as margarine, shortening, salad oils, and frying oil. The remaining 10% is used for non-food applications such as lubricants, oleochemicals, biofuels, detergents, and other industrial applications.

The desired characteristics of the oil used in each of these applications varies widely, particularly in terms of the chain length and number of double bonds present in the fatty acids making up the TAGs. These properties are manipulated by the plant in order to control membrane fluidity and temperature sensitivity. The same properties can be controlled using selected scaffold-based Zf protein to produce oils with improved characteristics for food and industrial uses.

The primary fatty acids in the TAGs of oilseed crops are 16 to 18 carbons in length and contain 0 to 3 double bonds. Palmitic acid (16:0 [16 carbons: 0 double bonds]), oleic acid (18:1), linoleic acid (18:2), and linolenic acid (18:3) predominate. The number of double bonds, or degree of saturation, determines the melting temperature, reactivity, cooking performance, and health attributes of the resulting oil.

The enzyme responsible for the conversion of oleic acid (18:1) into linoleic acid (18:2) (which is then the precursor for 18:3 formation) is delta 12-oleate desaturase, also referred to as omega-6 desaturase. A block at this step in the fatty acid desaturation pathway should result in the accumulation oleic acid at the expense of polyunsaturates.

In one embodiment selected scaffold-based Zf proteins are used to regulate expression of the FAD2-1 gene in soybeans. Two genes encoding microsomal delta 6 desaturases have been cloned recently from soybean, and are referred to as FAD2-1 and FAD2-2 (Heppard et al., Plant Physiol. 110:311-319 (1996)). FAD2-1 (δ-12 desaturase) appears to control the bulk of oleic acid desaturation in the soybean seed. Scaffold-based Zf proteins can thus be used to modulate gene expression of FAD2-1 in plants. Specifically, NRSF-based Zf proteins can be used to inhibit expression of the FAD2-1 gene in soybean in order to increase the accumulation of oleic acid (18:1) in the oil seed. Moreover, scaffold-based Zf proteins can be used to modulate expression of any other plant gene, such as delta-9 desaturase, delta-12 desaturases from other plants, delta-15 desaturase, acetyl-CoA carboxylase, acyl-ACP-thioesterase, ADP-glucose pyrophosphorylase, starch synthase, cellulose synthase, sucrose synthase, senescence-associated genes, heavy metal chelators, fatty acid hydroperoxide lyase, polygalacturonase, EPSP synthase, plant viral genes, plant fungal pathogen genes, and plant bacterial pathogen genes.

Recombinant DNA vectors suitable for transformation of plant cells are also used to deliver protein (e.g., NRSF-based Zf proteins)-encoding nucleic acids to plant cells. Techniques for transforming a wide variety of higher plant species are well known and described in the technical and scientific literature (see, e.g., Weising et al. Ann. Rev. Genet. 22:421-477 (1988)). A DNA sequence coding for the desired ZFP is combined with transcriptional and translational initiation regulatory sequences which will direct the transcription of the ZFP in the intended tissues of the transformed plant.

For example, a plant promoter fragment may be employed which will direct expression of the scaffold-based Zf protein in all tissues of a regenerated plant. Such promoters are referred to herein as “constitutive” promoters and are active under most environmental conditions and states of development or cell differentiation. Examples of constitutive promoters include the cauliflower mosaic virus (CaMV) 35 S transcription initiation region, the 1′- or 2′-promoter derived from T-DNA of Agrobacterium tumafaciens, and other transcription initiation regions from various plant genes known to those of skill.

Alternatively, the plant promoter may direct expression of the scaffold-based Zf protein in a specific tissue or may be otherwise under more precise environmental or developmental control. Such promoters are referred to here as “inducible” promoters. Examples of environmental conditions that may effect transcription by inducible promoters include anaerobic conditions or the presence of light.

Examples of promoters under developmental control include promoters that initiate transcription only in certain tissues, such as fruit, seeds, or flowers. For example, the use of a polygalacturonase promoter can direct expression of the ZFP in the fruit, a CHS-A (chalcone synthase A from petunia) promoter can direct expression of the ZFP in flower of a plant.

The vector comprising the ZFP sequences will typically comprise a marker gene which confers a selectable phenotype on plant cells. For example, the marker may encode biocide resistance, particularly antibiotic resistance, such as resistance to kanamycin, G418, bleomycin, hygromycin, or herbicide resistance, such as resistance to chlorosluforon or Basta.

Such DNA constructs may be introduced into the genome of the desired plant host by a variety of conventional techniques. For example, the DNA construct may be introduced directly into the genomic DNA of the plant cell using techniques such as electroporation and microinjection of plant cell protoplasts, or the DNA constructs can be introduced directly to plant tissue using biolistic methods, such as DNA particle bombardment. Alternatively, the DNA constructs may be combined with suitable T-DNA flanking regions and introduced into a conventional Agrobacterium tumefaciens host vector. The virulence functions of the Agrobacterium tumefaciens host will direct the insertion of the construct and adjacent marker into the plant cell DNA when the cell is infected by the bacteria.

Microinjection techniques are known in the art and well described in the scientific and patent literature. The introduction of DNA constructs using polyethylene glycol precipitation is described in Paszkowski et al. EMBO J. 3:2717-2722 (1984). Electroporation techniques are described in Fromm et al. PNAS 82:5824 (1985). Biolistic transformation techniques are described in Klein et al. Nature 327:70-73 (1987).

Agrobacterium tumefaciens-meditated transformation techniques are well described in the scientific literature (see, e.g., Horsch et al Science 233:496₋498 (1984)); and Fraley et al. PNAS 80:4803 (1983)).

Transformed plant cells which are derived by any of the above transformation techniques can be cultured to regenerate a whole plant which possesses the transformed genotype and thus the desired ZFP-controlled phenotype. Such regeneration techniques rely on manipulation of certain phytohormones in a tissue culture growth medium, typically relying on a biocide and/or herbicide marker which has been introduced together with the ZFP nucleotide sequences. Plant regeneration from cultured protoplasts is described in Evans et al., Protoplasts Isolation and Culture, Handbook of Plant Cell Culture, pp. 124-176 (1983); and Binding, Regeneration of Plants, Plant Protoplasts, pp. 21-73 (1985). Regeneration can also be obtained from plant callus, explants, organs, or parts thereof. Such regeneration techniques are described generally in Klee et al. Ann. Rev. of Plant Phys. 38:467-486 (1987).

viii. Functional Genomics Assays

Scaffold-based Zf proteins also have use for assays to determine the phenotypic consequences and function of gene expression. Recent advances in analytical techniques, coupled with focused mass sequencing efforts have created the opportunity to identify and characterize many more molecular targets than were previously available. This new information about genes and their functions will improve basic biological understanding and present many new targets for therapeutic intervention. In some cases analytical tools have not kept pace with the generation of new data. An example is provided by recent advances in the measurement of global differential gene expression. These methods, typified by gene expression microarrays, differential cDNA cloning frequencies, subtractive hybridization and differential display methods, can very rapidly identify genes that are up or down-regulated in different tissues or in response to specific stimuli. Increasingly, such methods are being used to explore biological processes such as, transformation, tumor progression, the inflammatory response, neurological disorders etc. Many differentially expressed genes correlate with a given physiological phenomenon, but demonstrating a causative relationship between an individual differentially expressed gene and the phenomenon is labor intensive. Until now, simple methods for assigning function to differentially expressed genes have not kept pace with the ability to monitor differential gene expression.

The Zf technology of the present invention can be used to rapidly analyze the function of differentially expressed genes. Selected scaffold-based-based Zf proteins can be readily used to up or down-regulate any endogenous target gene. Very little sequence information is required to create a gene-specific DNA binding domain. This makes the scaffold-based Zf selection technology ideal for analysis of long lists of poorly characterized differentially expressed genes. One can simply build a zinc finger-based DNA binding domain for each candidate gene, create chimeric up and down-regulating artificial transcription factors and test the consequence of up or down-regulation on the phenotype under study (transformation, response to a cytokine etc.) by switching the candidate genes on or off one at a time in a model system.

Additionally, greater experimental control can be imparted by scaffold-based Zf proteins than can be achieved by more conventional methods. This is because the production and/or function of scaffold-based Zf proteins, like other Zf proteins, can be placed under small molecule control. Examples of this approach are provided by the Tet-On system, the ecdysone-regulated system and a system incorporating a chimeric factor including a mutant progesterone receptor. These systems are all capable of indirectly imparting small molecule control on any endogenous gene of interest or any transgene by placing the function and/or expression of a scaffold-based Zf protein under small molecule control.

ix. Transgenic Mice

A further application Zf proteins of the present inventions, is their use in manipulating gene expression in animal models. As with cell lines, the introduction of a heterologous gene to a transgenic animal, such as a transgenic mouse, is a fairly straightforward process. Thus, transgenic expression of a Zf proteins in an animal can be readily performed.

By transgenically expressing Zf proteins of the present invention comprising an activation domain, a gene of interest can be over-expressed. Similarly, by transgenically expressing a suitable Zf protein fused to a repressor or silencer domain, the expression of a gene of interest can be down-regulated, or even switched off to create “functional knockout”.

Two common issues often prevent the successful application of the standard transgenic and knockout technology; embryonic lethality and developmental compensation. Embryonic lethality results when the gene plays an essential role in development. Developmental compensation is the substitution of a related gene product for the gene product being knocked out, and often results in a lack of a phenotype in a knockout mouse when the ablation of that gene's function would otherwise cause a physiological change.

Transgenic expression of the Zf proteins of the present invention can be temporally controlled, for example using small molecule regulated systems as described in the previous section. Thus, by switching-on expression of the selected Zf protein at a desired stage in development, a gene can be over-expressed or “functionally knocked-out” in the adult (or at a late stage in development), thus avoiding the problems of embryonic lethality and developmental compensation.

### EXAMPLES

The following examples are provided to describe and illustrate, but not limit, the claimed invention. Those of skill in the art will readily recognize a variety of non-critical parameters that could be changed or modified to yield essentially similar results.

### Example 1

### Use of the Bacterial 2-Hybrid System to Study the Binding of NRSF to DNA

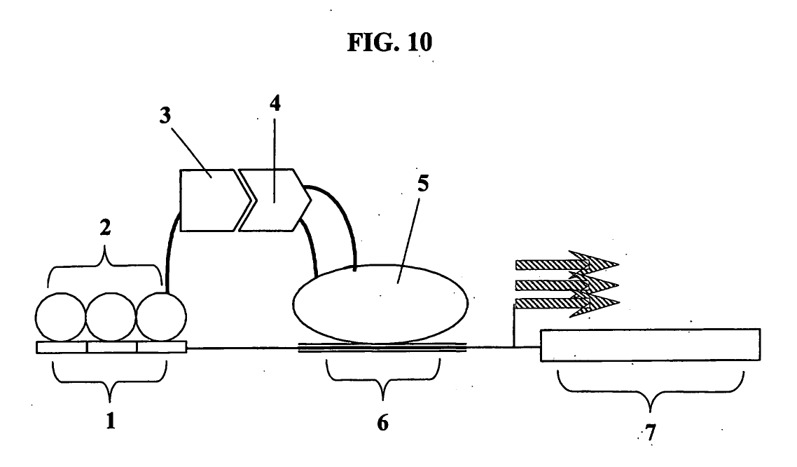

The use of a bacterial 2-hybrid system to identify and study Cys₂His₂ Zf proteins has been described (Joung et al., 2000, Proceedings of the National Academy of Sciences (USA) 97:7382 and US Patent Application No. 20020119498). As shown in FIG. 10, in an appropriately engineered E. coli strain, binding of a Zf protein (2) to a target DNA sequence of interest (1) can trigger transcriptional activation of a reporter gene (7). In this strain, the target DNA sequence is positioned upstream of a weak promoter (6) that directs low level expression of a reporter gene (7). Transcription of the reporter gene (7) can be activated by expressing 2 hybrid proteins, one a fusion of the Zf protein (2) with a fragment of the yeast Gal11P protein (3) (to form GP-Zf) and the other a fusion between a fragment of the yeast Gal4 protein (4) and the E. coli RNA polymerase alpha subunit (5) (to form α-Gal4 protein). Since the yeast Gal11P(3) and Gal4 (4) protein fragments can interact with each other, GP-Zf bound to the target DNA sequence (1) can mediate recruitment of RNA polymerase complexes that have incorporated the α-Gal4 protein thereby stimulating transcription of the reporter gene (7) from the weak promoter (6) (see FIG. 10). This transcriptional activation is dependent upon binding of the GP-Zf hybrid protein to the target DNA sequence positioned near the weak promoter. Thus, in this type of engineered E. coli cell, the level of reporter gene expression provides an indirect measure how well a Zf protein occupies the target DNA sequence of interest.

In the methods of the present invention a bacterial 2-hybrid system is utilized in 2 different ways, 1) as a reporter system for assessing how well a Zf protein can bind to a target sequence and activate transcription, and 2) as a selection system for identifying Zf variants (e.g. from large randomized libraries >10⁸ in size) that bind to a target DNA sequence. As shown in FIG. 10, to use the bacterial 2-hybrid as a reporter system, requires the creation of a bacterial 2-hybrid reporter strain (“B2H reporter strain”) in which a target DNA sequence is positioned upstream of a weak promoter that directs the expression of the lacZ reporter gene. Expression of the lacZ gene product can be easily quantified by performing β-galactosidase assays. To use the system as a selection system, a bacterial 2-hybrid selection strain (“B2H selection strain”) is created in which a target sequence is positioned upstream of a weak promoter that directs expression of 2 co-cistronically expressed selectable markers, the yeast HIS3 gene and the bacterial aadA gene (use of these markers is described in detail in Joung et al., 2000). All strains (B2H reporter or B2H selection) also harbor a plasmid that expresses the α-Gal4 fusion protein. In addition, all Zf proteins introduced into either B2H reporter strains or B2H selection strains are expressed as fusions to a Gal11P fragment.

Histidine-deficient medium utilized for selections has been previously described. Where required, the following antibiotics were added: carbenicillin (50 μg/ml in liquid medium, 100 μg/ml in solid medium), chloramphenicol (30 μg/ml), kanamycin (30 μg/ml). Isopropyl β-D-thiogalactoside (IPTG, to induce protein expression), 3-aminotriazole (3-AT, a HIS3 competitive inhibitor), and streptomycin were added at various concentrations to control selection conditions.

The αGal4 protein expression plasmid used has been described previously by (Joung et al., 2000, Proceedings of the National Academy of Sciences (USA) 97:7382). Zinc finger proteins (ZFPs) were expressed from vectors based on the previously described pBR-GP-ZI 23 plasmid (Joung et al., 2000 as above). In these plasmids the inducible lacUV5 promoter directs the expression of a Zf protein fused to a fragment of the yeast Gal11p protein. Reporter strains for both selections and in vivo transcriptional activation assays were constructed as described (Joung et al., 2000 as above). These strains contain a single copy F′-episome with the target DNA binding site positioned immediately upstream of a weak lac-promoter that controls the transcription of the selectable HIS3 and aadA genes (in “B2H selection strains”) or the lacZ reporter gene (in “B2H reporter strains”).

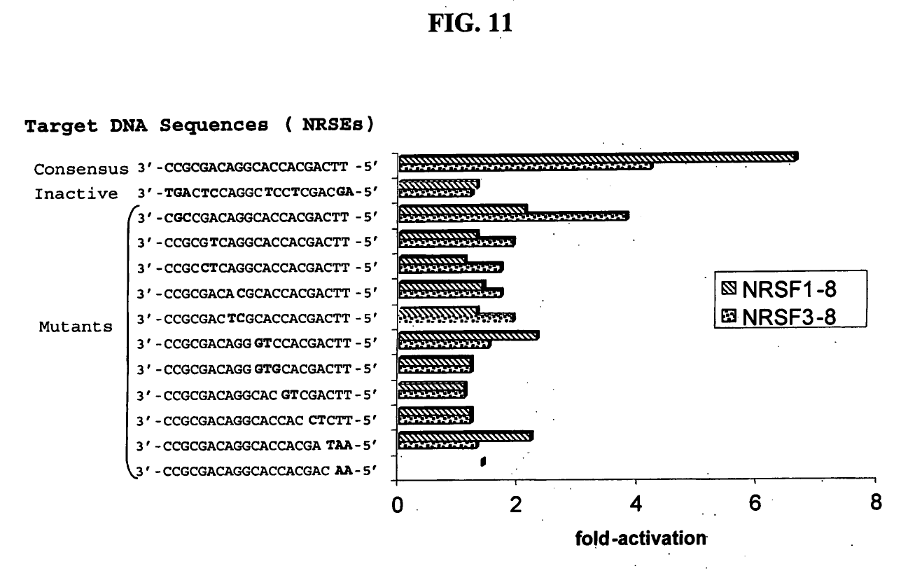

Experiments were performed to determine whether the NRSF Zf domain could be studied using the bacterial 2-hybrid system. To do this, the NRSF DNA binding domain (Zfs 1-8) was fused to a fragment of the yeast Gal11P protein to create the GP-NRSF1-8 hybrid protein. In addition, a “B2H reporter strain” was constructed that harbors a consensus NRSE as the target sequence. Plasmids encoding the GP-NRSF1-8 protein or a Gal11P fragment (as a control) were then each introduced into the B2H reporter strain and α-galactosidase assays performed to measure lacZ expression. As shown in FIG. 11, the GP-NRSF 1-8 fusion protein efficiently stimulates transcription of the lacZ gene nearly 7-fold compared with the Gal11P only control. This increased lacZ expression is dependent upon binding of GP-NRSF 1-8 to the consensus NRSE, as replacement of this sequence with an “inactive” NRSE (to which NRSF fails to bind in vitro or in vivo) abolishes activation (see FIG. 11).

In conclusion, GP-NRSF 1-8 can bind to the consensus NRSE present in the B2H reporter strain, and stimulate transcription of the associated lacZ reporter gene. Thus, the bacterial 2-hybrid system provides a useful genetic method for studying DNA binding by the NRSF Zf domain.

### Example 2

### The NRSF Zf Domain Binds to the NRSE with High Specificity

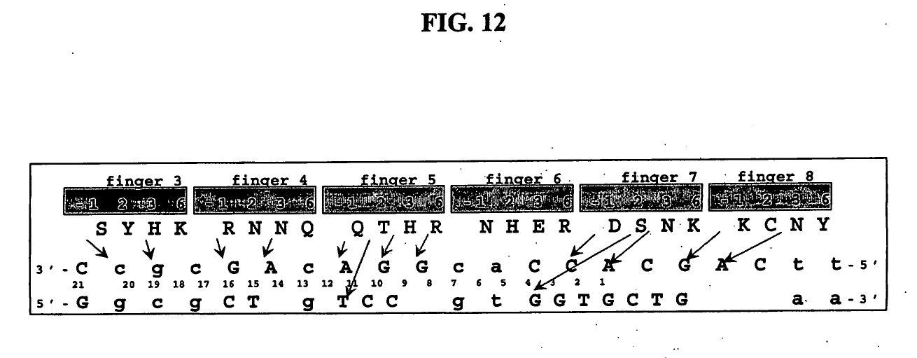

The bacterial 2-hybrid system was used as a method to assess the specificity of DNA binding by the NRSF Zf domain. Only Zf proteins that bind with high affinity and specificity for their target DNA sequence can activate transcription efficiently in the bacterial 2-hybrid system. Thus, this system provides a rapid method to assess how well a given Zf protein can recognize a target site of interest. A series of “B2H reporter strains,” was generated, each bearing one of the mutated NRSE sequences shown in FIG. 11 as a target sequence. These mutated sites bear single or clustered double or triple base pair substitutions in positions distributed throughout the consensus NRSE. To assess the effects of these mutations on DNA binding by the wild-type NRSF Zf domain, plasmids expressing the GP-NRSF1-8 or the Gal11P control fragment were introduced into each of the B2H reporter strains and β-galactosidase activities assessed. As shown in FIG. 11, many of the mutations introduced in the consensus NRSE resulted in near complete loss of transcriptional activation. This sensitivity of binding to small changes throughout the length of the NRSE strongly suggests that NRSF simultaneously contacts many of the bases within the NRSE, and binds to a sequence that spans at least 20 of the 21 bases in the NRSE with specificity. There also appeared to be a correlation between the effect of mutating particular bases and the degree to which these bases are conserved in the NRSE consensus sequence (see mutant NRSE sites in FIG. 11 and the conserved bases in FIG. 12). Changing more strongly conserved bases resulted in greater loss of transcriptional activation. Since the consensus is based on functionally defined NRSE sequences, this correlation suggests that the binding of NRSF to the consensus NRSE according to the methods of the present invention, accurately reflects the physiologic interaction.

### Example 3

### Model for Binding of NRSF Fingers 3-8 to the NRSE

Our existing understanding of how Zfs bind to and recognize specific DNA sites permits some limited ability to predict the DNA sequences likely to be bound by a given finger. A single Zf commonly uses residues within or adjacent to its recognition helix to make contacts with bases in the major groove of DNA. Structural information combined with results from studies of designed synthetic Zfs have together demonstrated a collection of contacts that occur between amino acids at specific positions in the recognition helix and 4 consecutive bases on a DNA strand. In addition, to a first approximation, fingers linked in tandem (particularly those connected by canonical TGEKP-type linkers) will recognize adjacent stretches of DNA (i.e., large gaps do not typically occur in the sequence of recognized bases).

A model that plausibly matches the residues in the recognition helices of NRSF fingers 3 through 8 with the NRSE sequence was constructed. The proposed alignment (shown in FIG. 12) matches the typical directional “polarity” of Zfs to DNA (N-terminal to C-terminal protein “reads” 3′ to 5′ DNA sequence) and postulates plausible contacts along a span of 17 base pairs of DNA. In this particular model there are no contacts to certain weakly conserved positions in the consensus NRSE. In addition, this model lacks contacts for any residues in finger 6, (because this finger is also positioned over a weakly conserved region of the consensus, finger 6 may not make sequence-specific DNA binding contacts with the NRSE).

### Example 4

### NRSF Zf1 and Zf2 are not Required for DNA Binding

The model for the NRSF/NRSE interaction described in Example 3 does not assign a direct DNA binding role to either fingers 1 or 2. These fingers are separated from each other, and from fingers 3 through 8, by linkers longer than the 5 residue linkers present between the remaining fingers. It was therefore hypothesized that these 2 fingers may not participate directly in DNA binding. To test this hypothesis, we used the bacterial 2-hybrid system and in vitro DNA-binding assays to determine whether fingers 3 through 8 from NRSF were sufficient to bind the NRSE.

The bacterial media, and bacterial plasmids and strains used, were as described in the previous example.

Protein expression and purification. Maltose binding protein—zinc finger protein fusions (MBP-ZFP) were expressed from a T7 promoter (plasmid pEXP1-DEST, Invitrogen, Carlsbad, Calif.) in the Expressway coupled in vitro transcription/translation system (Invitrogen, Carlsbad, Calif.). Proteins were expressed according to the manufacturer's instructions at 37° C. for 3.5 hours with the addition of 500 uM ZnCl₂ and the omission of the post-synthesis RNAse A treatment. Two to three synthesis reactions for each protein were pooled and the MBP-ZFP were batch affinity purified using amylose resin (New England Biolabs). Amylose beads were washed three times with 1 ml of WB1 [15 mM HEPES pH 7.8, 200 mM NaCl, 1 mM EDTA, 20 uM ZnSO₄, 1 mM DTT] prior to the addition of protein. Proteins were allowed to bind to beads in a total volume of 750 μl while rotating for 1.5 hours at 4° C. After binding, the slurry was spun at 2×g for 3 minutes at 4° C. and unbound proteins and in vitro transcription/translation components were removed from beads by pipet. Beads were subsequently washed twice with 700 μl WB1 and twice more with 700 μl WB2 [binding buffer from Greisman and Pabo, Science (1997) with omission of acetylated BSA and addition of 1 mM DTT]. After the final centrifugation, supernatant was removed and beads were resuspended in 200 μl elution buffer [WB2+40 mM maltose]. Elution reactions were rotated at 22° C. for 30 minutes and supernatant containing MBP-ZFP was aliquoted and frozen for storage at −80° C.

Electrophoretic Mobility Shift Assays (EMSA). Gel shift assays were performed as previously described by Greisman and Pabo, Science (1997), except that a) binding buffer contained non-acetylated bovine serum albumin (100 ug/ml), b) 0.5 pM or 1 pM of the labeled DNA site was used for each binding reaction, and c) protein-DNA mixtures were incubated for 1 or 4 hours at room temperature. Results for both incubation times were comparable indicating that the binding reactions had reached equilibrium after one hour and thus results of all experiments were averaged. Reactions were subjected to gel electrophoresis on Criterion 4-20% native TBE polyacrylamide gels (Bio-Rad, Hercules, Calif.). Gels were dried, exposed overnight to phosphorimaging screens, and quantitated using Quantity One imaging software (Bio-Rad). In order to determine dissociation constants, the % of DNA bound (θ) was plotted against the concentration of protein [P] in each binding reaction. SigmaPlot8 (Sigma) non-linear regression software was used to fit the curve plotted above according to Equation (1) in the manuscript by Elrod-Erickson and Pabo (J Biol Chem (1999) July 2; 274(27):19281-5) and to calculate values for the Kd of each protein. The concentration of active protein was determined for each experiment by titrating dilutions of the fusion ZFP against a fixed excess amount of unlabeled target site (12.5 nM) and a small amount of labeled target site (1 pM). Reactions were incubated and subjected to gel electrophoresis concurrently with those used for dissociation constant determination. Active protein concentrations ([P]_{stock}) were determined by plotting θ vs. 1/diln. factor according to Equation (1).

$$θ = \frac{{[ P ]}_{stock}}{di ln . factor} * \frac{1}{{[ DNA ]}_{t}} \qquad ( 1 )$$

Binding site competition experiments were performed according to Greisman & Pabo ((1997) Science 275:657 and U.S. Pat. No. 6,410,248) with the exception that 0.5 or 1 pM of radiolabeled target site was used. Specific and non-specific dissociation constants were averaged over at least three independent experiments (R²≧0.90).

In Vivo Transcriptional Activation Assays (β-galactosidase assays): DNA encoding selected Gal11p-Zf protein fusions and plasmid encoding αGal4 were co-transformed into bacterial reporter strains containing respective targeted binding sites upstream of a weak promoter driving expression of the lacZ gene. β-galactosidase assays assays were performed as described previously (Joung et al., PNAS 2000).

A hybrid protein consisting of NRSF fingers 3-8 fused to the yeast Gal11P fragment (protein GP-NRSF3-8) was expressed in B2H reporter strains harboring the consensus NRSE or a mutant NRSE as the target sequence and β-galactosidase assays were performed. The results shown in FIG. 11 demonstrate that GP-NRSF3-8 can bind to the consensus NRSE and activate transcription nearly as efficiently as GP-NRSF1-8. To assess the specificity of DNA binding by GP-NRSF3-8, this protein was also expressed in the series of “B2H reporter strains” harboring mutated NRSE sites bearing single or clustered double or triple base pair substitutions in positions distributed throughout the NRSE and again β-galactosidase assays were performed. The results demonstrate that, like GP-NRSF1-8, GP-NRSF3-8 binds with great specificity to a span of at least 20 base pairs of DNA sequence (see FIG. 11). However, certain mutations appear to have differential effects on binding by the NRSF1-8 and NRSF3-8 domains (e.g. mutations at the 3′ end of the NRSE) indicating that fingers 1 and/or 2 may play an indirect role in influencing DNA binding specificity.

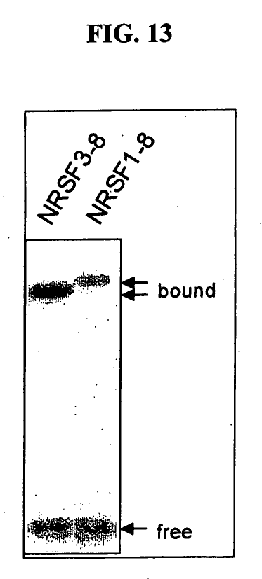

Using electrophoretic mobility shift assays, biochemical evidence that purified NRSF3-8 binds to the consensus NRSE with an affinity that approaches that of purified NRSF1-8 for the same site was also obtained. Domains of NRSF fingers 1-8 and fingers 3-8 (NRSF1-8 and NRSF3-8) were expressed and purified as fusions to the maltose-binding protein using a standard optimized procedure. A synthetic double-stranded DNA template bearing a single consensus NRSE was radioactively labeled to high specific activity. Electrophoretic mobility shift assays using purified proteins demonstrate that both of NRSF1-8 and NRSF3-8 can bind to the consensus NRSE site in vitro (see FIG. 13). In addition, inspection of protein titration experiments suggest that both NRSF1-8 and NRSF3-8 bind with an apparent dissociation constant in the low picomolar range with NRSF1-8 binding somewhat more tightly than NRSF3-8. Taken together, the bacterial cell-based results and biochemical analysis strongly suggest that fingers 1 and 2 of NRSF are not required for binding to the consensus NRSE, though they may make indirect contributions to DNA binding affinity and specificity.

### Example 5

### Construction of NRSF-Based Primary Libraries

Six different NRSF-based primary libraries were constructed. Each library expressed variants of a fusion protein consisting of a fusion between a fragment of the yeast Gal11P protein (Joung et al., PNAS 2000) and the NRSF zinc finger DNA binding domain (fingers 1-8). For each library, six positions within or just amino terminal to the recognition helix (positions −1, 1, 2, 3, 5 and 6 numbered with respect to the start of the alpha helix), were randomized. In each of the six libraries, only one of fingers 3, 4, 5, 6, 7, or 8 was randomized. The “codon doping” strategy utilized for the finger 4 and 5 libraries used 24 codons to encode 16 amino acids (all except cysteine, tryptophan, tyrosine, and phenylalanine). The “codon doping” strategy utilized for the finger 3, 6, 7, and 8 libraries used 24 codons to encode 19 amino acids (all except cysteine).

To generate these libraries, first a plasmid was designed to express the Gal11P—NRSF F1-F8 protein (plasmid ST120) by replacing the coding sequence of the finger to be randomized with a “stuffer” sequence containing two Bbsl sites flanking a BamHI site. BbsI is a type IIS restriction enzyme that recognizes a particular sequence but cleaves a certain number of bases away (regardless of what the adjacent sequence is). In the “stuffer” plasmids, digestion with Bbsl excised the stuffer sequence to leave incompatible sticky overhangs.

Next a partially randomized fragment of DNA encoding the randomized finger residues was ligated into the BbsI-digested “stuffer” plasmid. The fragment of DNA consists of a partially randomized oligonucleotide annealed to two “annealing oligos” that are complementary to the constant regions of the partially randomized oligonucleotide. Partially randomized oligonucleotides comprising 24 codons encoding 16 amino acids were obtained commercially. Partially randomized oligonucleotides comprising 24 codons encoding 19 amino acids were produced using a standard laboratory nucleic acid synthesizer, according to the manufactures instructions. This annealed oligo fragment has sticky ends that are compatible with the BbsI-digested “stuffer” plasmid. The resulting ligation product reconstitutes the Gal11P-NRSF F1-F8 fusion protein but with randomization of the appropriate six recognition helix residues in one finger.

This ligation mixture was then electroporated into high efficiency XL1-Blue E. coli cells and more than 10⁹ transformants were obtained. The phagemids in these cells were then converted into infectious bacteriophage particles by infecting with helper phage M13K07. The phage particles were harvested, concentrated and then stored frozen.

After titering, these phage stocks can be used to introduce the library into an appropriate Bacterial two-hybrid selection strain.

The specific protocols used for library construction were as follows:

To create the randomized DNA fragments, kinase “annealing” of randomized oligos was performed by incubating 30 μl of gel purified oligo (10 pmol/μl), 5 μl 10×T4 DNA ligase buffer (NEB), 1 μl T4 polynucleotide Kinase (10 U/μl), and 14 μl H₂0 (final reaction 50 μl and 6 pmol/ul) for 30 minutes at 37° C., 30 minutes at 65° C., and 20 minutes at 4° C.

Annealing cassettes were generated by incubating, 20 μl kinased annealing oligo 1, 20 μl kinased annealing oligo 2, 20 μl kinased randomized oligo, 8 μl 10× annealing buffer, and 12 μl H₂0 (total reaction volume 80 μl at 1.5 pmol/ul), at 98° C. for 4 minutes, 0.1° C. for 3 seconds, 36° C. for 5 minutes, followed by a “slow cool” to 25° C. and then to 4° C.

The “stuffer” plasmid vector DNA for ligation was prepared by digesting 35 μg of maxi DNA with 40 μl of fresh NEB2, 40 μl of fresh BbsI (5 U/ul), in a 400 μl, reaction volume (made up with H₂0) overnight at 37° C., and then adding 50 μl 10× BSA, 47.5 μl 10× SalI Buffer, 2.5 μl BamHI (20 U/μl) at 37° C. for 2.5 hours.

The digestion reactions were then purified over four QIAgen PCR purification columns, by adding each digest to 2.5 ml PB buffer (Qiagen) in a 50 cc conical tube, passing 750 μl through each column, and spinning, washing each column with 750% PE, and spinning twice, eluting each column with 50 μl of prewarmed (60° C.) 0.1× EB, re-eluting with flow-through, pooling the eluates together, and measuring the OD₂₆₀ of a 1:200 dilution in H₂0.

The ligation reactions for the “actual” libraries and a smaller scale vector control were performed at 16° C. overnight, as follows:

| | Actual | | Control | |
|---|---|---|---|---|
| BbsI/BamHI Vector DNA (0.1 μg/ul) | 150 | μl | 7.5 | μl |
| FRESH 10× T4 DNA Ligase Buffer (NEB) | 50 | μl | 2.5 | μl |
| Annealed oligos or H₂0 | 27 | μl | 1 | μl H₂0 |
| FRESH T4 DNA Ligase (2000 U/ul) | 4 | μl | 0.2 | μl |
| H₂0 | 269 | μl | 13.8 | μl |
| (Total reaction volume) | (500 | μl) | (25 | μl) |

Gaps were then “filled in” using Sequenase 2.0 enzyme at 37° C. for 1.5 hours, as follows.

Each “actual” library and each vector control was transformed into chemical competent XL1 Blue cells. The transformation mixture was held on ice for 10 minutes, then incubated at 42° C. for 2 minutes, before placing back on ice for 2 minutes and the adding 900 μl pf LB an incubating at 37° C. for 45 minutes.

Each library transformation mixture was then serially diluted 10⁰ to 10⁻² in Luria Broth (LB, see Sambrook et al., Molecular Cloning; A Laboratory Manual 2d ed. (1989)), and 5 μl×3 of each dilution was spotted onto LB/12.5 μg/ml tetracycline/100 μg/ml carbenicillin plates, which were incubated at 37° C. overnight.

The “filled in” library ligations were phenol chloroform-extracted (without vortexing), and were then precipitated in the presence of 1 μl glycogen (20 mg/ml), 33 μl 3M NaOAc, and 900 ul 100% EtOH on dry ice for 25 minutes. A final wash in 500 μl of 70% EtOH was also performed before air drying the pellet and resuspending the library ligations in 40 μl of H₂0.

The library ligations were then electroporated into electrocompetent XL1 Blue cells, and allowed to recover in 100 ml cultures at 37° C. for 1 hr.

Pre-amplification titering was performed using 3 independent serial dilutions 10⁻¹ to 10⁻⁶ in 2XYT bacterial medium (see Sambrook et al., Molecular Cloning; A Laboratory Manual 2d ed. (1989)) and spotting 5 μl×3 of each dilution on LB/12.5 μg/ml tetracycline/100 μg/ml carbenicillin plates (to quantify the number of transformants) and LB/100 μg/ml carbenicillin/70 μg/ml kanamycin plates (to check for phage contamination).

To amplify, each library culture was transferred to a 2L baffled flask with 900 ml 2XYT, 1 ml of 50 μg/ml carbenicillin, 1 ml of 12.5 μg/ml tetracycline, and was shaken at 250 rpm, 37° C., for 2 hours.

Post-amplification titering was performed using 3 independent serial dilutions for each culture (10⁻¹ to 10⁻⁶ in 2XYT) and spotting 5 μl×3 on LB/12.5 μg/ml tetracycline/100 μg/ml carbenicillin and LB/100 μg/ml carbenicillin/70 μg/ml kanamycin plates, which were then incubated at 37° C. overnight.

To harvest, cultures were spun down in autoclaved 1 L centrifuge bottles at 4° C., 4000 rpm, for 30 minutes. Pellets were resuspended (on ice) in 20 ml 2XYT with 15% glycerol, and frozen in 4×5 ml aliquots in 15 ml conical tubes in dry ice/EtOH for 30 minutes before storing the libraries at −80° C. Typcial titers of these libaries were 10⁹ transformants with an approximately 4-10 fold amplification. To convert these libraries into infectious bacteriophage particles, the following procedure was performed.

1.2×5 ml aliquots of the frozen cells/library were thawed and inoculated into 90 ml 2XYT/12.5 μg/ml tetracycline/50 μg/ml carbenicillin in a 250 ml flask, which were incubated at 37° C. for 1.5 hours at 125 rpm. Then Aliquots were removed and diluted 10⁻¹ to 10⁻⁶ in 2XYT in triplicate for each library, and spotted (5 μl×3 of each dilution) on LB/12.5 μg/ml tetracycline/100 μg/ml carbenicillin and LB/100 μg/ml carbenicillin/70 μg/ml kanamycin plates. Next 10 ml of filtered M13K07 phage (˜1×10¹² KTU) was added, and incubated at room temp for 15 minutes before incubating at 37° C. for 1.5 hrs at 125 rpm. Aliquots were removed and diluted 10⁻¹ to 10⁻⁶ in 2XYT in triplicate for each library, and 5 ul×3 of each dilution was spotted on LB/12.5 μg/ml tetracycline/100 μg/ml carbenicillin and LB/100 μg/ml carbenicillin/70 μg/ml kanamycin plates. The remainder of each culture was added to 900 ml 2XYT with a final concentration of 50 μg/ml carbenicillin in a 2L baffled flask, and incubated at 37° C., 250 rpm, for 1 hour. Then kanamycin was added to a final concentration of 70 μg/ml and the samples were incubated at 37° C., 250 rpm, for 18 hours. The cultures were transferred to sterile 1 L centrifuge bottles and spun at 4° C., 400 rpm, for 30 minutes, before filtering the supernatant into a large PES 0.2 μm filter unit and storing the filtered supernatant at 4° C. Finally, the phage particles were concentrated by polyethylene glycol (PEG) precipitation, and each library was resuspended in 2XYT/15% glycerol, and stored at −80° C. until ready for use.

### Example 6

### Mapping NRSF-NRSE DNA Interactions by Targeted Re-Engineering of DNA Binding Specificity

A targeted genetic approach was used to confirm the register and positioning of NRSF fingers 3 through 8 on the NRSE predicted by the NRSF-NRSE interaction model described in Example 3. In this approach, a clustered double mutation was introduced into the NRSE and then residues in the recognition helix of the finger predicted by the model to interact with the mutated bases were randomized. If the model is correct it should be possible to isolate NRSF variants from the randomized library that bind specifically to the mutated NRSE and not to the original consensus NRSE. In genetic terms, such an altered DNA binding specificity NRSF variant would be similar to an “allele-specific” suppressor of the mutation(s) in the NRSE. The successful isolation of this type of NRSF variant would provide strong genetic confirmation of the interaction(s) predicted by the model. Alternatively, if the model is inaccurate in its predictions, then for a given mutation in the NRSE it should not be possible to isolate such variant NRSF suppressors.

In a preliminary test of this approach, two different clustered double mutations were introduced into the consensus NRSE targeting bases predicted to be bound by NRSF finger 4 or finger 5. Two different B2H selection strains were then constructed, each harboring one of these mutated NRSE sites as the target DNA sequence. Two randomized libraries were also constructed, both based on the GP-NRSF1-8 protein. In each library, 6 residues in the recognition helix of one NRSF finger (finger 4 or finger 5) were randomized. The 6 residues randomized, positions −1, 1, 2, 3, 5, and 6 numbered relative to the helix start, are all positions that can potentially contribute to DNA binding. Cassette mutagenesis was used to construct the libraries and the codon scheme used allowed 16 possible amino acids (all except the aromatics and cysteine) encoded by 24 codons. The theoretical size of these libraries is 24⁶ or approximately 2×10⁸ possible members. Each of the actual libraries we constructed had greater than 10⁹ independent members (a 5-fold over-sampling of the theoretical library size).

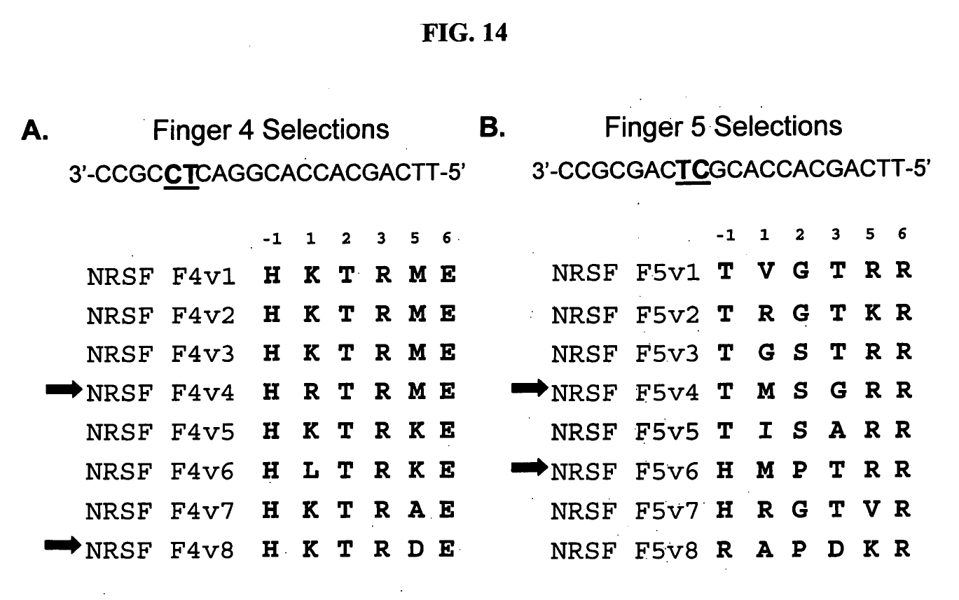

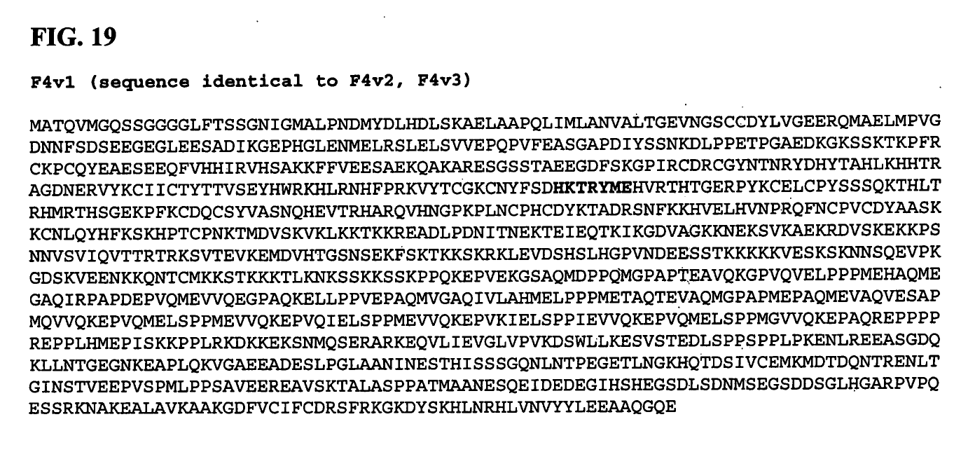

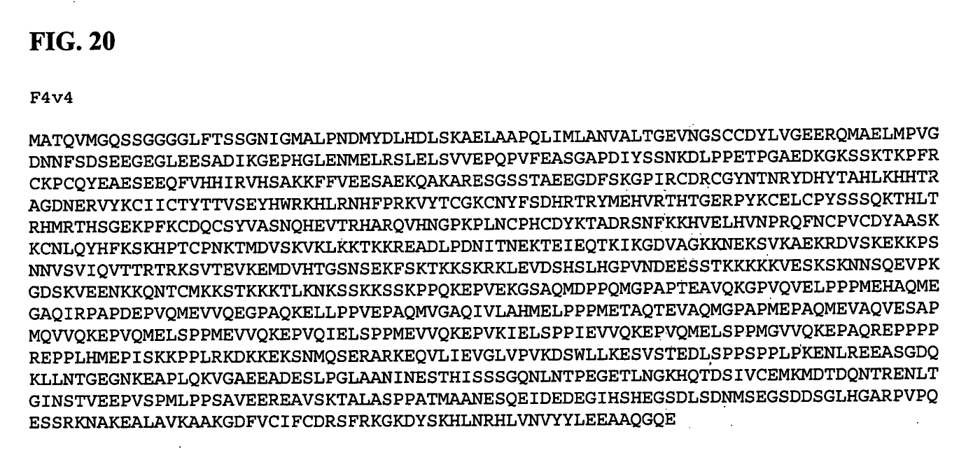

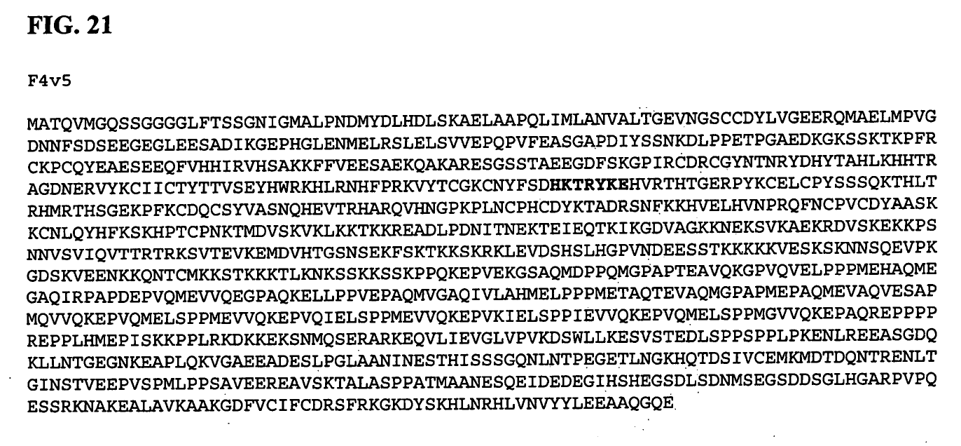

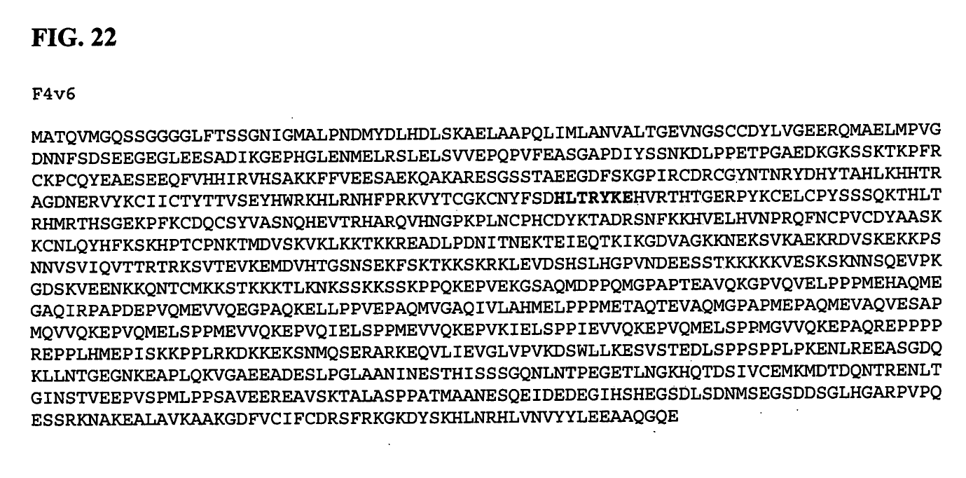

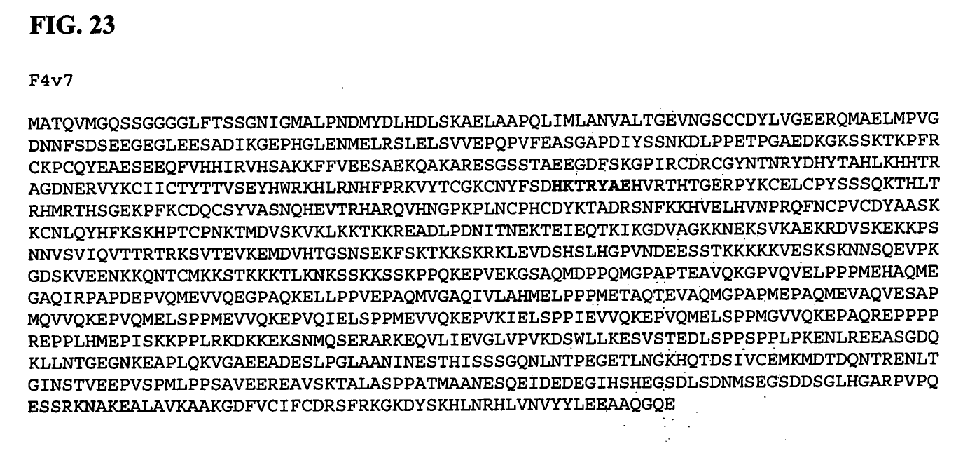

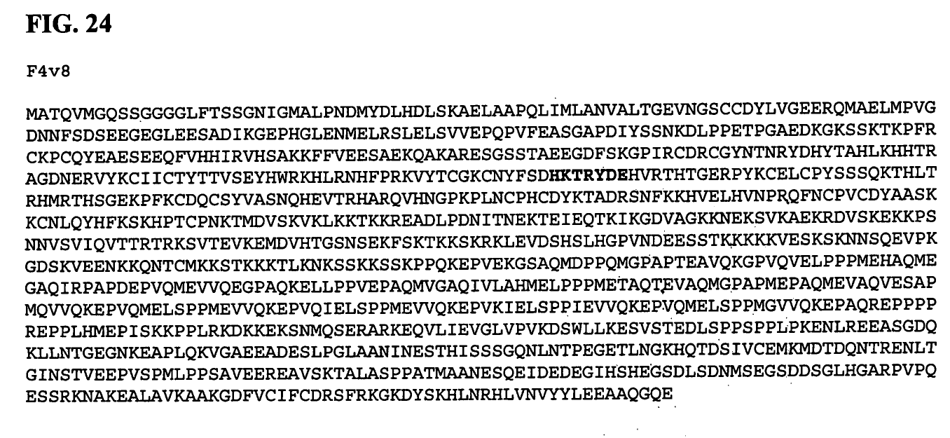

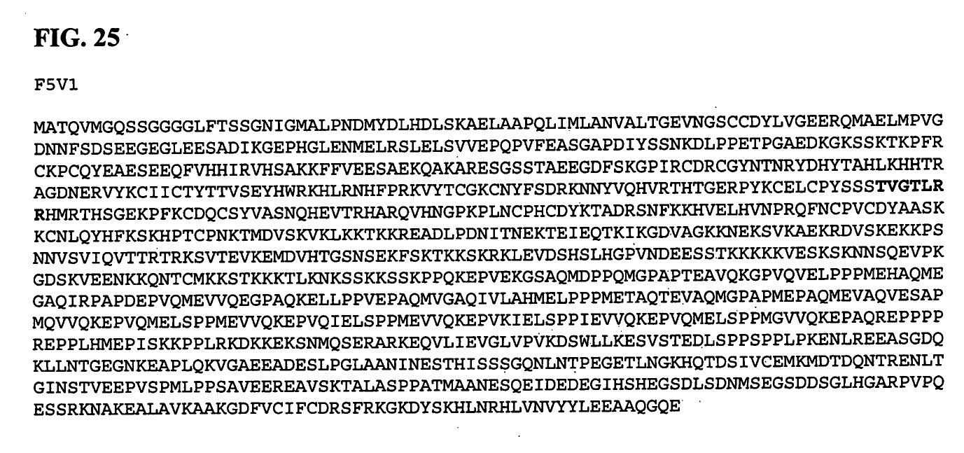

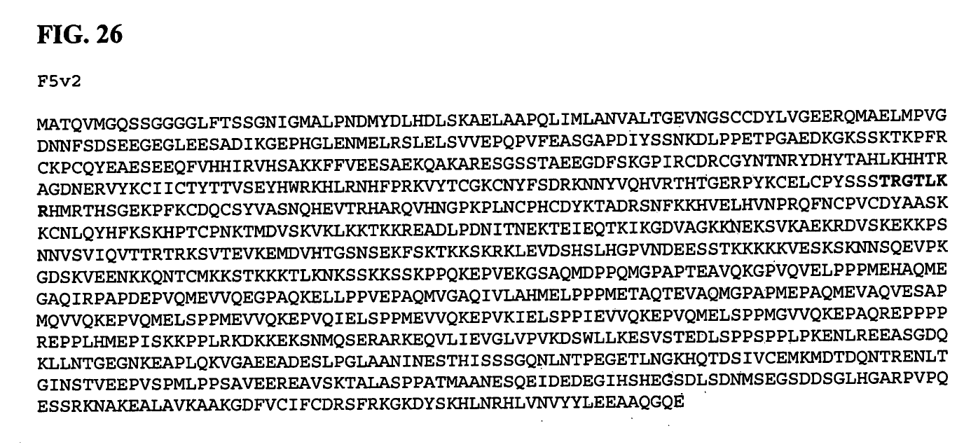

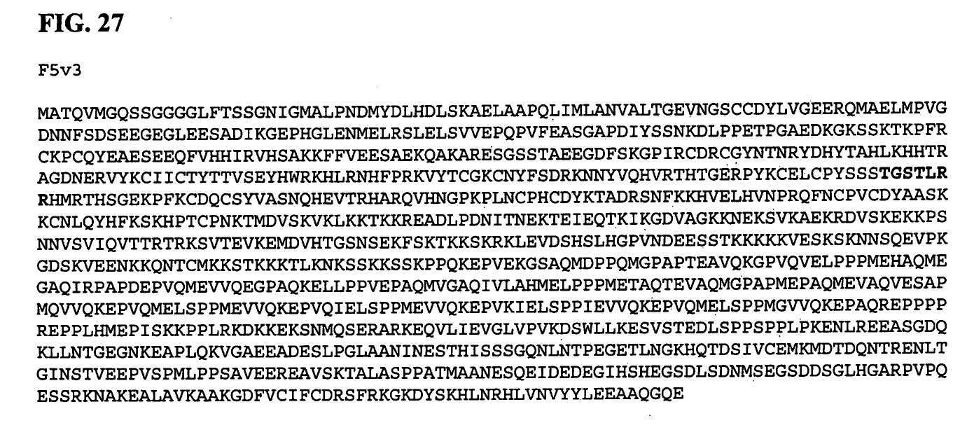

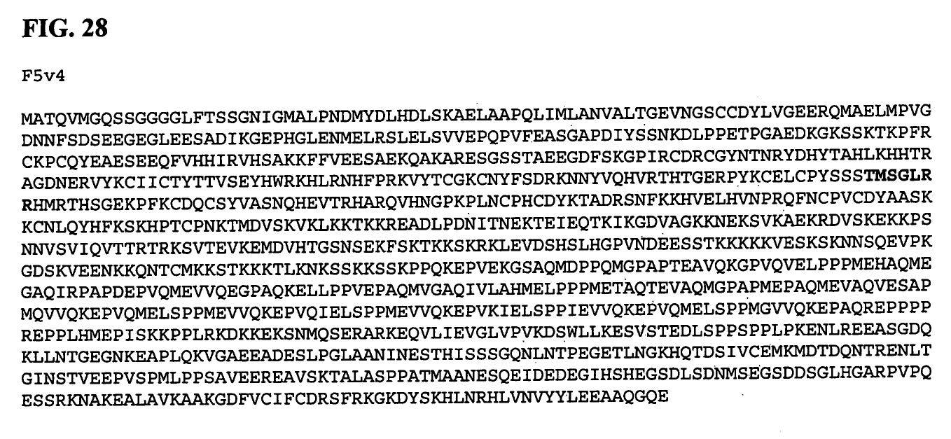

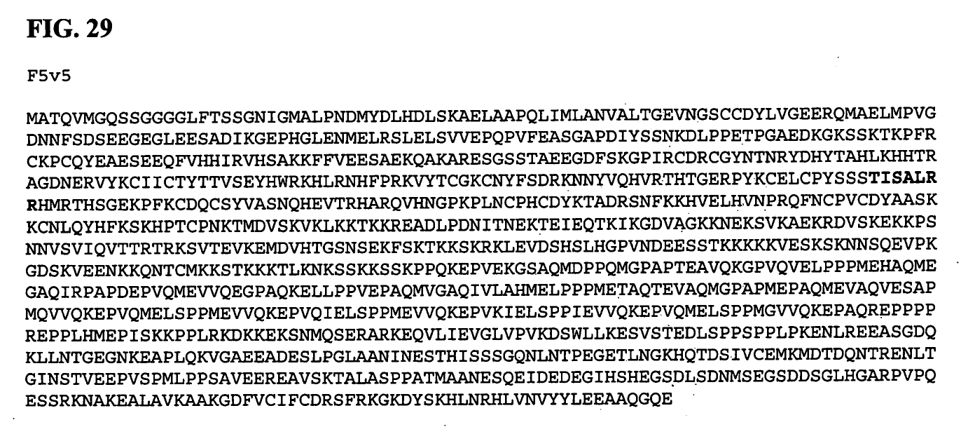

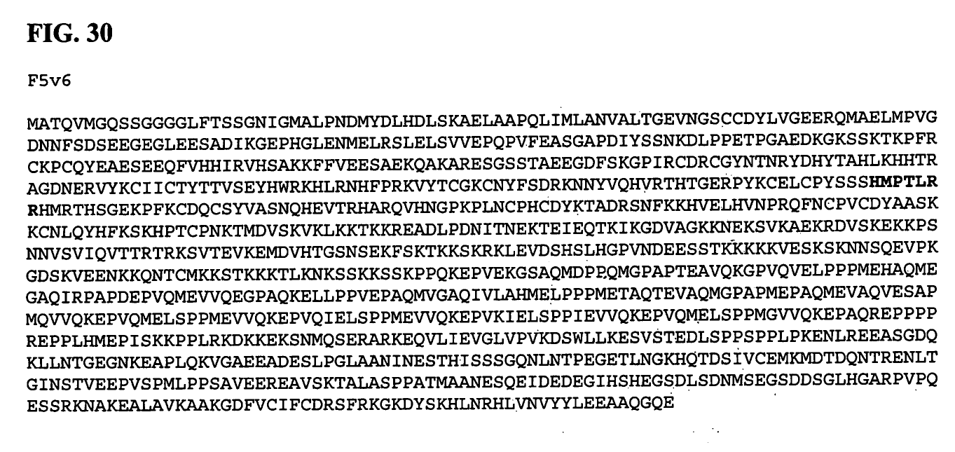

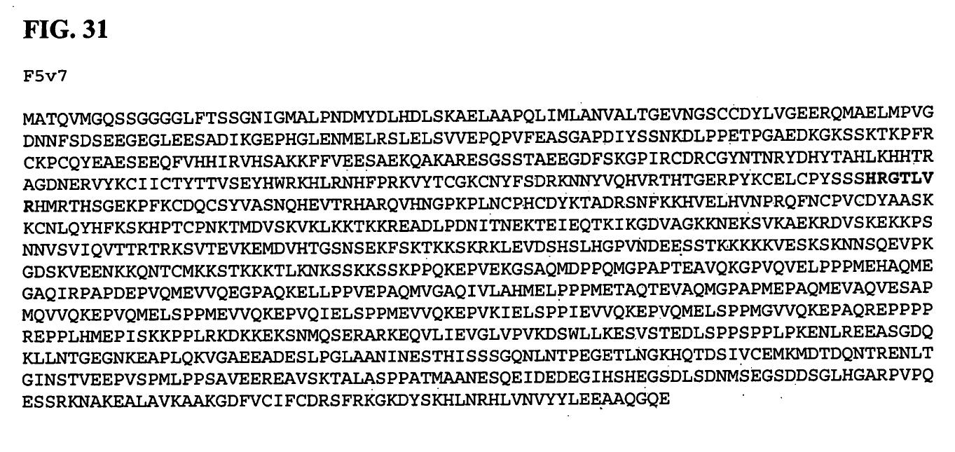

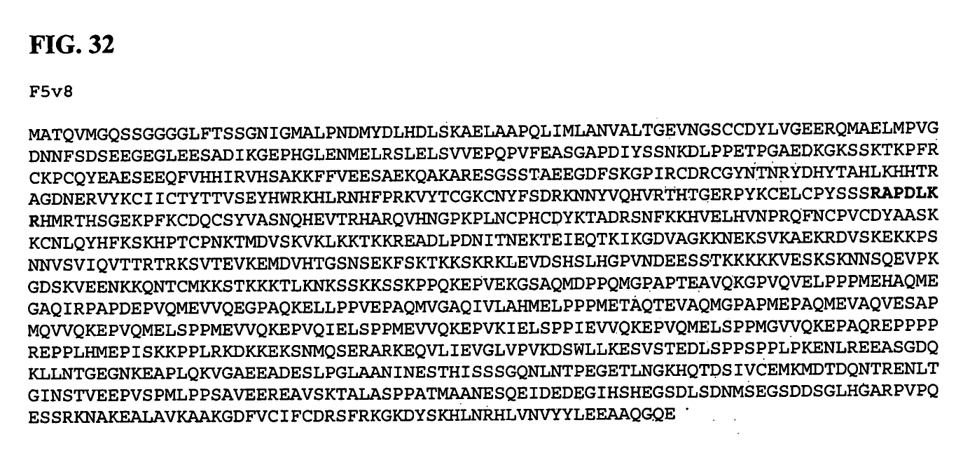

To perform selections using the bacterial 2-hybrid system, plasmids encoding members of the randomized NRSF finger 4 or finger 5 libraries were introduced into their appropriately matched selection strain (see Materials and Methods of previous Examples). In both of these selection strains, binding of a variant GP-NRSF1-8 fusion protein to the mutant NRSE should trigger transcriptional activation of the selectable HIS3 and aadA genes. These transformed cells were then plated on medium that selects for the activated expression of both the HIS3 and aadA genes. For both selection experiments, colonies were obtained on the selective medium plates and then isolated and sequenced. For both selections, the variants we isolated were all very similar in their recognition helix sequences demonstrating the success of the selection in identifying variants with a common function. As shown in FIG. 14A, the recognition helices of the NRSF finger 4 variants are all very similar to one another and together define a single consensus sequence with completely conserved residues at positions −1, 2, 3, and 6. FIGS. 19-32 show the full sequences of the selected NRSF-variants illustrated in FIG. 14. Note that finger 4 variants 1, 2, and 3 (F4v1, F4v2, F4v3) have identical sequences as shown in FIGS. 14 and 19. The recognition helices of the NRSF finger 5 variants appear to define at least 2 different consensus sequences and again within each sub-group strong conservation of residues at positions −1, 2, 3, and 6 is seen (FIG. 14B). It is interesting to note that the model predicts that the arginine at position 6 of finger 5 in the wild-type NRSF protein contacts the guanine located at base position 12 of the NRSE (see FIG. 12). This guanine remains unchanged in the mutated NRSE site used to select the finger 5 variants and the arginine at position 6 is strongly re-selected in the finger 5 variants. This result is consistent with the idea that this arginine contacts the guanine at position 12 of the NRSE, providing further support for the model presented in Example 3.

### Example 7

### Re-Engineered NRSF Variants are True Altered DNA Binding Specificity Mutants

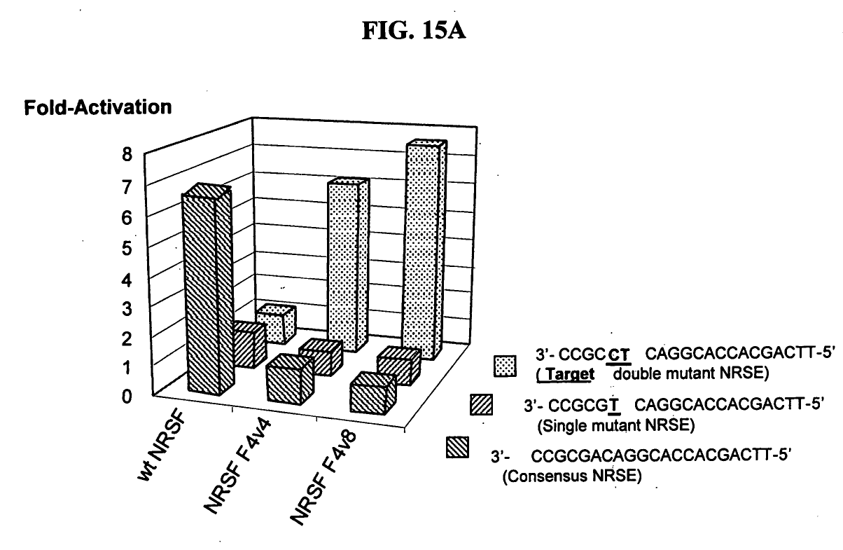

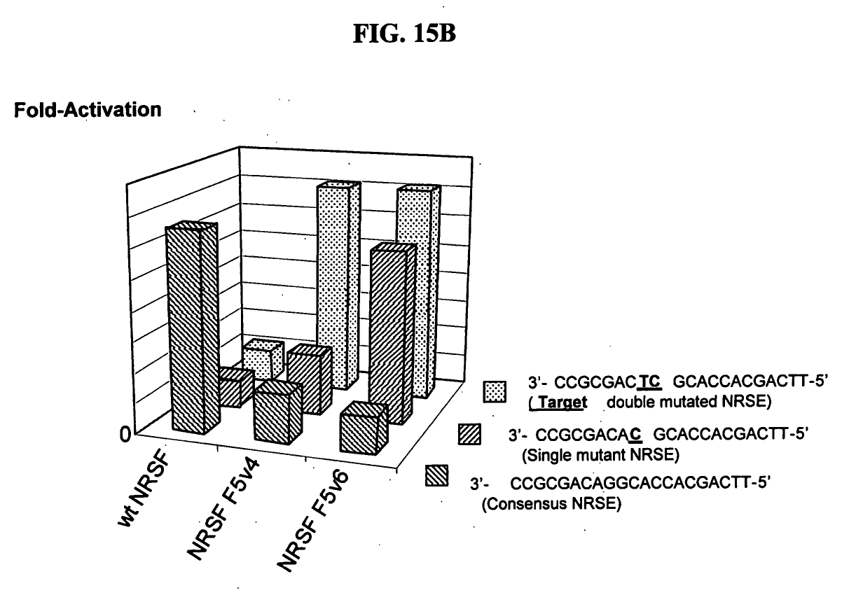

To confirm that the NRSF variants are truly altered (as opposed to just relaxed) in their DNA binding specificity, these proteins were tested to see how well they bind to the mutant NRSE they were selected to recognize, and to the original consensus NRSE. To perform these tests, B2H reporter strains were constructed harboring the NRSE to be tested positioned upstream of a weak test promoter that controls expression of the lacZ gene. Two representative candidates from each selection (indicated by blue arrows in FIGS. 14A and 14B), and wild-type NRSF1-8 were introduced into each reporter strain, and β-galactosidase assays were performed, as described in Example 4. The results (shown in FIGS. 15A and 15B) reveal that variants tested from the F4 and F5 selections bind to their appropriate target mutant NRSE but fail to bind to the original wild-type NRSE sequence demonstrating that they are true altered DNA binding specificity mutants. Thus, residues in NRSF finger 4 interact with base positions 16 and 17 in the NRSE and residues in NRSF finger 5 interact with base positions 13 and 14 (and possibly 12) in the NRSE. This genetic result provides the first detailed information regarding the position of NRSF fingers as they engage the NRSE.

A further aim was to determine whether the altered DNA binding specificity mutants of NRSF possessed the same specificity as the original wild-type NRSF protein. A particular aim was to determine whether a single base change in the mutant NRSE would abolish binding by a re-engineered variant. To test this possibility, additional mutant NRSE sequences were generated that each differed by one base from the double mutant NRSEs used to select the NRSF finger 4 and finger 5 variants. (Because the mutant NRSEs used in the selections differ from the consensus NRSE by 2 base changes, these newer mutant NRSEs also each differ from the consensus NRSE by a single base change.). B2H reporter strains were constructed harboring these new mutant NRSEs and the ability of the wild-type NRSF and the selected variants to activate transcription was assessed. The β-galactosidase results shown in FIGS. 15A and 15B demonstrate that most of the altered DNA binding specificity NRSF variants tested possess the specificity of the original protein i.e. changing just one of the mutated bases in the NRSE abolishes binding by the variant. This result is not entirely unexpected as the bacterial 2-hybrid system selects for proteins that bind with both high affinity and specificity to their target DNA sequences.

### Example 8

### Targeted Re-Engineering of DNA Binding Specificity of NRSF Fingers 6, 7 and 8

Example 5 above describes how a targeted genetic approach was used to alter the DNA binding specificity of NRSF fingers 4 and 5. Example 6 shows that these re-engineered NRSF variants have truly altered DNA binding specificity, as opposed to having just relaxed DNA binding. The present Example extends this approach to fingers 6, 7 and 8 of NRSF.

As described in Example 5, this approach involved first introducing various mutations into the NRSE. In this case, different point mutations were introduced into bases in the consensus NRSE predicted to be bound by NRSF finger 6, 7 or 8. Different B2H selection strains were then constructed, each harboring one of the mutated NRSE sites as the target DNA sequence. Randomized libraries were then constructed based on the GP-NRSF1-8 protein. Libraries RF6, RF7, and RF8 had amino acids in NRSF fingers 6, 7 and 8 randomized, respectively. In each of these libraries, 6 residues in the recognition helix of one NRSF finger (finger 6, 7 or 8) were randomized. The 6 residues randomized, positions −1, 1, 2, 3, 5, and 6 numbered relative to the helix start, are all positions that can potentially contribute to DNA binding. Cassette mutagenesis was used to construct the libraries and the codon scheme used to construct the finger 7 library allowed 16 possible amino acids (all except the aromatics and cysteine) encoded by 24 codons. The codon scheme used to construct the finger 6 and finger 8 libraries permitted 19 possible amino acids (all except cysteine) encoded by 24 codons. The theoretical size of these libraries is 24⁶ or approximately 2×10⁸ possible members. Each of the actual libraries constructed had greater than 10⁹ independent members (a 5-fold over-sampling of the theoretical library size).

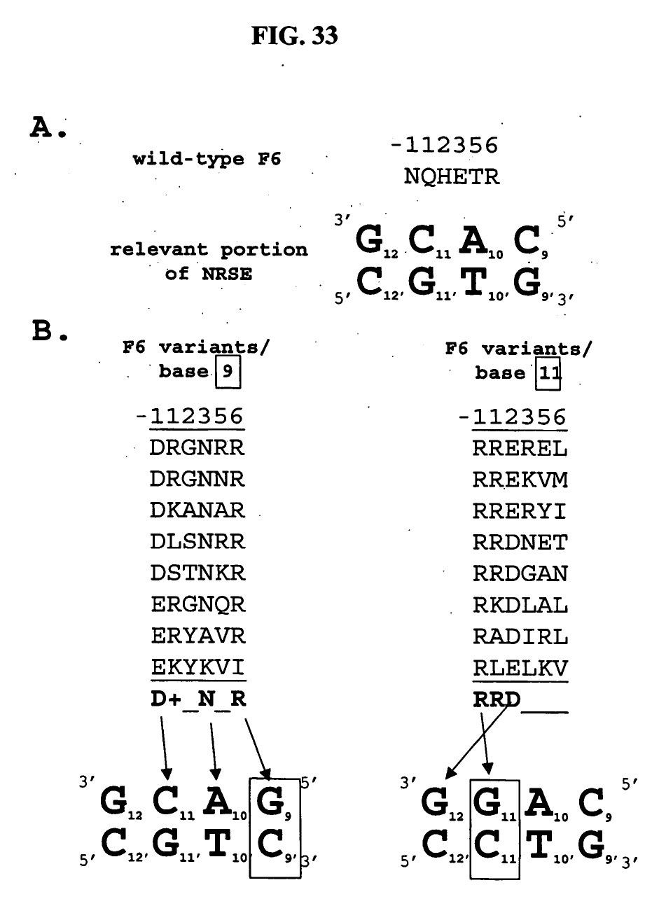

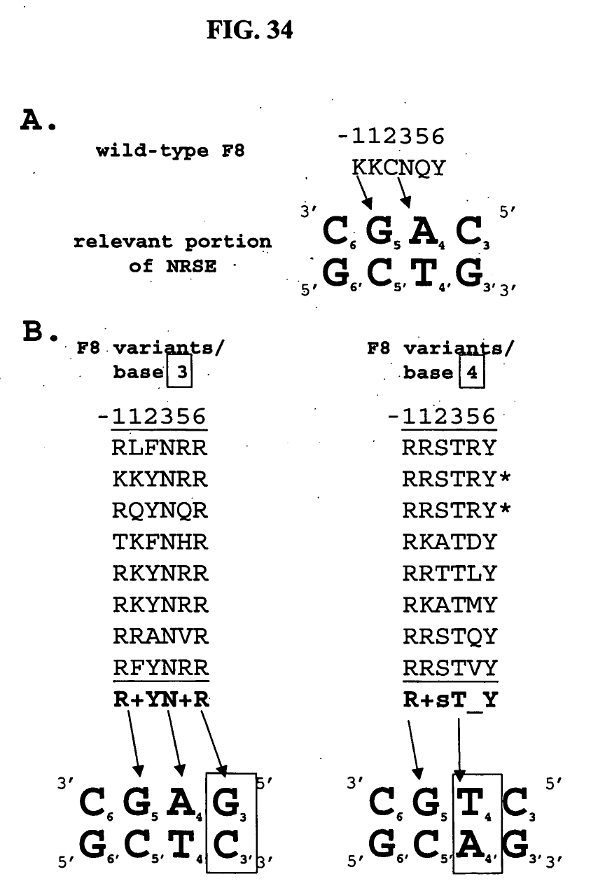

To perform selections using the bacterial 2-hybrid system, plasmids encoding members of the randomized RF6, RF7, and RF8 libraries were introduced into their appropriately matched selection strains (see Materials and Methods of previous Examples). In each selection strain, binding of a re-engineered variant GP-NRSF1-8 fusion protein to a mutant NRSE should trigger transcriptional activation of the selectable HIS3 and aadA genes. The transformed cells were plated on medium that selects for the activated expression of both the HIS3 and aadA genes. Surviving colonies able to grow on selective medium plates were isolated and sequenced. The recognition helix sequences of eight candidates are shown with their respective binding sites in FIG. 33 b (finger 6) and FIG. 34 b (finger. 8). Note that each set of sequences defines a consensus sequence (shown in bold text at the bottom of the finger sequences) suggesting that the selections were successful. In addition, one can postulate very likely contacts (based on our existing understanding of zinc finger recognition) between amino acids found at positions −1, 2, 3, or 6 of the consensus recognition helices and specific base positions in the mutated NRSE (indicated with arrows in FIGS. 33 b and 34 b).

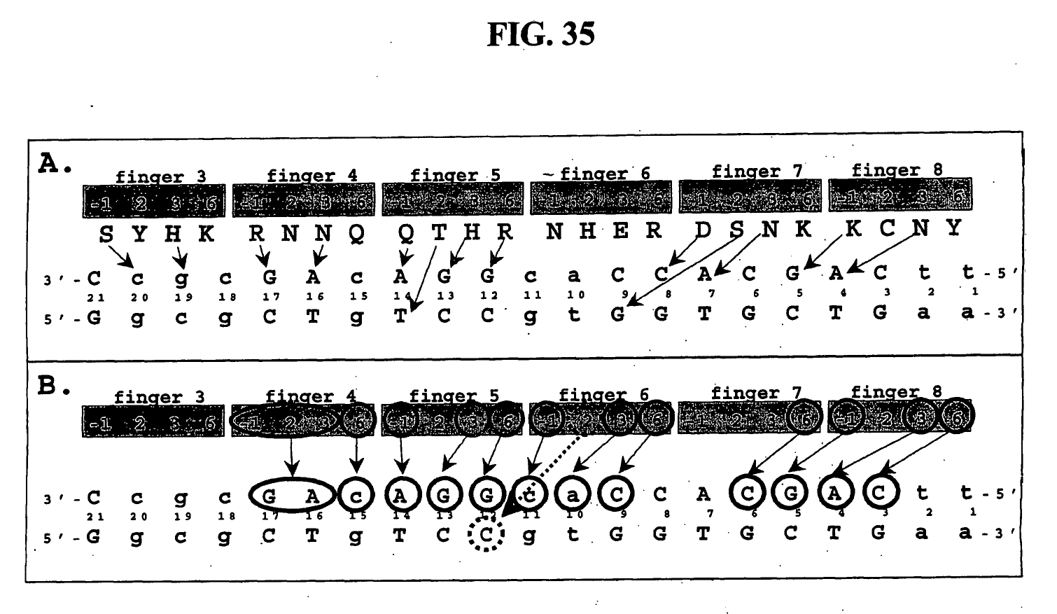

Comparisons of the amino acid sequences and DNA binding specificities of wild-type and variant NRSF fingers combined with our existing understanding of zinc finger-DNA interactions, allow us to infer likely contacts between specific amino acid positions in NRSF recognition helices with particular base positions in the NRSE. For example, wild-type NRSF finger 8 recognizes the sequence ^{3′}GAC^{5′} with residues KNY (at the −1, 3, and 6 recognition helix positions, respectively; see FIG. 34 a) whereas one of the variants selected to bind the base 3 mutant NRSE sequence ^{3′}GAG^{5′} has the residues KNR suggesting that recognition helix position 6 in finger 8 recognizes base 3 in the NRSE. This type of arginine to guanine contact is commonly found in a number of other previously described zinc finger DNA interfaces. All of the potential NRSF-NRSE interactions deduced from NRSF finger 4, 5, 6, 7, and 8 variants isolated to date are summarized in FIG. 35 b, including a contact between NRSF finger 7 and the NRSE based on preliminary data (not shown). For comparison, FIG. 35 a provides the original predicted model of the NRSF-NRSE interaction.

In conclusion, the present Example, in conjunction with Examples 5 and 6, shows that the DNA binding specificities of NSRF fingers 4, 5, 6, 7, and 8, can be altered successfully, thus underscoring the utility of the methods of the present invention.

### Example 9

### Selection and Characterization of NRSF Variants with Re-Engineered DNA Binding Specificities

Artificial transcription factors composed of 3 to 6 synthetic Zfs fused to a transcriptional regulatory domain have been shown to function in mammalian cells to alter expression of endogenous target genes. However, because there appears to be a limit to the number of fingers that can simultaneously bind to DNA, the true specificity of these proteins remains unclear. Many of them may not specify significantly more than the 10 base pairs that can be bound by a 3-finger unit. Any given 10 base pair sequence will occur approximately 3000 times just by chance in the human genome. Thus, to affect the expression of only a single gene in a mammalian cell, it will very likely be necessary to design proteins capable of targeting sequences longer than 10 base pairs. The usefulness of Zf proteins for applications in biological research and gene therapy will be substantially enhanced by being able to make proteins that have specificity for a single address in the genome.

The NRSF protein exhibits a number of characteristics that make it an attractive framework upon which to design synthetic Zf proteins capable of recognizing DNA sequences significantly greater than 10 base pairs in length. Specifically, 1) NRSF recognizes an extended DNA sequence that is at least 20 base pairs in length, 2) NRSF binds with high specificity to its target DNA sequence, and 3) individual fingers in the NRSF DNA binding domain can be re-engineered to recognize new alternative DNA sequences.

The methods of the present invention can be used to create NRSF variants that recognize novel target sequences approximately 18-21 base pairs in length. The affinities and specificities of these variants can be determined in vitro and their abilities to regulate the expression of an endogenous mammalian gene containing the extended target sequence can then be tested.

To create NRSF variants with novel DNA binding specificities, the CSPO Zf selection strategy is employed. This strategy (illustrated in FIG. 16) involves 2 stages of selection that are both performed using the bacterial 2-hybrid system: In the first stage, separate low stringency selections are performed in parallel using different libraries in which one of the finger recognition helices is randomized. To perform these low stringency selections libraries are introduced into appropriately engineered B2H selection strains bearing the target subsite of interest and the transformed cells are plated on selective medium. Plasmids encoding NRSF variants that confer the ability to survive on histidine-deficient medium containing 50 μM IPTG, 10 mM 3-AT and 20 μg/ml streptomycin are isolated and sequenced. These low stringency selections yield pools of NRSF-bases proteins which are then amplified and recombined together to form a secondary library. Recombination is performed using PCR-mediated fusion of DNA fragments encoding individual finger units that preserve the positions of the fingers identified in the primary selections. For each library, approximately 35 selected (but unsequenced) recognition helices for each finger position are first amplified using finger position-specific primers and then randomly fused together and amplified to create a pool of DNA molecules encoding “shuffled” NRSF-based proteins. These molecules are then cloned into an appropriate plasmid for expression as a Gal11P-fusion protein. Each library created using this method typically contains >10⁸ independently derived members.

In the second stage, stringent selections are then performed using this recombined library to identify optimized multi-finger proteins that bind to the final target DNA sequence of interest. The secondary library is introduced into the appropriate B2H selection strain bearing the full target sequence of interest and the transformants are plated on a series of histidine-deficient selective medium plates containing various concentrations of IPTG, 3-AT, and streptomycin. Candidates chosen for sequencing and subsequent analysis are picked from the most stringent selection conditions that permit growth.

This approach is somewhat analogous to the affinity maturation process used by the immune system to optimize antibodies. Initial low stringency selections identify fingers with any reasonable affinity for the DNA targets and then the secondary higher stringency selection identifies fingers that work well together to recognize the target sequence with high affinity and specificity. This method has successfully been used to isolate three different synthetic 3-finger proteins that bind with excellent affinity and specificity for their intended DNA target sequences. This strategy can also be extended to the selection of proteins with 4 or more fingers simply by increasing the number of parallel low stringency selections performed in the first stage of the procedure. This method is used herein to re-engineer the specificity of the NRSF Zf domain using 6 separate finger selections in the primary selections.

The choice of sequences selected as targets for designer Zf proteins is influenced by the details of the NRSF-NRSE interface. In the present example a “framework” sequence, a partially degenerate version of the 21 base pair consensus NRSE (e.g.—^{5′}NNNNN(C/G)NNCNNGNNCNNCNNN^{3′} SEQ ID NO. 13) that limits the possible target used. Any potential target sequence that matches this framework sequence can be used. The fixed, non-degenerate bases in this framework sequence are those that are likely to be contacted by recognition helix residues from more than one finger at the NRSF-NRSE interface. This limitation stems from the fact that alteration of one of these “finger overlap” bases might require randomization of more than one finger to recognize a new base at that position and the CSPO selection strategy utilizes libraries in which recognition helix positions from only a single finger are randomized (a restriction imposed by combinatorial issues). In addition, without being bound by theory, it can be desirable to fix the bases at certain positions in the framework sequence if specificity of the NRSF protein simply can not be altered at some positions. Initial results suggest that at least 8 bases recognized by 4 fingers can be altered. In this Example, two potential target sequences in the human VEGF-A and erbB2 genes are used in selections to identify NRSF-based variants that recognize each of these 2 target sites.

In the first stage of the re-engineering procedure, 6 low stringency selections are performed in parallel—one for each of the 6 fingers in the final protein. Six randomized libraries based on the Gal11P-NRSF1-8 hybrid protein are produced, one for each of the 6 fingers (fingers 3 through 8) that contact the NRSE sequence. Bases contacted by a given finger are altered in a NRSE and this variant used to construct a B2H selection strain. Selections are performed using this selection strain and the appropriately matched randomized library. Selections will be performed for each of the 6 subsites located within a larger target sequence. For each selection approximately 20 candidates are sequenced.

To perform the second stage of selection, secondary libraries of NRSF variants consisting of “shuffled” combinations of the fingers selected in the initial selections are assembled. These libraries are constructed using a PCR-based in vitro recombination protocol which ensures that fingers selected at a given position remain in the same position in the reassembled protein (e.g.—fingers selected at the F4 position all occupy the F4 position in the recombined library). Each secondary library is constructed from approximately 35 different fingers selected at each of the 6 DNA binding finger positions and thus have a theoretical complexity of 356 or approximately 2×10⁹ proteins. To ensure oversampling of this sequence space, secondary libraries are constructed consisting of at least 10¹⁰ members (a library size that can reasonably be attained in E. coli). “Shuffled” libraries are constructed in the context of a Gal11P—NRSF1-8 hybrid protein (i.e. all proteins will also contain wild-type NRSF fingers 1 and 2). The bacterial 2-hybrid system is used to perform high stringency selections to identify candidates from the secondary libraries that bind to the desired target sequences.

For each target sequence, at least 12 independent NRSF variants that survive the selection process are sequenced and characterized. To quantify the capability of these proteins to activate transcription in the bacterial 2-hybrid system, the 12 candidates from each selection are introduced into B2H reporter strains bearing the appropriate extended target sequence. Expression of lacZ in these strains is quantified by performing β-galactosidase assays.

### Example 10

### In Vitro Characterization of Selected NRSF-Based Proteins

The affinity and specificity of our selected NRSF variants for their extended target sequences is characterized biochemically. For each of the 2 target sequences, at least 3 different NRSF variants are expressed and purified using standard protocols. Using electrophoretic mobility shift assays, the dissociation constant and specificity ratio of each protein for its specific target DNA sequence is determined (see Methods described in Example 4). NRSF variants that bind with a variety of specificities to their intended target sequence are identified. In particular, proteins that bind with comparable affinities to the same target site but exhibit differing specificities for that sequence are identified. Proteins exhibiting these differential properties are chosen for the next stage of analysis to assess the importance of specificity (as determined in vitro) on the functional specificity of these synthetic Zf domains in mammalian cells.

### Example 11

### Evaluating the Functional Activity and Specificity of NRSF-Based Proteins in Mammalian Cells

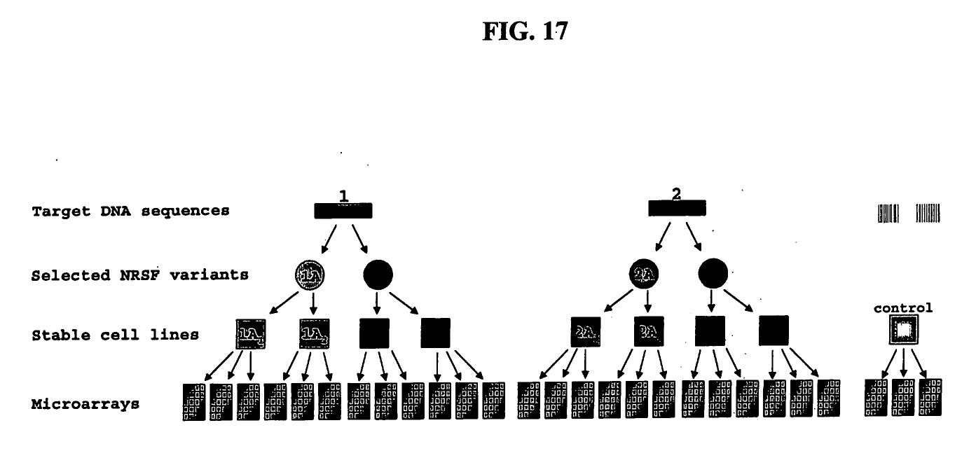

The function of re-engineered NRSF variants is examined in mammalian cells. Proteins with greater specificity for their target should have improved cellular function in at least 2 ways: 1) these proteins bind fewer “unintended” target sequences and therefore affect the expression of fewer non-target genes, and 2) these proteins will require lower levels of expression to bind to their intended target sequence because they do not become “diverted” to non-target DNA sequences (i.e. the concentration of protein in the cell that is free to bind the target site will be higher). NRSF variants are converted into synthetic transcription factors and their effects on gene expression both at the intended target gene (using quantitative RT-PCR) and globally on all other genes (using microarray expression profiling) are assessed. A diagram summarizing this set of experiments is depicted in FIG. 17.

For each of the two extended target DNA sequences, 2 NRSF variants selected in the previous step are tested. Ideally, these two variants have approximately equivalent affinities but different specificities for their target sequence. The experiments described involve activating expression of the endogenous human VEGF-A gene, however, the protocol can be modified to target other genes for either activation or repression. To create artificial transcriptional activator proteins, a mammalian expression plasmid (based on plasmid pcDNA5, Invitrogen) in which a hybrid protein consisting of our variant NRSF Zf domains (fingers 1-8) fused to the p65 activation domain is under the control of a strong CMV promoter that can be regulated by tetracycline repressor is constructed. This hybrid protein also includes an amino-terminal SV40 nuclear localization signal and a FLAG epitope tag on the carboxyl-terminal end (a similar fusion has been previously described for synthetic 3-finger proteins). In mammalian cells engineered to express tetracycline repressor, the CMV promoter on these expression plasmids is repressed and fusion protein is produced at low levels. Addition of a tetracycline analog such a doxycycline to the medium inactivates the DNA binding capability of tetracycline repressor and thereby leads to induction of fusion protein expression. This regulated (Tet-ON) system allows fusion protein expression to be controlled by adding doxycycline to the medium.

A series of stable cell lines each expressing a synthetic activator protein based on a different NRSF variant are created. Each of these lines is generated by transfecting human embryonic kidney cells that stably express tetracycline repressor (TRex 293 cells, Invitrogen) with linearized plasmid encoding the artificial activator fusion protein and selecting for stable integrants that are resistant to hygromycin B (resistance to this antibiotic is encoded on the pcDNA5 expression plasmid). TRex 293 cells are used because they express low levels of VEGF-A. For each synthetic activator protein, at least 10 independent stably integrated cell lines are isolated.

To assess the abilities of the NRSF variant activators to stimulate transcription of the VEGF-A gene, quantitative RT-PCR is utilized. Stable cell lines expressing the artificial activators and a control cell line with a stably integrated pcDNA5 plasmid that does not express any activator protein is grown in the presence of doxycycline (at a concentration [1 μg/mL] that will fully induce protein expression). Total RNA is isolated from each line (RNeasy, QIAgen) and used as template for first strand DNA synthesis. Quantitative RT-PCR reactions are then performed using, for example, Taqman chemistry and an ABI 7900HT Sequence Detection System machine. The amount of template in the reactions is normalized using expression of the GAPDH gene as a control. Primers and detection probes for the VEGF-A and control GAPDH genes are used. The fold-activation of a target gene by a given NRSF variant activator can be determined by comparing the transcript levels in cells expressing the synthetic activator with levels in the control cells that do not express any activator. Typically for any given synthetic activator, the 10 stable cell lines isolated that express that protein will activate the VEGF-A gene to various levels (due to variable levels of activator expression secondary to position-dependent effects). For each target sequence, four stable cell lines (2 cell lines for each synthetic activator targeted to that sequence) are chosen that activate VEGF-A to approximately the same level for subsequent microarray analysis.

To assess the functional specificity of the NRSF variant activators, i.e. their effects on the levels of non-target genes, global expression profiles of the stably transfected mammalian cell lines can be obtained using Affymetrix GeneChip technology. To obtain RNA samples for this DNA microarray analysis, all cell lines—including the sample lines which stably express variant NRSF activators under doxycycline control, and the global control cell line (the parent T-REx 293 line which does not express an activator) are grown in triplicate in medium containing doxycycline for 30 hours. RNA samples from each culture will be extracted (RNeasy kit, QIAgen), quantitated by UV spectrophotometry, and screened for gross degradation via agarose gel electrophoresis. Samples then undergo additional RNA analysis, biotinylated cRNA probe synthesis, probe hybridization to the Affymetrix human U-133A GeneChip, staining, and laser confocal scanning. Primary gene expression data (i.e., raw data) is extracted from the scanned images of the U-133A chips by Affymetrix Microarray Suite software. The U-133A GeneChip contains over 22,000 probe sets representing a substantial majority of human genes referenced in Build 133 of the UniGene database. Thus, it provides an efficient surrogate for the entire human genome for assessing and comparing the functional specificity of the designer Zf proteins.

As noted above, to obtain data sets suitable for statistical analysis, for each of the 8 stable cell lines RNA is isolated from 3 independent cultures and microarray analysis can be performed on each sample. A normalized expression measurement for each gene on each array is extracted from the raw data by means of the current best available algorithm. In the experiment, referenced below, the RMA algorithm implemented in the Affymetrix package of Bioconductor, an open source bioinformatics tool set for use in the R statistical programming environment, was used. The effect of the synthetic activators on expression levels of each gene is inferred from fold-activation (or fold-repression) of the gene, calculated as the appropriately transformed ratio of expression levels in the “sample” cell line to levels in the “control” cell line. Statistical significance of expression fold-change for each gene is determined using the CyberT software which implements a Bayesian probabilistic approach to address the problems of high inherent noise, variability which scales with expression level, and limited replicate numbers characteristic of microarray data.

From this analysis of our global expression data, a list of all genes whose expression is significantly altered at the level of transcription by the presence of a given synthetic activator is obtained. Genes in this list have their expression altered by different mechanisms and can be categorized into five groups: 1) genes that harbor an exact match of the target DNA sequence in their promoter, 2) genes that harbor a sequence similar to the target DNA sequence in their promoter, 3) genes whose expression is altered by the recombination event required to stably integrate the synthetic activator expression vector, 4) genes affected by the altered expression of genes in the previous 3 groups (indirect or downstream effects), and 5) genes whose expression is affected by the altered expression of VEGF-A. To assess how specifically the NRSF variants bind in a mammalian cell, it is desirable to identify the genes that fall into categories 1) and 2). Genes in category 3) are identified by comparing the genes affected in the two independent stable cell lines created for each synthetic activator—these genes should only be affected in one of the two cell lines. The number of genes affected by the activation of VEGF-A expression (category 5) is minimal since VEGF-A is a secreted protein. However, genes in category 5) can also be identified by comparing the results of the experiments that use proteins to target different DNA sequences in the VEGF-A gene—genes affected by synthetic activators targeted to different sequences are likely to be those affected by upregulation of VEGF-A. One method for attempting to separate the genes in categories 1) and 2) from those in category 3) is to search the promoters of regulated genes for exact or partial matches to the target sequence. This method, though imperfect, helps to reduce the confounding effects introduced by genes in category 3). Such an analysis has been performed. In an experiment with a 3-finger protein, activated genes are enriched for near matches to the target sequence compared with genes whose expression is unaffected or repressed. In addition, chromatin immunoprecipitations with antibody against the Zf activator can be performed to directly verify binding to particular promoters.

With the narrowed list of affected genes obtained, a simple measure of “functional specificity” can be calculated: the reciprocal of the total number of genes with statistically significant alterations in expression level (reciprocal, so that perfect functional specificity—characterizing a transactivator that effects only its target gene and no other—equals 1, and higher/closer to one implies better specificity than lower/closer to zero). Functional specificity should correlate with specificity as determined in vitro. These experiments provide a measure of how functionally specific the NRSF-derived synthetic activators are in their effects in mammalian cells.

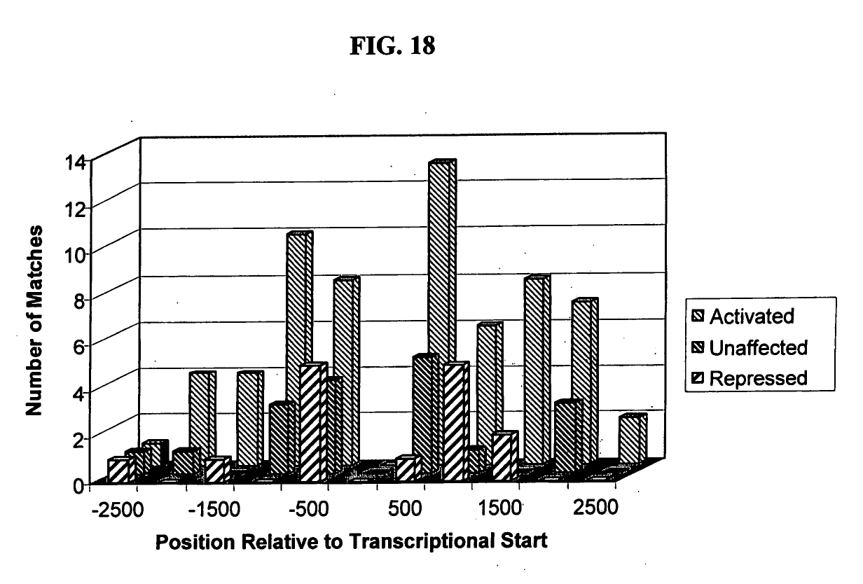

The non-naturally occurring activators constructed from NRSF variants that bind to extend DNA sequences with high specificity should have much greater functional specificity in mammalian cells than analagous activators constructed from 3-finger proteins. Not surprisingly, synthetic 3-finger activator proteins can directly affect the expression of dozens of non-target genes in mammalian cells. This was seen using a TRex 293 cell line which stably expresses a previously described synthetic activator consisting of the p65 activation domain fused to a 3-zinc-finger DNA binding domain (termed VZ-573) designed to bind a sequence located 573 bp upstream of the endogenous VEGF-A transcriptional start site. Expression of the synthetic activator was controlled by a tetracycline-inducible CMV promoter. Expression of the activator mediates reproducible activation of VEGF-A at both the mRNA and protein levels as judged by quantitative RT-PCR and ELISA assay, respectively. RNA was isolated from the cell line stably expressing the VZ-573 synthetic activator and from the parent TRex 293 cell line (both grown in the presence of tetracycline). The resulting RNA was then hybridized to an Affymetrix U133A GeneChip. As shown in FIG. 18, promoter analysis of a subset of 30 most highly activated genes (all more highly activated than VEGF-A itself) compared to 30 unaffected and the 30 most highly repressed gene sets, demonstrates striking (and statistically significant, p-values <0.0002) enrichment of exact or near matches to the intended target site of the VZ-573 within 2500 bases of the transcription start point (see FIG. 18). This suggests that the expression levels of potentially dozens of genes are directly affected by the 3-finger VZ-573 synthetic activator protein.

Having thus described in detail preferred embodiments of the present invention, it is to be understood that the invention as described herein is not to be limited to particular details set forth in the above description, as many apparent variations thereof are possible without departing from the spirit or scope of the present invention.

We claim:

1. A non-naturally occurring NRSF-based zinc-finger polypeptide that differs from a naturally occurring NRSF zinc-finger polypeptide comprising at least one amino acid residue in at least one zinc finger that differs in amino acid sequence from the naturally occurring NRSF zinc-finger polypeptide, wherein the naturally occurring NRSF zinc finger polypeptide binds to a NRSE consensus sequence, and the non-naturally occurring NRSF-based zinc finger polypeptide binds to a sequence of interest but does not bind to the NRSE consensus sequence.

2. The non-naturally occurring NRSF-based zinc-finger polypeptide of claim 1, wherein the polypeptide comprises at least two zinc-fingers.

3. The non-naturally occurring NRSF-based zinc-finger polypeptide of claim 1, wherein the polypeptide is monomeric, dimeric, or multimeric.

4. The non-naturally occurring NRSF-based zinc-finger polypeptide of claim 1, wherein the polypeptide comprises one or more functional domains.

5. The non-naturally occurring NRSF-based zinc-finger polypeptide of claim 4, wherein the functional domain(s) are selected from the group comprising transcriptional activation domain, transcriptional repressor domain, transcriptional silencing domain, acetylase domain, de-acetylase domain, methylation domain, de-methylation domain, kinase domain, phosphatase domain, dimerization domain, multimerization domain, nuclear localization domain, nuclease domain, endonuclease domain, integrase domain, and resolvase domain.

6. The non-naturally occurring NRSF-based zinc-finger polypeptide of claim 5, wherein the polypeptide comprises a transcriptional activation domain.

7. The non-naturally occurring NRSF-based zinc-finger polypeptide of claim 5, wherein the polypeptide comprises a transcriptional repression domain.

8. The non-naturally occurring NRSF-based zinc-finger polypeptide of claim 5, wherein the polypeptide comprises a silencing domain.

9. The non-naturally occurring NRSF-based zinc-finger polypeptide of claim 5, wherein the polypeptide comprises either or both of the C-terminal and N-terminal transcriptional repression domains of a naturally occurring NRSF protein.

10. The non-naturally occurring NRSF-based zinc-finger polypeptide of claim 5, wherein the polypeptide comprises an endonuclease domain.

11. A method of regulating the expression of a gene comprising contacting a non-naturally occurring NRSF-based zinc-finger polypeptide according to claim 1 with a sequence of interest in the gene, such that the expression of the gene is regulated.

12. A method of altering the structure of a nucleic acid molecule, comprising contacting a NRSF-based zinc-finger polypeptide according to claim 1 with a sequence of interest to form a binding complex, such that the structure of the nucleic acid molecule is altered.

13. A method of altering the structure of chromatin comprising contacting a non-naturally occurring NRSF-based zinc-finger polypeptide according to claim 1 with a sequence of interest to form a binding complex, such that the structure of the chromatin is altered.

14. A method of cleaving a sequence of interest, comprising contacting a non-naturally occurring polypeptide according to claim 10 with a sequence of interest under conditions sufficient to cleave the sequence of interest.

15. A method of silencing of a gene, comprising contacting a sequence of interest in the gene with a non-naturally occurring NRSF-based zinc-finger polypeptide according to claim 8 to form a binding complex, wherein the gene is silenced.

16. A method of selecting a non-naturally occurring NRSF-based zinc-finger polypeptide that binds to sequence of interest, comprising:
a) expressing nucleic acid libraries encoding NRSF-based zinc finger polypeptides in a polypeptide expression system, wherein the NRSF-based zinc finger polypeptides have at least one randomized amino acid position within at least one zinc finger,
b) incubating the NRSF-based zinc finger polypeptides with the sequence of interest under conditions sufficient to form binding complexes, and
c) selecting the NRSF-based zinc finger polypeptides that bind to the DNA sequence of interest.

17. The method according to claim 16, wherein the NRSF-based zinc finger polypeptides comprise at least 4 zinc-fingers.

18. The method according to claim 16, wherein the nucleic acid libraries encoding NRSF-based zinc finger polypeptides are expressed in a phage display polypeptide expression system.

19. The method according to claim 16, wherein the nucleic acid libraries encoding NRSF-based zinc finger polypeptides are expressed in a eukaryotic or prokaryotic polypeptide expression system.

20. The method according to claim 16, wherein the nucleic acid libraries encoding NRSF-based zinc finger polypeptides are expressed in a bacterial polypeptide expression system.

21. A method of selecting a non-naturally occurring NRSF-based zinc finger polypeptide that binds to a sequence of interest, comprising the steps of:
a) incubating primary libraries with target site constructs under conditions sufficient to form first binding complexes, wherein the primary libraries comprise NRSF-based zinc finger polypeptides having one variable finger and at least one anchor finger having, and wherein the target site construct has one subsite with a sequence identical to a subsite of the sequence of interest, and one or more subsites with sequences to which the anchor finger(s) bind;
b) isolating pools comprising nucleic acid sequences encoding polypeptides, wherein said polypeptides comprise the first binding complexes;
c) recombining the pools to produce a secondary library;
d) incubating the secondary library with the sequence of interest under conditions sufficient to form a second binding complex; and
e) isolating nucleic acid sequences encoding NRSF-based zinc finger polypeptides, wherein the NRSF-based zinc finger polypeptides comprise the second binding complexes.

22. The method of claim 21, wherein the NRSF-based zinc finger polypeptides that comprise the second binding complexes bind to the DNA sequence of interest with high affinity and specificity.

23. A nucleic acid library encoding NRSF-based zinc finger polypeptides, wherein the NRSF-based zinc finger polypeptides comprise at least one anchor finger with an amino acid sequence identical to a zinc finger of a naturally occurring NRSF polypeptide; and at least variable finger with at least one randomized amino acid residue.

24. A nucleic acid library encoding NRSF-based polypeptides according to claim 23, wherein the variable zinc finger is derived from one of zinc fingers 3 to 8 of a naturally occurring NRSF protein.

25. A nucleic acid library encoding NRSF-based polypeptides according to claim 20, wherein the anchor fingers have the amino acid sequence of one of zinc fingers 3 to 8 of a naturally occurring NRSF protein.

26. A nucleic acid library encoding NRSF-based polypeptides according to claim 23, wherein six amino acid residues in the variable zinc finger are randomized.

27. A nucleic acid library encoding NRSF-based polypeptides according to claim 26, wherein amino acid positions −1, +1, 2, 3, 5, and 6, numbered relative to the start of the recognition alpha helix, are randomized.

28. A DNA sequence of interest to be used in the selection of a non-naturally occurring NRSF-based zinc finger polypeptide, wherein the DNA sequence of interest comprises 10 to 24 base pairs.

29. A DNA sequence of interest to be used in the selection of a non-naturally occurring NRSF-based zinc finger polypeptide, wherein the DNA sequence of interest can be described by the consensus nucleotide sequence ^{5′}NNNNN(C/G)NNCNNGNNCNNCNNN^{3′} (SEQ ID NO. 13).

30. A non-naturally occurring scaffold-based zinc-finger polypeptide that differs from a scaffold zinc-finger polypeptide comprising at least one amino acid residue in at least one zinc finger that differs in sequence from the scaffold polypeptide, and wherein the scaffold polypeptide binds to a naturally occurring DNA binding site and the non-naturally occurring scaffold-based zinc-finger polypeptide binds to a sequence of interest but does not bind to the naturally occurring DNA binding site of the scaffold polypeptide.

31. The scaffold protein according to claim 30, selected from the group comprising CTCF, KS1, Evi-1, MZF, and NRSF.

32. The scaffold protein according to claim 30, wherein the scaffold protein is NRSF.

33. The non-naturally occurring scaffold-based zinc-finger polypeptide of claim 30, wherein the polypeptide is monomeric, dimeric, or multimeric.

34. The non-naturally occurring scaffold-based zinc-finger polypeptide of claim 30, wherein the polypeptide comprises one or more functional domains.

35. The non-naturally occurring scaffold-based zinc-finger polypeptide of claim 34, wherein the functional domain(s) are selected from the group comprising transcriptional activation domain, transcriptional repressor domain, transcriptional silencing domain, acetylase domain, de-acetylase domain, methylation domain, de-methylation domain, kinase domain, phosphatase domain, dimerization domain, multimerization domain, nuclear localization domain, nuclease domain, endonuclease domain, integrase domain, and resolvase domain.

36. The non-naturally occurring scaffold-based zinc-finger polypeptide of claim 35, wherein the polypeptide comprises a transcriptional activation domain.

37. The non-naturally occurring scaffold-based zinc-finger polypeptide of claim 35, wherein polypeptide comprises a transcriptional repression domain.

38. The non-naturally occurring scaffold-based zinc-finger polypeptide of claim 35, wherein the polypeptide comprises a silencing domain.

39. The non-naturally occurring scaffold-based zinc-finger polypeptide of claim 35, wherein the polypeptide comprises either or both of the C-terminal and N-terminal transcriptional repression domains of a naturally occurring NRSF protein.

40. The non-naturally occurring scaffold-based based zinc-finger polypeptide of claim 35, wherein polypeptide comprises an endonuclease domain.

41. A method of regulating the expression of a gene comprising contacting a non-naturally occurring scaffold-based zinc-finger polypeptide according to claim 30, with a sequence of interest in the gene to form a binding complex, such that the expression of the gene is regulated.

42. A method of altering the structure of a nucleic acid molecule comprising contacting a non-naturally occurring scaffold-based zinc-finger polypeptide according to claim 30 with a sequence of interest in the nucleic acid molecule to form a binding complex, such that the structure of the nucleic acid molecule is altered.

43. A method of altering the structure of chromatin comprising contacting a non-naturally occurring scaffold-based zinc-finger polypeptide according to claim 30, with a sequence of interest in the chromatin to form a binding complex, such that the structure of the chromatin is altered.

44. A method of a cleaving a sequence of interest, comprising contacting a non-naturally occurring polypeptide according to claim 40 with the sequence of interest to form a binding complex, such that the sequence of interest is cleaved.

45. A method of silencing of a gene of interest comprising contacting a non-naturally occurring scaffold-based zinc-finger polypeptide according to claim 38 with a sequence of interest in the gene to form a binding complex, such that expression of the gene is silenced.

46. A method of selecting a non-naturally occurring scaffold-based zinc-finger polypeptide comprising more than three zinc fingers, that binds to a sequence of interest, comprising,
a) expressing nucleic acid libraries encoding scaffold-based zinc finger polypeptides in a polypeptide expression system, wherein said polypeptides comprises at least one randomized amino acid position within at least one zinc finger,
b) incubating said polypeptides with the sequence of interest under conditions sufficient to form binding complexes, and
c) selecting the scaffold-based zinc finger polypeptides that bind to the sequence of interest.

47. The method according to claim 46, wherein the selected scaffold-based zinc finger polypeptides comprise at least 4 zinc-fingers.

48. The method according to claim 46, wherein the nucleic acid libraries are expressed in a phage display polypeptide expression system.

49. The method according to claim 46, wherein the nucleic acid libraries are expressed in a eukaryotic or prokaryotic polypeptide expression system.

50. The method according to claim 46, wherein the nucleic acid libraries are expressed in a bacterial polypeptide expression system.

51. A method of selecting a non-naturally occurring scaffold-based zinc finger polypeptide comprising more than three zinc fingers, that binds to a sequence of interest, comprising:
a) incubating primary libraries with target site constructs under conditions sufficient to form first binding complexes, wherein the primary libraries comprise scaffold-based zinc finger polypeptides having one variable finger and at least one anchor finger having, and wherein the target site construct has one subsite with a sequence identical to a subsite of the sequence of interest, and one or more subsites with sequences to which the anchor finger(s) bind.
b) isolating pools comprising nucleic acid sequences encoding polypeptides, wherein said polypeptides comprise the first binding complexes;
c) recombining the pools to produce a secondary library;
d) incubating the secondary library with the sequence of interest under conditions sufficient to form a second binding complex; and
e) isolating nucleic acid sequences encoding non-naturally occurring scaffold-based zinc finger polypeptides, wherein the scaffold-based zinc finger polypeptides comprise the second binding complexes.

52. The method of claim 51, wherein the second binding complexes are high affinity binding complexes.

53. A nucleic acid library encoding non-naturally occurring scaffold-based zinc finger polypeptides comprising at least four zinc fingers, wherein one zinc finger of the scaffold-based zinc finger polypeptides has at least one randomized amino acid residue, and wherein the remaining zinc fingers of the scaffold-based zinc finger polypeptide polypeptides have amino acid sequences identical to a scaffold polypeptide.

54. A nucleic acid library according to claim 53, wherein the scaffold polypeptide is selected from the group comprising CTCF, KS1, Evi-1, MZF, and NRSF.

55. A nucleic acid library according to claim 54, wherein the scaffold polypeptide is NRSF.

56. A nucleic acid library encoding scaffold-based zinc-finger polypeptides according to claim 53, wherein six amino acid residues in the variable zinc finger are randomized.

57. A nucleic acid library encoding scaffold-based zinc-finger polypeptides according to claim 56, wherein amino acid positions −1, +1, 2, 3, 5, and 6, numbered relative to the start of the alpha helix, are randomized.

58. A nucleic acid library encoding scaffold-based zinc-finger polypeptides according to claim 53, wherein six amino acid residues in the variable zinc finger are randomized.

59. A nucleic acid library encoding scaffold-based zinc-finger polypeptides according to claim 54, wherein amino acid positions −1, +1, 2, 3, 5, and 6, numbered relative to the start of the alpha helix, are randomized.

60. A nucleic acid library encoding scaffold-based zinc-finger polypeptides according to claim 55, wherein six amino acid residues in the variable zinc finger are randomized.

61. A nucleic acid library encoding scaffold-based zinc-finger polypeptides according to claim 59, wherein amino acid positions −1, +1, 2, 3, 5, and 6, numbered relative to the start of the alpha helix, are randomized.
